(19) United States
(12) Patent Application Publication
(10) Pub. No.: US 2020/0226899 A1
(43) Pub. Date: Jul. 16, 2020

(54) SYSTEM AND METHOD FOR FLUIDS MANAGEMENT WITH SURVEILLANCE

(71) Applicant: Beverage Metrics, Inc., Highlands Ranch, CO (US)

(72) Inventor: Werner Grunwald, Highlands Ranch, CO (US)

(21) Appl. No.: 16/741,584

(22) Filed: Jan. 13, 2020

Related U.S. Application Data
(60) Provisional application No. 62/791,791, filed on Jan. 12, 2019.

(51) Int. Cl. G08B 13/24; G06K 7/10; G06K 19/07; G06K 19/06

(52) U.S. Cl. CPC G08B 13/248; G06K 7/10366; G08B 13/2417; G06K 19/06037; G06K 19/0723

(57) ABSTRACT

A system, method, apparatus, and non-transitory computer readable storage medium for managing the disbursement of fluids, including beverage pours, and information related thereto, is disclosed. The system includes a tag assembly having an electronic tag, including a circuit. The system includes a communications system between the tag circuit, a reader, a receiver/transmitter, and a secure, cloud-based or on-premises analytical system. The system further includes a computer software system and a surveillance system for monitoring or surveilling dispensing of liquids from containers to which tags are attached.

### CROSS REFERENCES

The present Application for Patent claims priority to Provisional Application No. 62/791,791, titled “System and method for fluids management with surveillance”, filed Jan. 12, 2019, and assigned to the assignee hereof. This application is hereby expressly incorporated by reference herein.

### FIELD OF THE DISCLOSURE

The present disclosure relates to a system, method, method for manufacturing, and apparatus, among other things, for managing the disbursement of fluids, including beverage pours, and information related thereto.

### DESCRIPTION OF RELATED ART

Various industries dispense fluids and require a system for accurately monitoring and tracking such dispensing. For example, the beverage and events industries lose real revenue due to inaccurate or false pours for customers, including free drinks for non-paying persons or improper beverage disbursement. Further, such non-revenue generating pours provide incorrect measurements and data for a business attempting to forecast inventory for the business or for events.

Present solutions have been found to provide inaccurate and untenable solutions for measuring pours and monitoring same. For example, some systems track the weight of the fluids in the bottles, while others utilize a dispensing gun or other devices to keep track of beverage pours. Further, such systems include a significant amount of manual labor to keep track of and weigh the beverage containers at the end of business periods.

Other solutions have provided RFID (radio frequency identification) data transmission systems, requiring local computation of the liquid pour system data and any analysis or reports related thereto. Such systems require relatively expensive infrastructure, including, e.g., the installation of on-site readers and dedicated processing power at each business establishment, in order to generate and analyze the data from the system. RFID readers are also expensive. Further, maintenance of such on-site systems provide an additional expense and time-consuming event. Such systems are not readily accessible to multiple entities, which could provide additional or remote monitoring and analysis.

In addition to the foregoing, the presently used data-generating processes appear to provide inaccurate data generation, due, e.g., to the switching of bottle sizes, being used with the same or similar type of tagging electromechanical device. It is also difficult for existing methods to identify a person causing an event.

### SUMMARY OF THE DISCLOSURE

Accordingly, there exists a need for an accurate and remote-accessible liquid dispensing monitoring and data analysis system to provide better forecasting of inventory without the need to open the container or locate sensors within a container.

Embodiments of the present disclosure provide for an improved system and method for monitoring a liquid, e.g., beverage, dispensing system. Embodiments of the present disclosure provide for a data analysis system and method for forecasting inventory and determining faults in the system.

Embodiments of the present disclosure provide for an improved data-generating process, including an algorithm that tracks and takes into account several factors. In an embodiment, the improved data-generating process includes recognition and analysis of point of sale (POS) data reconciliation, inventory control mechanisms, financial information, and reorder data forecasting. Previous systems provide algorithms based simply on empirical data generation. With the embodiments of the present disclosure, a business can analyze the generated data and provide customers with reports on inventory, reorder and pour data. Further, embodiments of the present disclosure can provide information useful for market research companies and manufacturers/distributors to understand usage and effectiveness.

Embodiments of the present disclosure provide for a new type of electromechanical tag, which is smaller, elegant, and incorporates new technologies in measuring pours. In an embodiment, a tag incorporates use of an accelerometer, gyroscope, etc. to measure bottle or pour data and a proximity sensor (e.g., IR) to detect attachment and detachment of the tag to the container. In an embodiment, a tag is smaller and more elegant, thus providing a more aesthetic and pleasing look to users of the tag. In an embodiment, the tag supports infrared or other proximity determining means thus avoiding the need for a manual on/off switch.

Embodiments of the present disclosure provide for a form of wireless communication (e.g., Bluetooth®, Bluetooth Low Energy, Z-wave, Zigbee, or other low energy network) for transmitting pour and other event data captured by the tag sensors to a server for processing. Embodiments of the present disclosure provide for analysis of generated data from the system in a local area network, a wide area network, the Internet and/or the Cloud. For example, in an embodiment where some or all of the data analysis is performed in the Cloud, this may decrease or eliminate a need for additional on-premises processing of the pour and point-of-sale (POS) data.

One aspect of the present disclosure relates to a system for monitoring dispensing of a liquid comprising one or more hardware processors configured by machine-readable instructions, a central processing unit, and one or more of an internal memory device, and further comprising: an electronic tag, said electronic tag including at least a tag housing, a motion detector and a timing device for measuring a duration of motion of the electronic tag, wherein the electronic tag is attached to a container used in a dispensing event; a data transceiver for transmitting and receiving data from the electronic tag and a computer system, including at least a first motion alert, the first motion alert pertaining to the motion of the electronic tag; wherein the computer system triggers a second alert based at least in part on analyzing the motion of the electronic tag, and wherein the computer system analyzes the motion of the electronic tag based at least in part on the received data. It should be noted that an alert can be associated with both desirable and undesirable events and data. Further, the computer system may be configured to cause the surveillance system to query and retrieve video or image data linked by time and/or location to the motion of the electronic tag or to cause a surveillance system to capture at least one image or a video feed of the dispensing event (or other pour-related events such as cash handling).

In some aspects of the present disclosure, the computer system triggers the second alert based on a timestamp associated with the dispensing event, detecting the motion of the electronic tag attached to the container, identifying that a location of the electronic tag changes, identifying a lack of motion of the electronic tag within a predefined period of time, or identifying that the duration of motion of the electronic tag exceeds a threshold.

In some aspects of the present disclosure, detecting the motion of the electronic tag comprises identifying attachment or removal of the electronic tag from the container. In some aspects of the present disclosure, the motion of the electronic tag comprises a tilt angle for the electronic tag exceeding a tilt angle threshold, and wherein the motion of the electronic tag is linked to a tilt or pour event.

In some aspects of the present disclosure, said surveillance system includes a recognition unit for recognizing at least one of a location or time of the dispensing event. In some aspects of the present disclosure, the computer system identifies a fill state of the container based at least in part on analyzing pour data. In some aspects of the present disclosure, the computer system calculates an amount or volume of liquid remaining in the container based on an amount or volume of liquid originally in the container at start of use, and subtracting pour volumes of liquid based on the pour data, the pour data linked to at least one dispensing event.

In some examples of the system described above, a database associated with the computer system stores fill states for at least one or more containers. In some aspects of the present disclosure, the fill state comprises an empty state, a partially-full state, and a full state. In some aspects of the present disclosure, the fill state comprises an open state and an unopened state.

In some examples of the system described above, the computer system triggers the second alert (e.g., a stockout alert, bottle approaching stockout alert, tag removed from non-empty bottle alert, improper cash handling alert, excessive pour time alert, bottle removed from premises alert, bottle poured outside of the bar area alert, pour without corresponding POS alert, pour outside of acceptable recipe alert, detecting the motion of the electronic tag attached to the container, identifying that a location of the electronic tag has changed, identifying a lack of motion of the electronic tag within a predefined period of time, identifying that the duration of motion of the electronic tag exceeds a threshold) based on motion of the electronic tag. In some examples, the motion of the electronic tag is linked to a tilt or pour event, and wherein the monitoring comprises identifying the location of the electronic tag and a tilt angle for the tilt or pour event.

In some examples of the system described above, the computer system generates (or formulates) a message for the surveillance system, the message including at least one of a subject line or file name, an alert time period including a preset value of time before and after a first time when the electronic tag sends the first motion alert, a location of the electronic tag at the first time, and a request for a video feed for the location for the alert time period. In some aspects of the present disclosure, the surveillance system receives the message and parses the alert time period, the location, and the request.

In some examples of the system described above, the surveillance system determines the alert time period as it matches to one or more digital records of the location, and transmits a copy of the video feed, surveillance images, surveillance audio, or any other media recorded by the surveillance system, for the alert time period and location to the computer system. In some aspects of the present disclosure, the computer system or an administrator analyzes the copy of the video feed and one or more surveillance images or surveillance audio received at the computer system, and determines if (1) the second alert is linked to an alert-worthy event or a false alarm or (2) an identity of a person causing the motion of the electronic tag.

In some aspects of the present disclosure, the surveillance system and the computer system utilize different identifiers for a same location, and access a database associated with the computer system, the database comprising a lookup table mapping the different identifiers to the same location.

Another aspect of the present disclosure relates to a system for managing disbursement of fluids comprising one or more hardware processors configured by machine-readable instructions, a central processing unit, and one or more of an internal memory device and a storage device, and further comprising: an electronic tag, said electronic tag including at least a tag housing, a motion detector and a timing device for measuring a duration of motion of the electronic tag, wherein the electronic tag is configured to be attached to a container used in a dispensing event; a data transceiver for transmitting and receiving data from the electronic tag and a computer system; wherein the computer system analyzes the motion of the electronic tag based at least in part on the received data; and a database associated with the computer system for storing fill states and locations of one or more containers, including at least the fill state and location of the container.

Some examples of the system described above further include a reader (or receiving device) for monitoring the electronic tag, wherein the monitoring is selected from a group including, but not limited to, Radio Frequency Identification (RFID) monitoring, Bluetooth Monitoring, Bluetooth Low Energy (BLE) monitoring, or Near-field Communication (NFC) monitoring.

In some examples of the system described above, the electronic tag further comprises an infrared (IR) proximity sensor for detecting whether the electronic tag is attached to the container, the detection based at least in part on measuring a reflection.

In some examples of the system described above, at least one of the data transceiver and the reader receive an indication of a tag attach event from the electronic tag, and relay the same to the computer system. In some aspects of the present disclosure, the computer system creates a digital association between the electronic tag and the container to which the electronic tag is attached based at least in part on the relaying, the digital association including at least a location of the electronic tag and the container.

In some examples of the system described above, the monitoring comprises one or more of: detecting the motion of the electronic tag attached to the container, identifying that a location of the electronic tag has changed, identifying a lack of motion of the electronic tag within a predefined period of time, and identifying that the duration of motion of the electronic tag exceeds a threshold. In some examples of the system described above, the motion of the electronic tag is linked to a tilt or pour event, and wherein the monitoring comprises identifying the location of the electronic tag and a tilt angle for the tilt or pour event.

In some aspects of the present disclosure, the timing device of the electronic tag starts an initial pour timer based at least in part on one or more of the location of the electronic tag, and a tilt angle for the tilt or pour event exceeding a tilt angle threshold. In some examples of the system described above, the computer system records pour durations for one or more tilt angles based at least in part on receiving pour timing data associated with one or more pour timers from the electronic tag, wherein each pour timer is linked to a specific tilt angle, and wherein the electronic tag ends the one or more pour timers when the tilt angle falls below the tilt angle threshold.

In some aspects of the present disclosure, the computer system determines one or more flow rates and one or more volumes dispensed based at least in part on the received pour timing data and the recording. In some aspects of the present disclosure, the motion detector detects the motion of the electronic tag, the motion linked to a movement event, and wherein the timing device of the electronic tag starts a transportation timer based at least in part on the detected motion.

In some aspects of the present disclosure, the electronic tag enters a low power/storage mode based at least in part on a lack of motion of the electronic tag within a predefined period of time, wherein the electronic tag communicates less frequently as compared to when the electronic tag is not in a low power mode (i.e., when it's in regular mode). In some examples of the system described above, the electronic tag enters a calibration mode based at least in part on a lack of motion of the electronic tag with a predefined period of time, and wherein the calibration mode includes identifying a current tag angle for the electronic tag and setting the current tag angle as a vertical container angle.

In some aspects of the present disclosure, a tilt angle is measured in reference to the vertical container angle. In some examples of the system described above, the tag band of the electronic tag can be composed of a material selected from, but not limited to, plastic, metal, rubber, silicone, silicon, elastomers, and polymers.

### BRIEF DESCRIPTION OF THE DRAWINGS

FIG. 1 shows an embodiment of the present disclosure.

FIG. 2 shows an embodiment of the present disclosure.

FIG. 3A shows an example embodiment of a tag of the present disclosure.

FIG. 3B shows an example embodiment of a tag of the present disclosure.

FIG. 3C shows an example embodiment of a tag of the present disclosure.

FIG. 4 shows an embodiment of the present disclosure.

FIG. 5A shows an example embodiment of a tag or tag assembly of the present disclosure.

FIG. 5B shows an example embodiment of a tag or tag assembly of the present disclosure.

FIG. 5C shows an example embodiment of a tag or tag assembly of the present disclosure.

FIG. 5D shows an example embodiment of a tag or tag assembly of the present disclosure.

FIG. 5E shows an example embodiment of a tag or tag assembly of the present disclosure.

FIG. 5F shows an example embodiment of a tag or tag assembly of the present disclosure.

FIG. 5G shows an example embodiment of a tag or tag assembly of the present disclosure.

FIG. 5H shows an example embodiment of a tag or tag assembly of the present disclosure.

FIG. 5I shows an example embodiment of a tag or tag assembly of the present disclosure.

FIG. 6A shows an example embodiment of a tag assembly of the present disclosure.

FIG. 6B shows an example embodiment of a tag assembly of the present disclosure.

FIG. 6C shows an example embodiment of a tag assembly of the present disclosure.

FIG. 6D shows an embodiment of a tag assembly of the present disclosure.

FIG. 6E shows an example embodiment of a tag assembly of the present disclosure.

FIG. 6F shows an example embodiment of a tag assembly of the present disclosure.

FIG. 6G shows an example embodiment of a tag assembly of the present disclosure.

FIG. 6H shows an example embodiment of a tag assembly of the present disclosure.

FIG. 6I shows an example embodiment of a tag assembly of the present disclosure.

FIG. 6J shows an example embodiment of a tag assembly of the present disclosure.

FIG. 6K shows an example embodiment of a tag assembly of the present disclosure.

FIG. 7A shows a first pour spout example used in an embodiment of the present disclosure.

FIG. 7B shows a second pour spout example, larger than the first, used in an embodiment of the present disclosure.

FIG. 8 shows a table of angle zones of a tag or sensor disposed on a liquid container according to an embodiment of the present disclosure.

FIG. 9 shows a schematic sketch of a cylindrical bottle according to an embodiment of the present disclosure.

FIG. 10 shows a schematic sketch of a rectangular bottle according to an embodiment of the present disclosure.

FIG. 11 shows example statistical quantities of beverage pours according to an embodiment of the present disclosure.

FIG. 12 shows example statistical quantities of beverage pours according to an embodiment of the present disclosure.

FIG. 13A shows a schematic sketch of a wine bottle used without a spout according to an embodiment of the present disclosure.

FIG. 13B shows a schematic sketch of a wine bottle used without a spout according to an embodiment of the present disclosure.

FIG. 14 shows example outflow velocities for beverage pours from a bottle without a spout such as that shown in FIGS. 13A, 13B according to an embodiment of the present disclosure.

FIG. 15 shows example statistical information on experimental beverage pours from a bottle without a spout according to an embodiment of the present disclosure.

FIG. 16A shows an example embodiment of a tag housing according to an embodiment of the present disclosure.

FIG. 16B shows an example embodiment of a tag housing according to an embodiment of the present disclosure.

FIG. 16C shows an example embodiment of a tag housing according to an embodiment of the present disclosure.

FIG. 16D shows an example embodiment of a tag housing according to an embodiment of the present disclosure.

FIG. 16E shows an example embodiment of a tag housing according to an embodiment of the present disclosure.

FIG. 16F shows an example embodiment of a tag housing according to an embodiment of the present disclosure.

FIG. 16G shows an example embodiment of a tag housing according to an embodiment of the present disclosure.

FIG. 16H shows an example embodiment of a tag housing according to an embodiment of the present disclosure.

FIG. 16I shows an example embodiment of a tag housing according to an embodiment of the present disclosure.

FIG. 16J shows an example embodiment of a tag housing according to an embodiment of the present disclosure.

FIG. 16K shows an example embodiment of a tag housing according to an embodiment of the present disclosure.

FIG. 16L shows an example embodiment of a tag housing according to an embodiment of the present disclosure.

FIG. 16M shows an example embodiment of a tag housing according to an embodiment of the present disclosure.

FIG. 16N shows an example embodiment of a tag housing according to an embodiment of the present disclosure.

FIG. 16O shows an example embodiment of a tag housing according to an embodiment of the present disclosure.

FIG. 16P shows an example embodiment of a tag housing according to an embodiment of the present disclosure.

FIG. 17A shows an example embodiment of tag features according to an embodiment of the present disclosure.

FIG. 17B shows an example embodiment of tag features according to an embodiment of the present disclosure.

FIG. 17C shows an example embodiment of tag features according to an embodiment of the present disclosure.

FIG. 17D shows an example embodiment of tag features according to an embodiment of the present disclosure.

FIG. 17E shows an example embodiment of tag features according to an embodiment of the present disclosure.

FIG. 17F shows an example embodiment of tag features according to an embodiment of the present disclosure.

FIG. 17G shows an example embodiment of tag features according to an embodiment of the present disclosure.

FIG. 18 shows an example alert report according to an embodiment of the present disclosure.

FIG. 19 shows an example alert report according to an embodiment of the present disclosure.

FIG. 20 shows an example alert report according to an embodiment of the present disclosure.

FIG. 21 shows an example exception report according to an embodiment of the present disclosure.

FIG. 22 block diagram of a system that supports fluid management with surveillance in accordance with aspects of the present disclosure.

FIG. 23 shows an example block diagram of a system that supports fluid management with surveillance in accordance with aspects of the present disclosure.

FIG. 24 illustrates a system that supports fluid management with surveillance in accordance with aspects of the present disclosure.

FIG. 25 illustrates a system that supports fluid management with surveillance according to an embodiment of the present disclosure

FIG. 26 illustrates a flowchart according to one or more embodiments of the present disclosure.

FIG. 27 illustrates a flowchart according to one or more embodiments of the present disclosure.

FIG. 28 illustrates a diagrammatic representation of one embodiment of a computer system within which a set of instructions can be executed for causing a device to perform or execute one or more aspects and/or methodologies of the present disclosure.

FIG. 29 illustrates an exemplary pour timeline plotting an angle of container tilt for two different containers or pours over a period of time.

### DETAILED DESCRIPTION

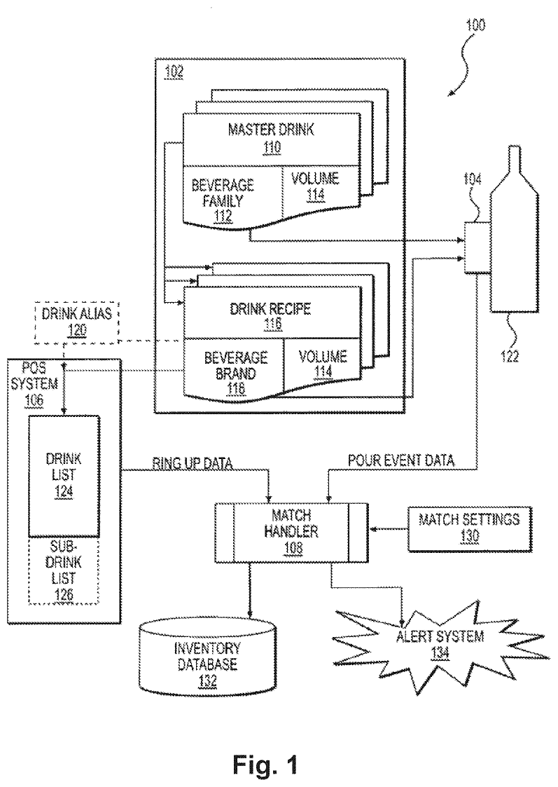

FIG. 1 shows an example embodiment of a beverage pour system. For explanatory purposes, the embodiments described herein may concern a beverage or alcohol pour system. These embodiments can also be used for other types of fluids such as chemicals.

In embodiments of the present disclosure, various options for taking inventory are provided. In addition to the options provided herein, inventory can also be taken manually by a user of the system. For example, a user can scan the bottle tag identifier (e.g., a digital identifier such as a one-dimensional or two-dimensional barcode (e.g., QR code)) with the mobile device or scanner, the system then inputs the exact type and brand of bottle. The user can then with a finger through a touch interface, increase or decrease the fluid level on the GUI to match the physical level of the bottle associated with the bottle tag. The increasing and decreasing of the fluid level can be done by various ways including: moving a level of color in a digital image of the bottle via the GUI; sliding a feature up and down along or in the digital image of the bottle to indicate the height; press a button(s) or soft button(s) to increase or decrease the volume level in a digital image of the bottle or just a numerical indicator of the volume; move a circular interface indicator to increase or decrease the viewable volume level in a digital image of the bottle. The system then can take that measurement, knowing already inputted bottle measurements for that specific brand and type and bottle volume, and calculate the volume of the fluid inside using standard geometry. Alternatively, the user can type or input the perceived level or height of fluid via the GUI, and the system will then calculate the volume of the fluid inside using standard geometry.

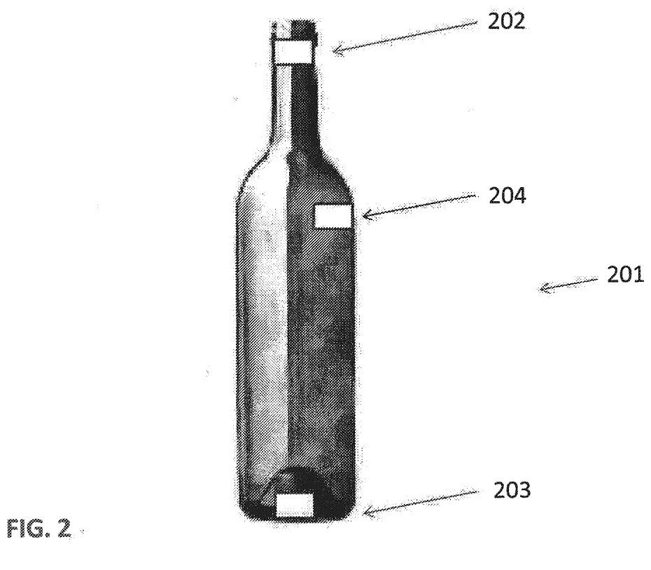

FIG. 2 shows various examples of tag locations on a container according to embodiments of the present disclosure. In an embodiment, the tag is a sensor attached to a location on a bottle or other liquid container 201 such as near the tip or lip 202 of the bottle 201, at a bottom 203 of the bottle 201, or at another location 204 in between the tip 202 and the bottom 203. In an embodiment, there can be multiple tags or sensors located on a bottle or liquid container 201. The tag can be mounted or disposed on the bottle using an adhesive, attachment means, snaps, magnet, hook and loop, mounted brackets allowing the tag to be removeable, and other available methods for attaching a device to a bottle or container.

In order to determine the meaning of certain tilt angles, the system also tracks the location of the specific sensor or tag. In an embodiment, the tag measures the tilt and the time in each tilt zone. In an embodiment, a software system receives the tag tilt and time data. In an embodiment, the software system can be controlled and/or maintained on a desktop, mobile device, or via a remotely-accessible server. In an embodiment, the angle of the tag is periodically measured. In an embodiment, the tag is portable and communicates with a software system or control system via Bluetooth® or other data transmission method. In an embodiment, the tag sends the data as a broadcast but can also send data in a two-way transmission with a handshake. The measured values are transmitted periodically in an embodiment. In an embodiment, the tag transmits operating counters, battery voltage, and other operating features. In an embodiment, the tag sends a periodic “alive” or system status signal in order to show present functioning capabilities. In an embodiment, the tag stores the measured data, and uploads the data at periodic time events.

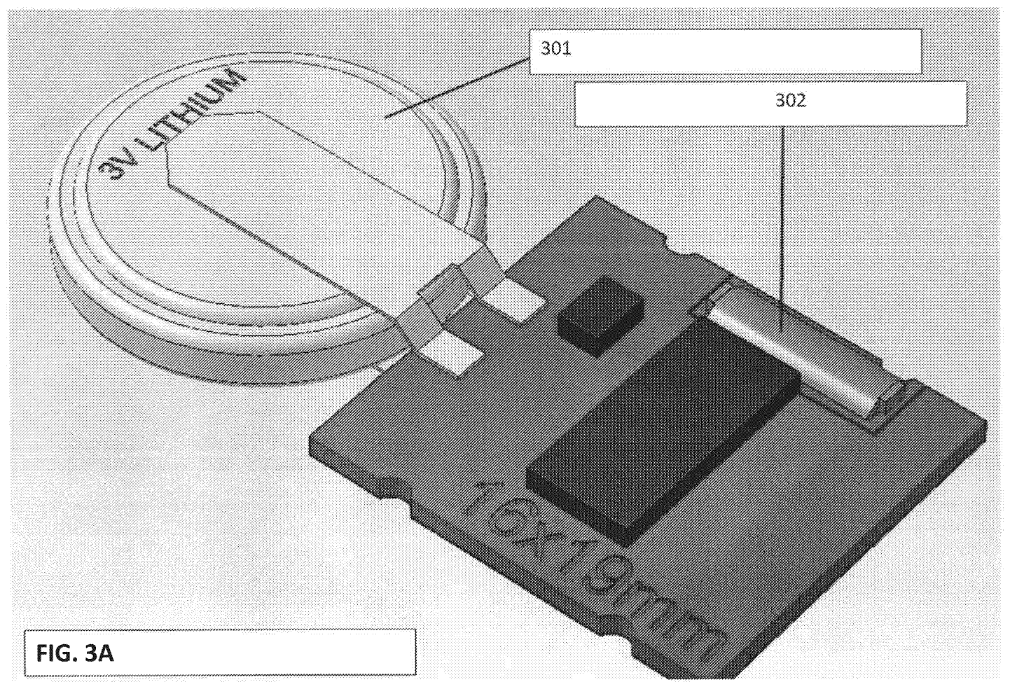

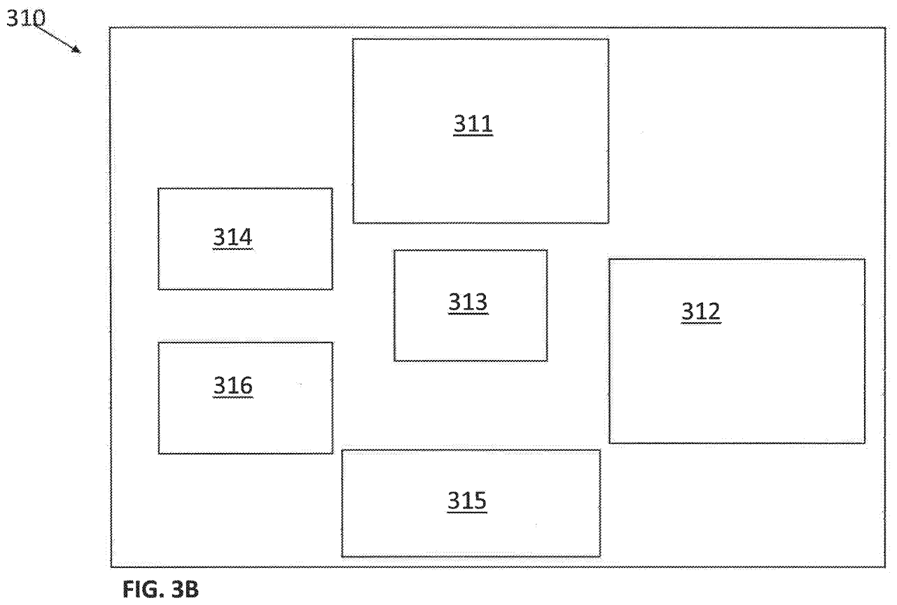

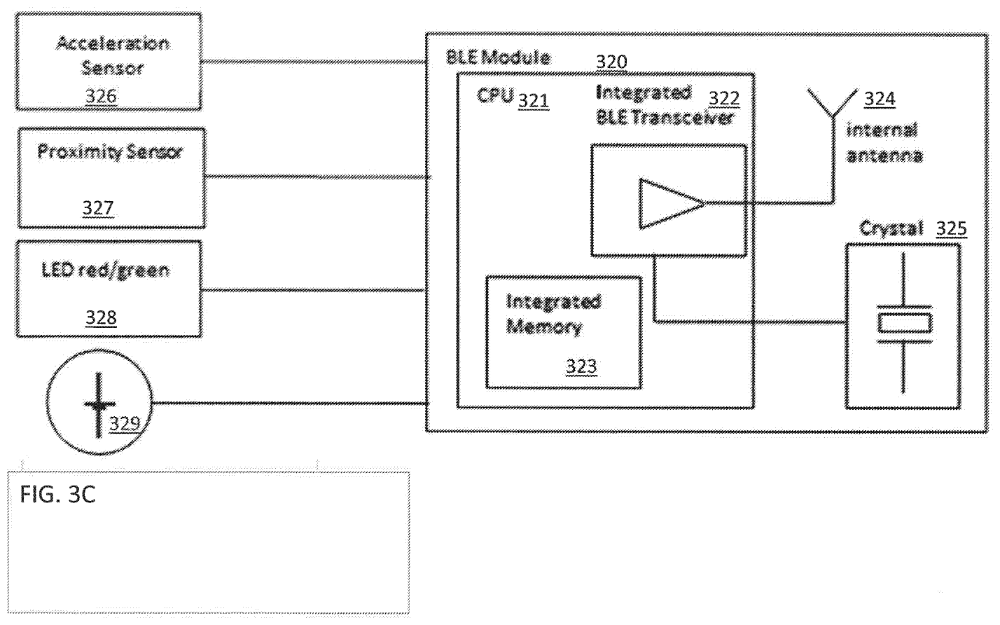

FIG. 3A shows an example embodiment of a tag of the present disclosure. In FIG. 3A, a tag is shown having a battery 301, such as a 3 volt lithium battery, which can be attached to the circuit via a stiff or immobile attachment conducting piece or soldered to the circuit or via a moveable attachment conducting piece. The circuit which is powered by the battery includes a movement and acceleration chip such as an accelerometer 302. This chip recognizes when the tag moves or the bottle is moved. This accelerometer chip on the tag triggers a wake up of the central processing unit (CPU) to initiate taking of one or more measurements. The measurements can be a calculation or measurement allowing for calculation of an angle during the pour measurement. The pour measurement can also include a measurement of time at specific angles or tilts. The circuit can include an infrared proximity sensor. The infrared proximity sensor is used to determine when attached to a bottle. The circuit can include storage device for storing production data. The circuit can include a transmission and reception device, such as a chip having an integrated CPU and antenna. In some examples, the transmission and reception device may be referred to as a transceiver.

FIG. 3B shows an example embodiment of a tag of the present disclosure. In FIG. 3B, a tag 310 is shown having various components: Bluetooth® chip with an integrated CPU and antenna 311; non-volatile memory device 312 such as an electrically erasable programmable read-only memory (EEPROM), for storing production data such as a serial number; dual green-red light emitting diode (LED) 313 or infrared (IR) LED or other indicator; infrared proximity sensor 314 to recognize when attached to a bottle; movement and acceleration chip 315; and a polarization protection circuit 316 to protect against when a user inserts the battery powering the circuit incorrectly, so that the tag's components are not damaged. The movement and acceleration chip 315 recognizes when the tag (including this chip) moves and wakes up or triggers the CPU to recognize and/or register via the tag a start of measurement and subsequent calculation of the measurements. Embodiments of the present disclosure do not need to include all of these features shown in FIG. 3B, such as the polarization protection circuit 316.

In FIG. 3B, the dual or infrared LED is used because one may not be able to see normal LED outside the tag housing. One could see IR signaling through the housing if the tag housing is IR transparent. In an embodiment, the tag housing is comprising of an IR transparent material, e.g., a plastic material such as that manufactured under Makrolon. In an embodiment, the signaling—whether IR LED or dual green-red LED or another—is viewable by an observer and/or a mobile device.

In an embodiment of the present disclosure, a calibration is made when the tag is associated with a bottle or object. For simplicity here, the object referred to will be a bottle containing fluid. The tag can be placed in a variety of positions on a bottle, and the tag could be placed at an angle or even upside down on the bottle by a user. Accordingly, a calibration is made in order to determine the exact angle of the tag circuit (tag) on the bottle. That exact angle measured is then calibrated by the system as the 0 degree or vertical position of the bottle. That calibration can occur every time the bottle has been stationary for a threshold amount of time, e.g., 5 seconds. This is because a user may move the tag on the bottle when using the bottle, or some other event could occur to change the placement of the tag after a first calibration. Alternatively, pour data can be measured without calibration, and then a later calibration step can take place once the bottle stabilizes. The calibration can then be applied to pour data in cache, and then the corrected pour data can be passed on for further analysis and use.

In an embodiment of the present disclosure, there are two steps of calibration that occur. First, a basic calibration is made to determine, e.g., whether the tag is face up or downwards on the bottle. With this information alone, the system can then measure and calculate pours from the bottle. The error measurement of such has been calculated to be roughly 5 to 10% error. Thus, a bartender or user can put the tag in the tag housing onto a bottle, and after 5 seconds (or other preset threshold of time) of the bottle being stationary, upright, the bartender can do a pour that is measurable within this low error rate. For this calibration, a user can hold the bottle upright—the bottle does not need to be stationary/still on a table or flat surface. After the tag is attached and basic calibration has occurred, then the bottle can be placed on a table or other surface allowing for stationary or no movement of the bottle. Upon a passing of a time threshold, e.g., 5 seconds, the system can effect a precise calibration of the tag on the bottle. Once that precise calibration has occurred, the subsequent pour measurements are precise as well.

In a system embodiment, a basic calibration includes the steps of: having the bottle with the tag remain in an upright or roughly upright orientation (e.g., pitch between 0 and 20 degrees deviant from the vertical position) for a specific time threshold (e.g., 5 seconds); then the system sets that measurement to a zero angle with a plus or minus 90 degrees if the tag is upright or upside down on the bottle; then the measurement error is set in the system for between 5 to 10%. This error is basically the angle of the tag itself on the bottle since the tag is not always placed perfectly parallel to the bottle neck.

In a system embodiment, a precise calibration includes the steps of: having the bottle with the tag remain completely still for a specific time threshold, e.g., 5 seconds; check the current pitch measurement between 0 and 20 degrees deviance from the vertical position if there is no change in measurement or if basic calibration has been done; check the current pitch measurement if between 0 and 20 degrees deviance from the vertical position and the current position measurement has change for more than I degree from a previously recorded precise calibration; set the current position measurement to zero angle. In this calibration, the error measurement is typically less than 5%. This provides for a very good measurement of pours from the bottle, allowing for a more precise calculation of the bottle volume and other calculated information from the measurement data recorded by the system via the tag.

In an embodiment, the determination of the white/clear/black/dark bottle can be based on reflection or another known means. For example, an IR proximity sensor is used to detect whether the tag is attached to a bottle. The tag housing, see embodiments described herein, is completely IR transparent, and so the tag housing does not interfere with the detection of the bottle. When the tag is placed on a bottle, the system detects a reflection based on the material and color of the bottle. In an embodiment, each IR proximity sensor of each tag is calibrated at production so that the system knows the value when there is no reflection. Dark bottles such as black colored bottles provide the smallest reflection grade, which makes it difficult to detect. Accordingly, the system determines a threshold grade so that in order to detect that the tag is attached or associated with a bottle, then the IR proximity sensor must detect a reflection grade above that threshold grade in the system. In an embodiment, a user can check the system and update the system should a tag be found to be attached to a bottle such as a dark bottle which did not register as having the threshold reflection grade.

In an embodiment, the tag measures and transmits on request the exact movements as a current angle per time unit. This allows a business to see how the bartender did a pour event and can display the angle in a graph for each tenth of a second, for example.

In an embodiment, the tag is always in a powered-down mode where it uses a very minimal amount of power, e.g., 5 μAmps. The movement and acceleration sensor is what is using that minimal amount of power during the powered-down mode, and can be active a specific amount of time, e.g., one measurement per second. Once there is movement detected by the sensor, then the sensor “wakes up” or triggers power-up by the CPU. The CPU will then switch the movement and acceleration sensor to a faster measuring speed (e.g., 10 measurements per second) and will scan if there is a tilt of the tag (i.e., bottle that the tag is on) of more than 62.04 degrees or other set amount. Then the system will start measuring the pour event. Once the tag is measured by the system to be less than 62.04 degrees or other set amount tilt, then the pour event is considered finished and the tag sends the measurement data from that pour event via Bluetooth® to the reader device (i.e., on-site reader). The CPU of the tag then switches the tag to powered-down mode again. The CPU will “wake up” or power up every other minute (or other set amount) to repeat the transmission of the last pour event or multiple last pour events. This can ensure that the system receives at least one if not multiple copies of the same data, allowing for redundancy which is later determined rather than losing data. In an embodiment, this transmission is by broadcast.

In an embodiment, the tag measures tilt, time, and other details. The tag can also measure the temperature and such data is sent to the server. This temperature information is used by the server application to monitor the temperature of the cooling devices and/or of the quality of the storage situation. The system can track specific threshold temperature changes, since large variations in temperature can harm the quality or viability of certain fluids.

In an embodiment, a tag communicates by sending and receiving data, as described herein. This can allow for the system to conduct firmware updates from the Master app or central server or providing company server. In an embodiment, this can allow for sending marketing information to the tags. The tags can then display this information on its display screen—as shown in the figures—or transmit that information to the company's server for further dissemination. The display on the tag could be promotion price, advertising, ingredients or other health information, customer branding, or other information desired by the client or user of the system.

In an embodiment, the tags can include an LED that is triggered when the tag battery level falls below a threshold, thereby making it easier for users to identify tags needed battery changing/charging. One or more LEDs on the tag could also be used to indicate to wait staff and bartenders the location of a given bottle or an oldest bottle in a set of the same type/brand. For instance, a waiter may digitally indicate that an order for a certain Merlot has been made and the LED on the oldest bottle of that wine may illuminate and help the waiter find the desired bottle. Triggering an LED on the oldest bottle may help the staff cycle inventory. In an embodiment, the tags have a small LED light to signal that it is attached or detached, etc. The bar owner or user of the system can use the LED light or an additional LED light controlled by the tag or the system or the app to make a blinking light or colored light for certain promotional or marketing information dissemination. For example, if a customer buys two drinks from the red blinking LED bottle, then the customer gets a discount or gets entered into a raffle or other promotional effort.

In an embodiment, the tag has a small camera or another input device which the user can trigger via the mobile app or the system or an external button or soft button on a display screen on the tag. For example, upon a trigger of the camera or scanning module, the system automatically enters the type of bottle and liquid into the inventory system associated with that tag identification. In this case, there is no need for an external scanner by the user.

FIG. 3C shows an example tag. Some features of this tag can differ, depending upon the desired result and different technical chips employed (e.g., some integrated chips might include other functionalities). In FIG. 3C, the tag includes a Bluetooth® low energy (BLE) module 320, having a CPU 321 with an integrated BLE transceiver 322 and an integrated memory 323 for storing data, an internal antenna 324 and a crystal 325. The module can be connected or associated with an acceleration sensor 326, a proximity sensor 327, and dual red/green LED 328, and a power source 329 or battery.

In an embodiment, the tag firmware is loaded during production process and initialized with a unique identified (ID). The tag ships to a customer or location or is stored at location in STORAGE mode, meaning that no message is transmitted during this mode. In order to get the tag out of the STORAGE mode, the tag is presented with a strong light source (e.g., flashlight), and then the proximity sensor sends this information to wake up the CPU. An LED in the tag may blink to signal this event, though this is not required.

In an embodiment, when fixing the tag on a bottle, the proximity sensor then detects the bottle's existence, and the tag sends an INVENTORY ATTACH message 3 times within 3 seconds (With the value of “Minutes Since Last Attach”=0) or other preset amount. The tag stays in INVENTORY ATTACH mode as long as the proximity sensor still detects a bottle. This message is sent cyclically every 6 minutes. In another embodiment, the tag and a receiving device can engage in a two-way communication such that the tag ceases sending an INVENTORY ATTACH message once the receiving device confirms that the message has been received.

In an embodiment, by detecting a tilt event (e.g., angle over approximately 60° from absolute 0° or other preset angle amount), the tag starts measuring pouring time and tilt angle as a function of time. Once the bottle is back in an upright position, or passes a tilt angle threshold, the tag recognizes the end of pour and sends a burst of 3 POUR messages within 3 seconds (or other amount), including the pouring duration times for every angle sector and the pour counter to the system. Other burst counts can also be implemented, or any one or set of messages, repeatedly sent to ensure the receipt occurs (where there is no receipt acknowledgment). In another embodiment, tags may periodically broadcast alerts to listening receiving devices. When a receiving device acknowledges receipt of the broadcast the tag can then cease broadcasts, thereby reducing power consumption.

In an embodiment, the tag measures a duration of 25.6 seconds in every angle sector (12 sectors). If the bottle is detected as staying in one of the sectors for more than 25.6 seconds, the POUR message will have the Value 256 (preset maximum) in that field, and the tag will then stop measuring. Alternatively, if the tag continues to measure pouring activity past this 25.6 second threshold, then a new POUR message can be transmitted until the pour event ends. Third, fourth, and additional POUR messages may also be sent depending on the length of the pour event. In this way, a POUR message may be fragmented into multiple chunks representing 25.6 seconds (and the last chunk representing some time less than or equal to 25.6 seconds).

In an embodiment, when the tag is removed from the bottle, the tag sends a burst consisting of 3 INVENTORY DETACHED messages within 3 seconds (With the value of “Minutes Since Last Detach”=0) or other preset amount, and then the tag stays in INVENTORY DETACH mode until the tag is placed again on a bottle or the tag is set to STORAGE mode (i.e., communicating less frequently). In an embodiment, the INVENTORY ATTACH or DETACH message includes the measurements of the last pours. In this message, the pour duration times of the last “n” pours are summed up in every angle sector. The number of “n” pours transmitted is limited by the total time of 25. 6 seconds in each angle sector. This is basically a log file of the last pours.

In an embodiment, the tag sends the INVENTORY DETACHED message every 12 Minutes until the Tag is placed again on a bottle or the tag is set to STORAGE mode or a set threshold of time (e.g., 4 hours) has passed. This time is configurable. In an embodiment, the tag sends an ALIVE message every 12 minutes if the tag is functional and attached to a bottle.

In an embodiment, when a tag remains motionless for a threshold time (e.g.: 30 minutes), it sends an “ENTER STORAGE” event and goes into low power mode where it only transmits an ALIVE message once every, e.g., 24 hours. During this period, the tag continues to monitor the motion sensor. When the tag is moved, it sends a “WAKEUP” message and transitions to active monitoring mode. During active mode, the tag sends an ALIVE message every N minutes so that the tag can be more actively tracked. As long as the tag keeps moving/pouring etc., the tag remains in active mode. Once the tag remains motionless for 30 minutes (or some other duration), it transitions back to storage mode and the process starts over.

For shipping, transportation and long-term storage, the tag can be set to STORAGE mode. The STORAGE mode is activated by a special sequence or BLE command or by a special sequence preset by the user or the administrator such as a pour is started, 4 seconds pass, the tag is detached from the bottle while the bottle is measured to be in horizontal position.

In an embodiment, the tag can be configured and the firmware can be changed after production process. For example, the tag can be set to automatically auto correct to 0° when attached to the bottle (even if attached at an incorrect angle) or be set to send a correction value.

In an embodiment of the present disclosure, the transceiver is located in the tag itself, and transmits from the tag hardware via universal asynchronous receiver transmitter (UART) to a other receiving device (e.g., Raspberry Pi). UART communication protocol is known. In an embodiment, the transceiver and the receiving device just receive data and then forwards the data to the server(s). In an embodiment, a timestamp is added to the data forwarded. In an embodiment, a timestamp and other information is added to the data forwarded. In an embodiment, there are two ways of communication between the tag hardware (including the transceiver) and the receiving device: i) normal broadcast mode; and ii) connected mode. Normal broadcast mode is when the tag sends out data such as pour events via broadcast, without any handshake between the transceiver and the receiving device. Such broadcast is, e.g., BLE communication protocol. Connected mode is when the receiving device pairs with a tag and gets into a connected mode where a user can read/write additional data into the tag. In some examples, Bluetooth® commands are used in the connected mode.

The receiving device connects to the transceiver or an on-site reader and opens communications and listens. In the connected mode, described above, the tag can be updated.

In an embodiment, when a message is received from a tag, and one or more receiving devices receive it at the same time (or different times), a timestamp is added and then the message is (optionally) held in buffer. In some examples, the receiving device may then send the message held in buffer as a raw message along with a corresponding timestamp. In some cases, the received message may be held in a buffer if the system is offline or if the message needs to be queued up and transmitted. Other information in addition or in place of a timestamp can be appended such as signal strength, device identification, etc., to the server. In some cases, the transmission sent from the receiving device may be asynchronous. In an alternate embodiment, the transmission is synchronous. In yet another embodiment, the transmission is synchronous and the message is acknowledged back to the receiving device.

In an embodiment, the receiving device may be configured to only exchange data with a cloud based system or website specific to the geographical location, e.g., bar, hotel, where the receiving device is located. In some examples, each location may deploy its own independent application or site within the broader system. Thus, there may exist a plurality of applications or databases, each of them associated with a specific area of a geographic location. In some examples, such a separation of apps and/or databases by area may allow for better security and integrity of the data and calculations. In an alternate embodiment, the apps and databases may not be separated, and may instead share the same set of resources.

In an embodiment, data integrity and calculations integrity is protected. One way is via an audit system in the present disclosure. For example, every table in the system (which allows a user to make a change) has a corresponding Audit table. For example, the Tag table has a Tag_Audit table. The Tag table stores the current record value, and the corresponding audit table has a copy of every record. A structured query language (SQL) trigger is used on insert or update on the main (e.g., Tag) table to copy that record to the Audit (e.g., Tag_Audit) table. Each is timestamped so that it is clear what changes were made and when. The system also stores in every table the last modified timestamp (as this can work offline this is when it was modified on the client), the last modified by (the user) and the ServerLastModified (this is the timestamp when the server saved it into the SQL DB).

For security purposes, all data is encrypted in transit. In an embodiment, one can use https-ssl 2048 bit certificates. In an embodiment, all data is stored on the server in, for instance, SQL or Azure Storage (for files, documents etc.) and all data at rest can be encrypted in these systems.

In an embodiment, only certain entities, e.g., Azure app services or another company's services, may be allowed access to the SQL server for each location. In an embodiment, no user is allowed a user-name and password in SQL to be able to bypass the app. In an embodiment, a company is provided an administrative user-name and password to bypass the app or security measures.

In an embodiment, there is a Master app which is where all customer sites are configured and there exists a master list of items, UPCs and images where a user can configure the sites. This allows for when a new site is built or when an update to a UPC comes in, the providing company has one central place to manage and update the individual locations associated with that update or site. This can also allow for when a user logs in on the mobile app, the providing company can look up the site for that user's location and from then on they are talking to the user via the user's company site.

In an embodiment of the system, each location site has at least two receiving devices and each of the receiving devices can receive messages from the tags. The receiving devices do not communicate with each other. In an embodiment, each receiving device is connected to the cloud server for that site via the Internet. When online, the receiving device receives the message and forwards it (with the other data mentioned herein) to the cloud server for its configured site.

In an embodiment, when the data is received by the cloud server, the cloud server puts the data into a FIFO (first in, first out) queue. This is because the data is being received in parallel, and multiple copies of the message may have been received. The system only wants to process a message once—even though the tag will have repeated sending the message multiple times in a few seconds, and each receiving device will have received and transmitted that same message onto the server. The server then processes all messages in the queue one at a time. The system on the server first checks if the system has received and processed the message, and if not, the raw message is saved to the database (and kept there for a set amount of time, e.g., 30 days) and saved in a data warehouse indefinitely. Once the raw message is saved on the database, then the message is processed by the system.

If the message received is an attached message (each tag sends this every 6 minutes (or other preset amount) to let the system know the tag is still there and attached), then the system decodes the information (e.g., this all is sent in plain text/byte array by the tag, or can be sent as an encrypted message from the tag to the receiving device) according to the communication protocol and store that information in various places (e.g., in the tag record).

If the message received is a detached message (each tag sends this every 12 minutes (or other present amount)) to let system know it is still there and also when detached), then the system decodes the information. This information can be stored in the tag. The system also checks the current tag attachment (e.g., the bottle/UPC the tag is attached to). If there is less than 10% fluid calculated as remaining in the bottle, the system automatically detaches the tag from the bottle and marks the bottle record as empty. In some cases, this empty state may also be referred to as a stock out or stock out state. In an embodiment, the system adjusts the inventory in the bar or location by the amount remaining. If the fluids amount is greater than 5%, or 10%, or 15%, or 20%, then the system sends a warning notification to the bar or location via the app or message or email or other communication means. If greater than 20% the system sends an alert to the bar or location via the app or message or email or other communication means.

If the message is a calibration message (each tag calibrates 5 seconds (or other preset amount) after the tag is attached and kept level or 5 seconds (or other preset amount) after the last pour), then the system stores this information in the tag. Information can be battery level, temperature, calibration angles and thresholds, etc.

If the message is a pour message, then we first check if the system has already processed this pour (the tag sends the pour message repeatedly on a frequent basis for approximately 20 minutes (or other preset amount) in case the system missed it. This is not a repeat of the raw message, but of the pour message—it will have the same pour data but other data which is different). If the system has not processed the pour message, then the system checks that the pour message is attached to the tag in the software and that it is physically attached (in the message data). The system then gets the tag, the item, and the formula, and calculates the volume poured. The system saves the pour information. Then the system updates the inventory for the item in the bar or location. In an embodiment, the system also updates the remaining volume for this tag.

The system then does a check on the par levels for this item and inventory amount, based on lead time to order, bottles/per day used and par level. The system alerts if this is now going to be below par and needs reordering.

In an embodiment, whenever information is received and records (tag, pours, attachments, inventory etc.) are updated in the database, the system also automatically pushes a live update to all applicable client systems and the client systems update all screens that are displaying that data. Reports could also be generated based on the received information.

In an embodiment, the system reorders based on inventory, such that the system automatically creates orders, exports orders to spreadsheets and other reporting tools, and receives orders. In an embodiment, there are dashboards, viewable herein in the various figures provided, for various data including by timestamps and other grouping features (inventory/pours/etc.). These dashboards can be updated dynamically by the system, and printed to pdf or other type doc. In an embodiment, the system allows for a user to override the inventory system and adjust as needed using the mobile app, by scanning tags, using a touch interface to indicate volume levels, etc. In an embodiment, the receiver device includes a touch screen version which allows a user to attach tags to bottles, move bottles from inventory to empty to other locations, receive orders, and other functions.

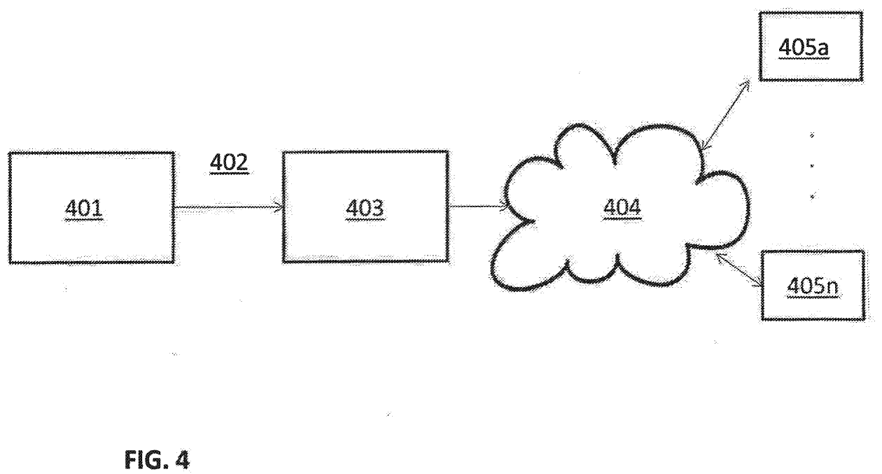

FIG. 4 shows an example system according to the present disclosure 400. For example, data 402 is transmitted from a pour system or liquid monitoring system 401 (e.g., such as that shown in FIG. 1) to local or remote receiver and/or processing device(s) 403. In an embodiment, the data 402 is transmitted to a local or remote device, e.g., a desktop computer, a laptop computer, a mobile device, an iPAD, an Apple Watch, or a mobile telephone. In an embodiment, the data 402 is transmitted to a local receiving device, which then transmits the data to a processing device. In an embodiment, the data 402 is transmitted to a remote receiver or processor or server. In an embodiment, the data 402 is transmitted from the local or remote receiver and/or processing device(s) 403 to the Cloud or network 404. From the Cloud, for example, various entities 405a to 405n can access the data, reports, analyzed data, and other information made available to them.

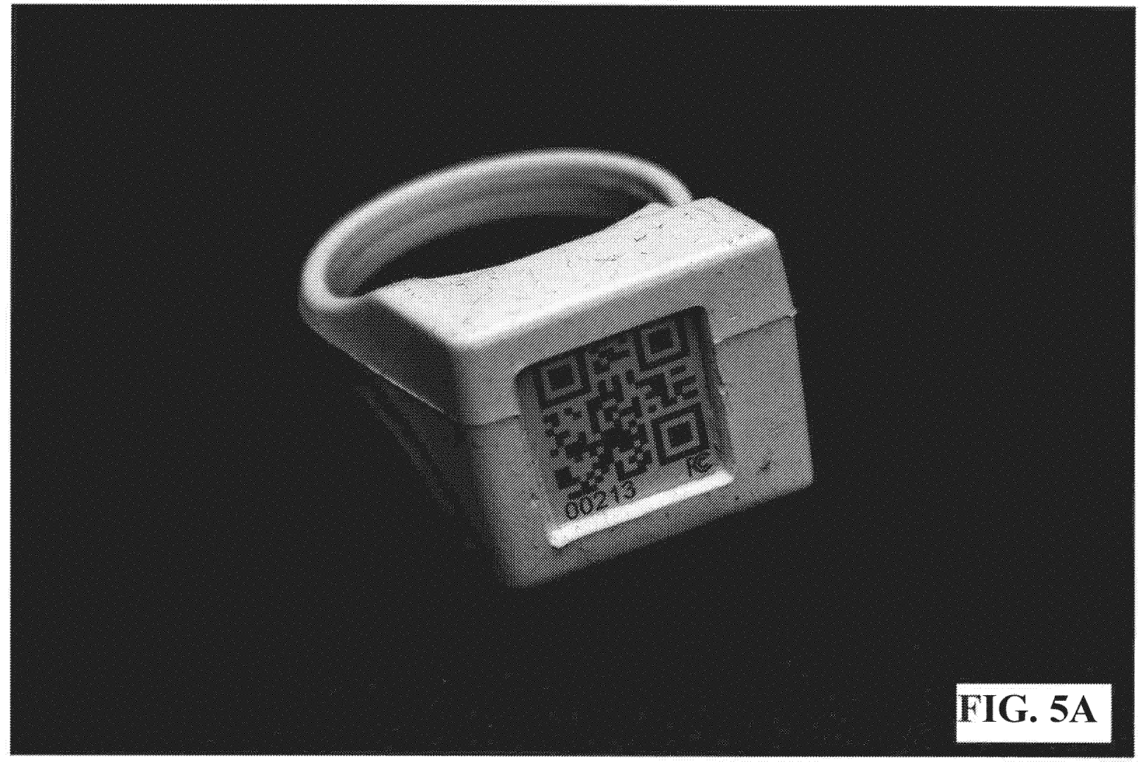

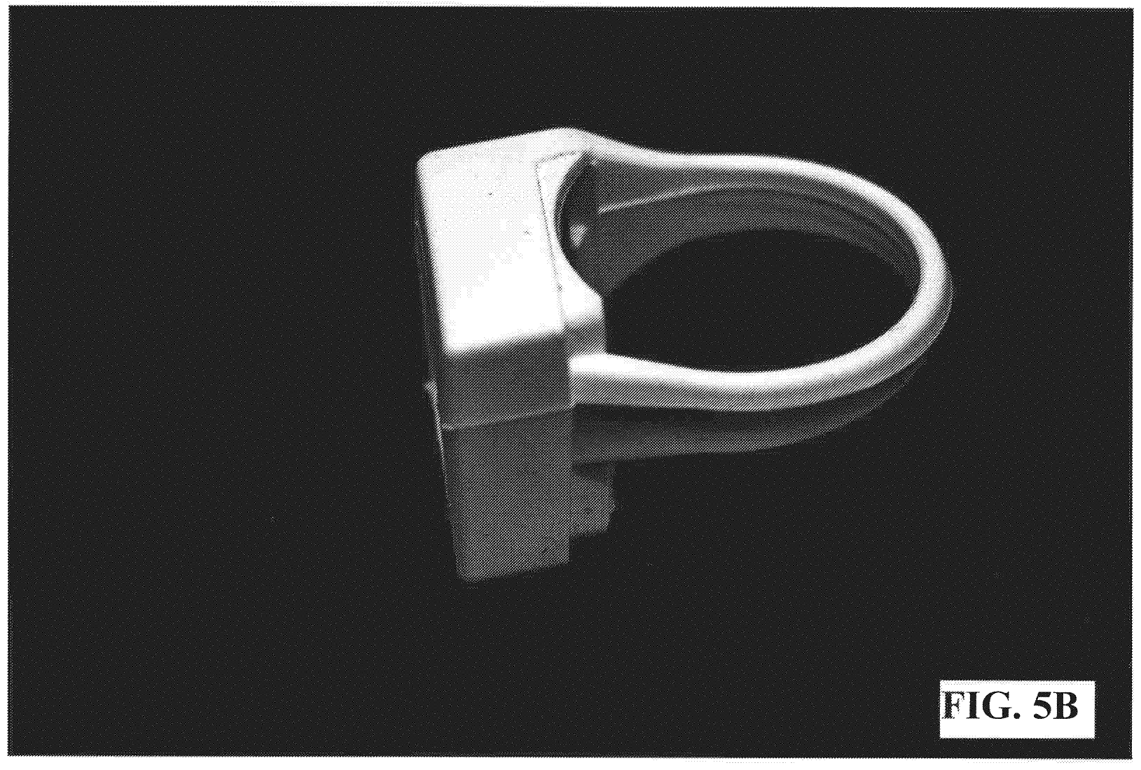

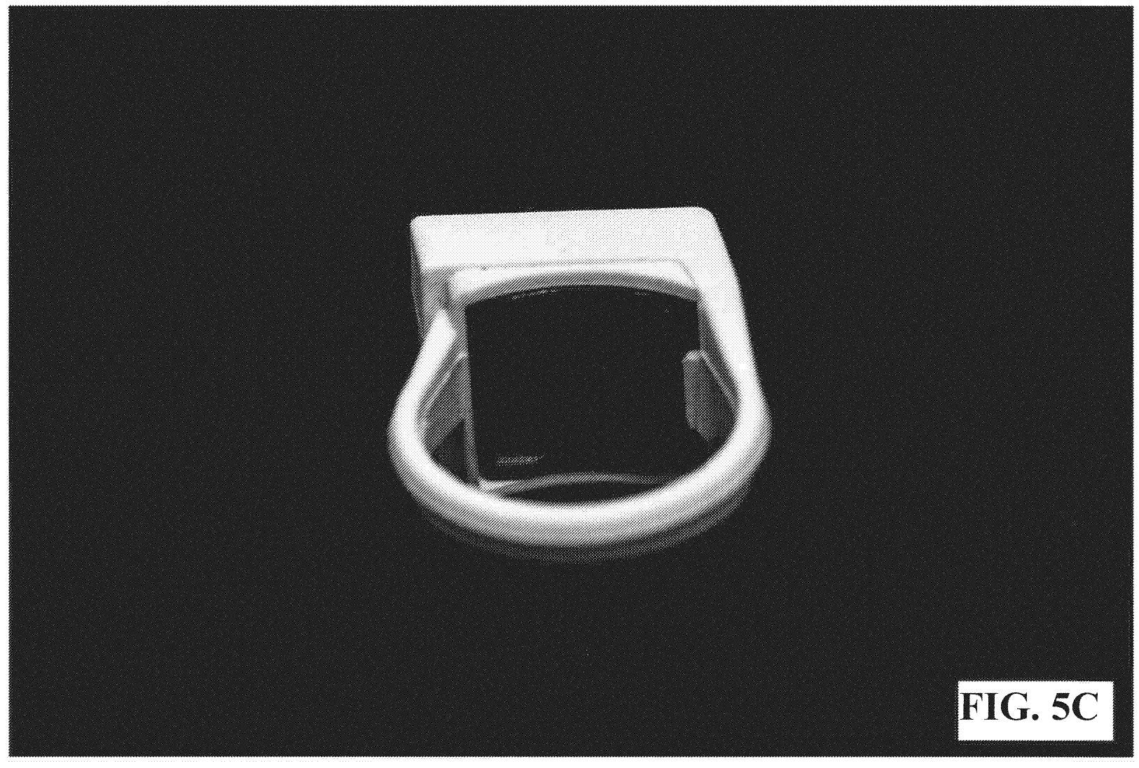

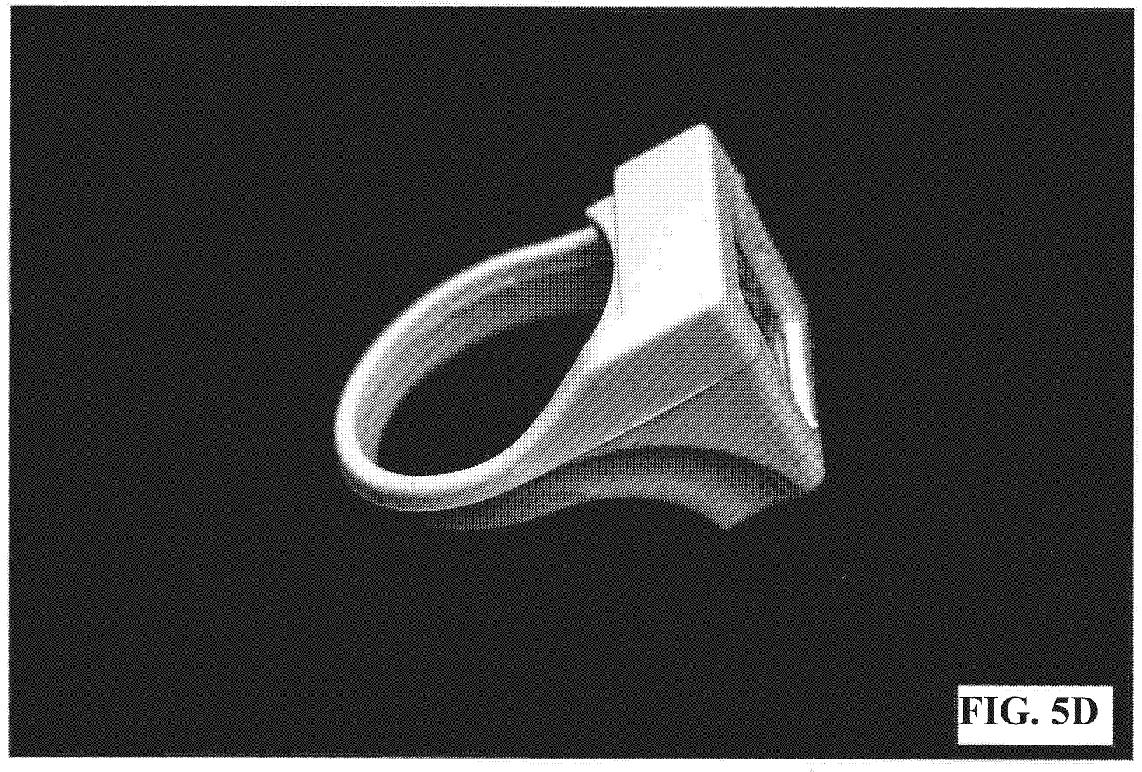

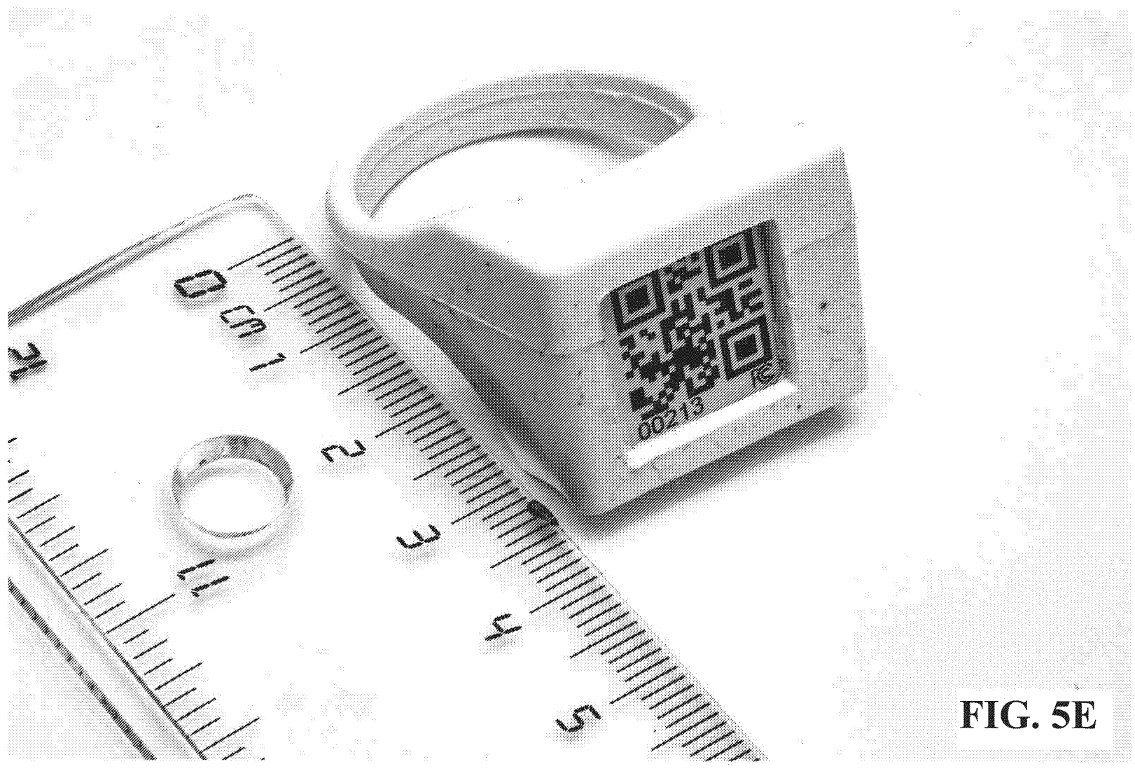

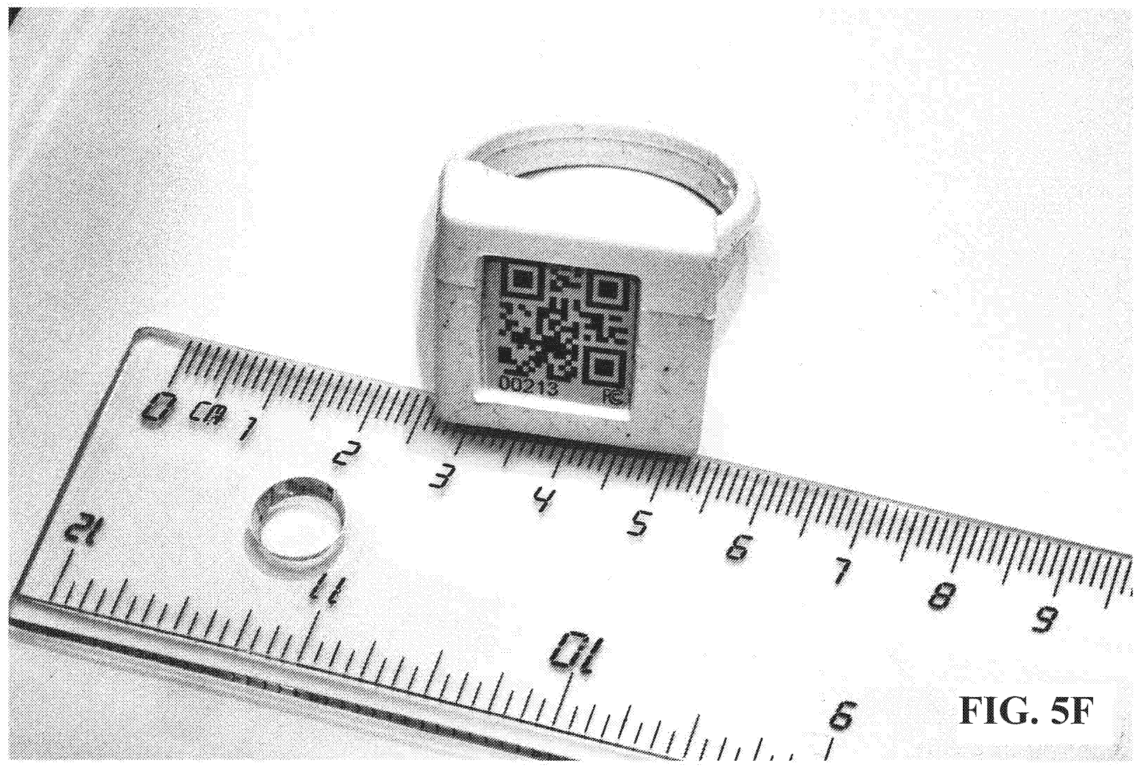

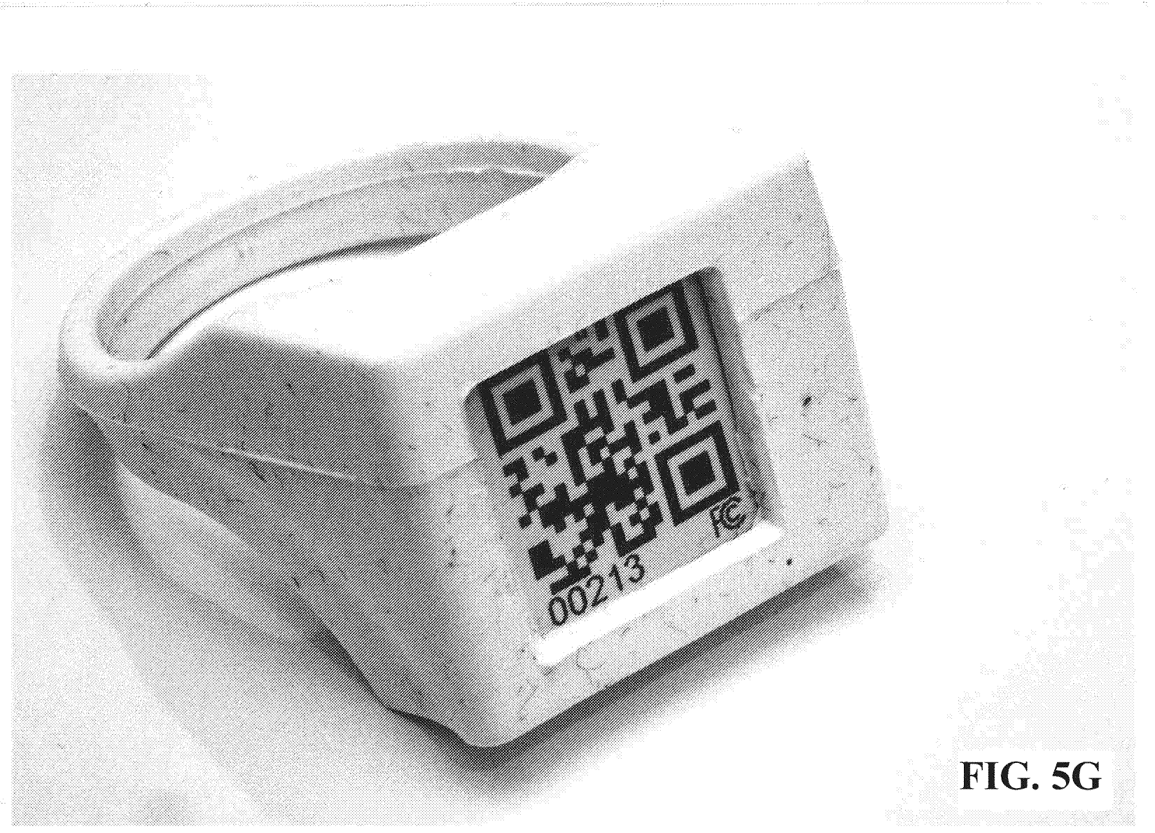

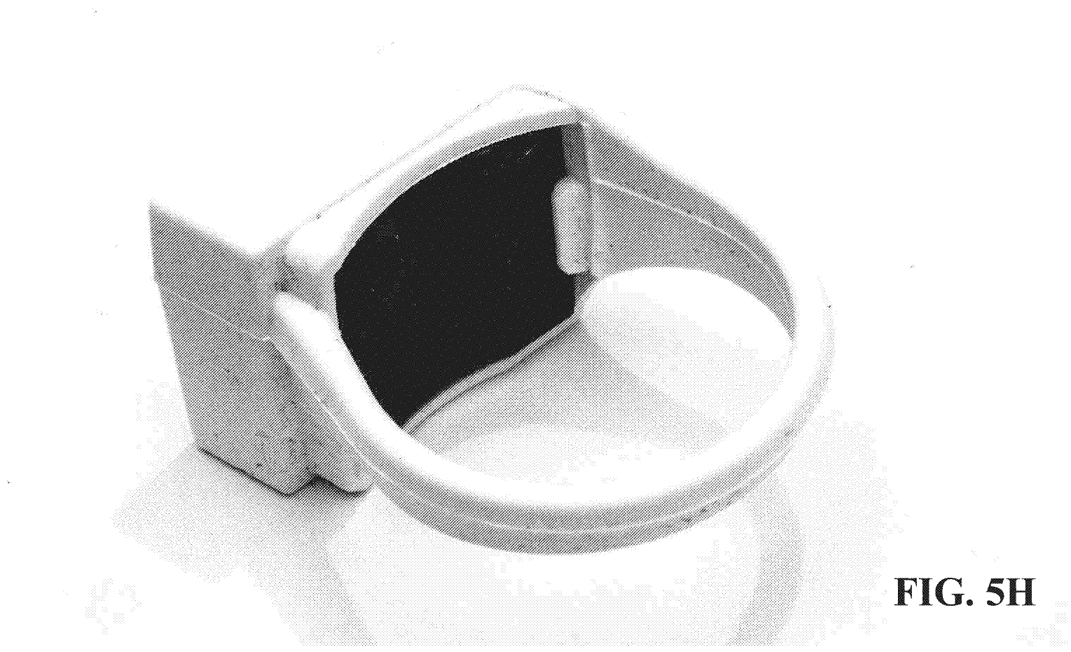

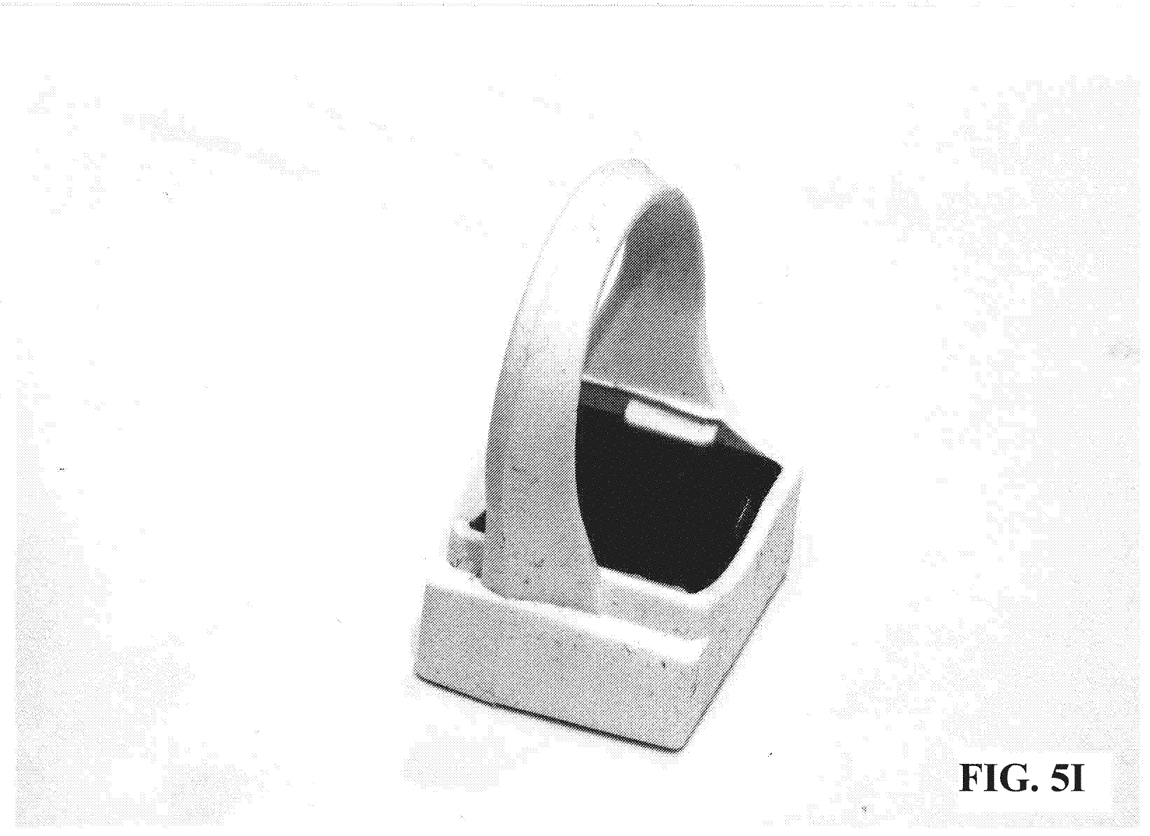

FIGS. 5A to 5I shows an example embodiment of the tag or tag assembly used in an embodiment system of the present disclosure. FIG. 5A shows a front view of a tag's housing including an identifying code (e.g., QR code) for the tag. The identifying code can be on a sticker or other surface which is either situated near to or disposed on a tag or chip or other device. Alternatively, the identifying code can be detected via a near-field communication (NFC) chip, such that no visible identifying code is needed. The tag or chip or other device includes circuitry that stores and communicates tilt, pour, time, and other data to a system embodiment. See, for example, the tag or chip or other device embodiments described herein. The tag housing can be manufactured out of one or more of a variety of plastics, metals, rubbers, and other materials. For example, the tag housing holding the tag or chip can be made of plastic or other material that is infrared transparent for the proximity sensor. For example, the tag band part (portion that appears to be a partial circle in order to fit onto a bottle or object) can be made of silicon or rubber to allow for a certain elasticity and grip onto a bottle or object when fitting the tag or tag housing to the bottle or object. FIG. 5B shows a right side view of a tag's housing. Certain lines from manufacturing can be seen in this figure and other figures, but are not an included portion of the design. FIG. 5C shows a back view of a tag's housing. In this figure, there is a small extra edge which extends from the tag housing over a small portion of the tag or chip device included in the tag's housing. FIG. 5D shows a left side view of a tag's housing. FIG. 5E shows a front-side perspective of a tag's housing with an example measurement showing. This measurement is for an example tag housing. The tag housings can be a variety of sizes, depending upon the tag size to be included and/or the object to be attached to. FIG. 5F shows a front view of a tag's housing with an example measurement showing. FIG. 5G shows a top-front side perspective of a tag's housing. FIG. 5H shows a back-right side perspective of a tag's housing. FIG. 5I shows a right-side-bottom perspective of a tag's housing. In the figure, the ring or partial circle band connecting to the front portion of the tag housing is shown connected at higher than the half-way measurement point along the front portion. In an embodiment, that connection can be at the half-way measurement point along the front portion or the lower-than half-way measurement point along the front portion.

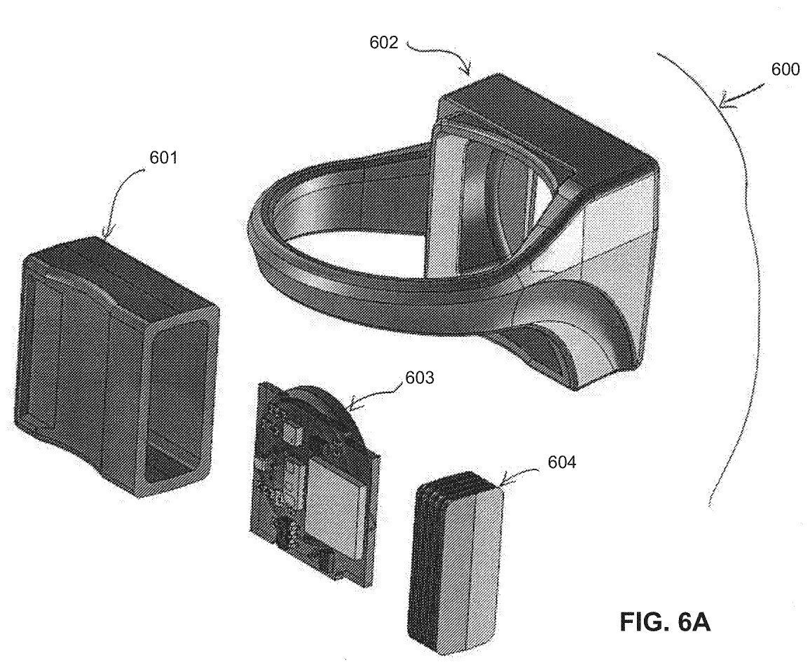

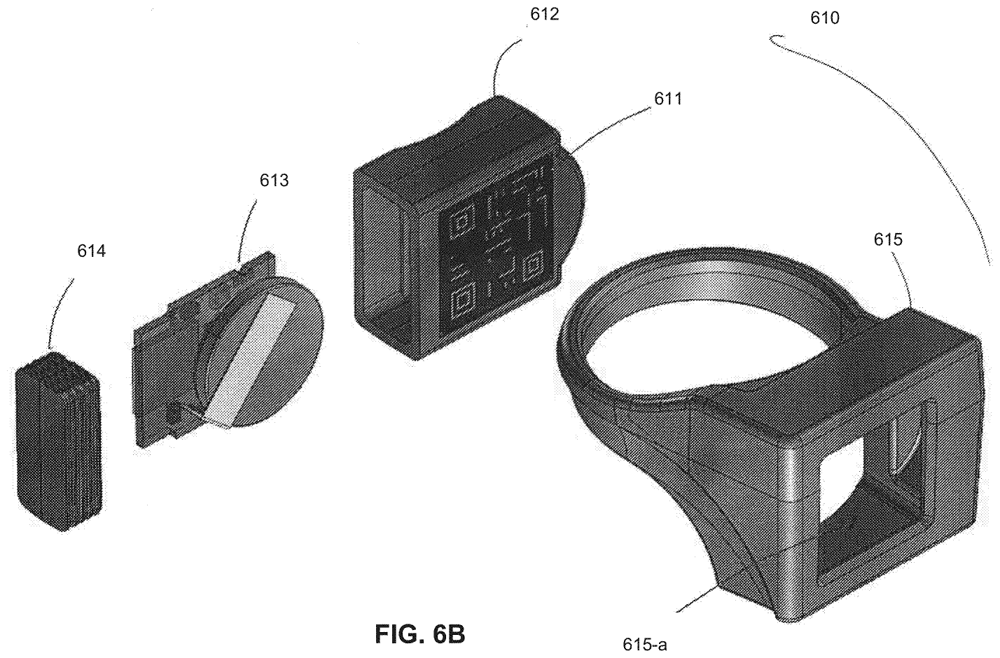

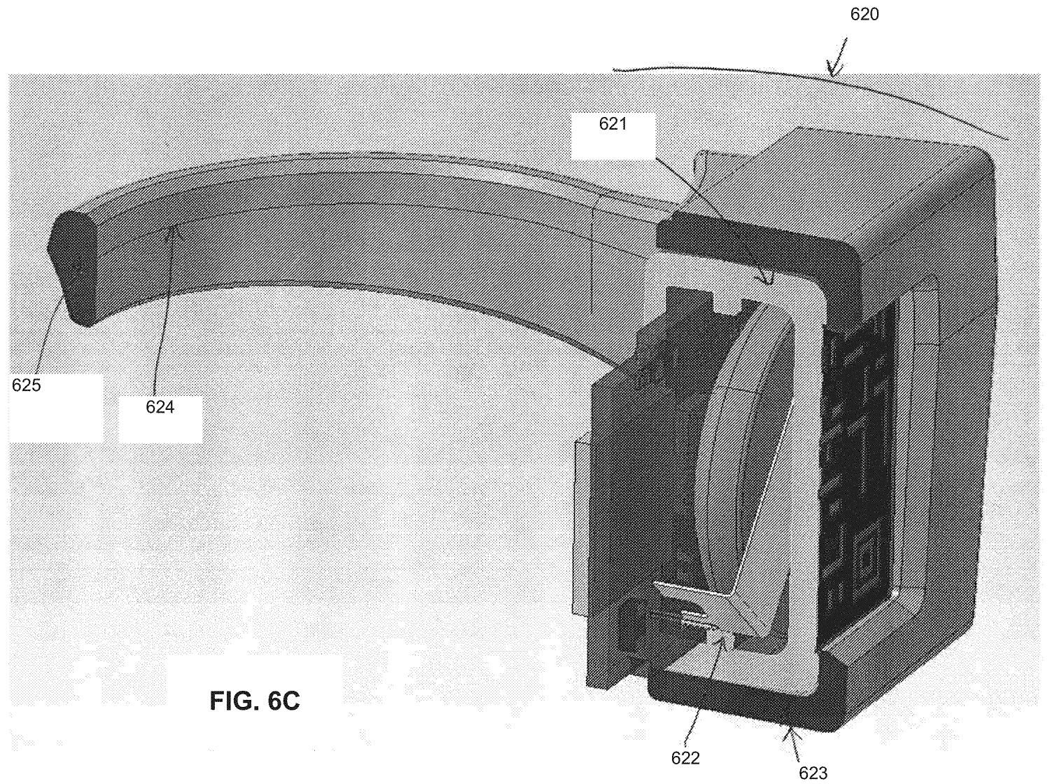

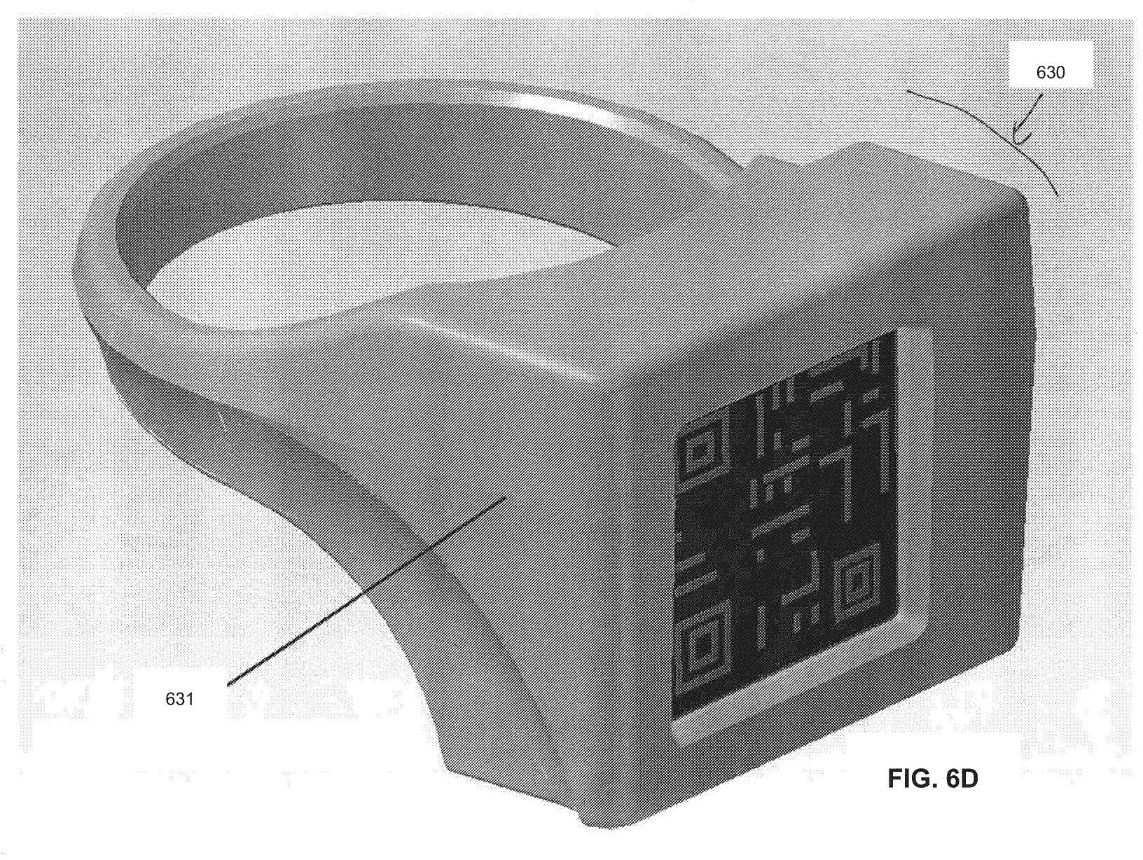

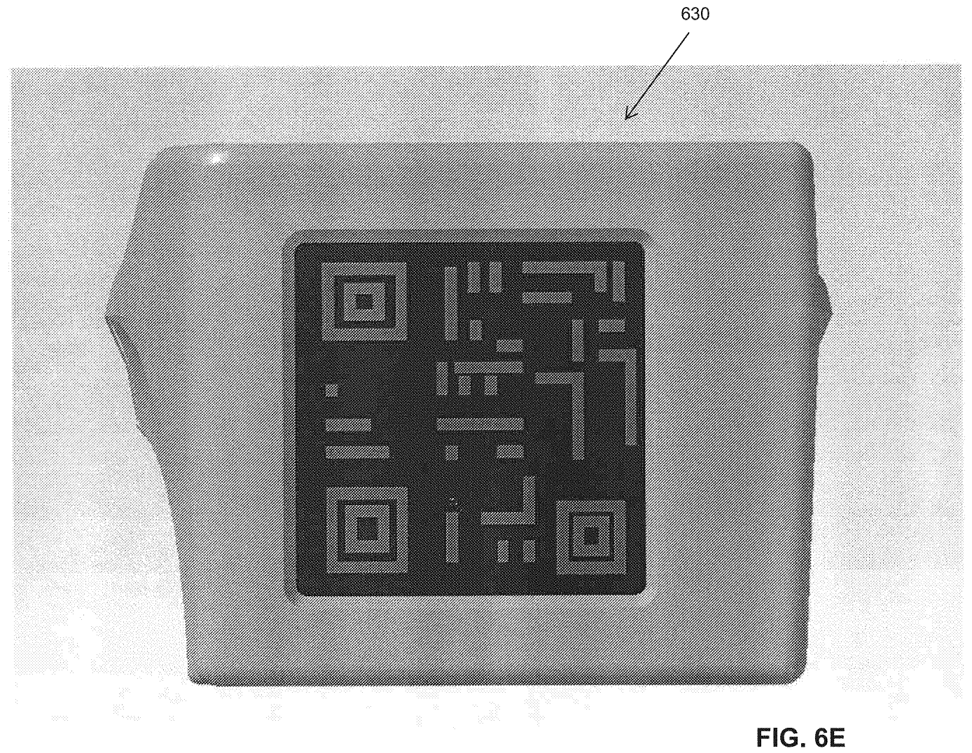

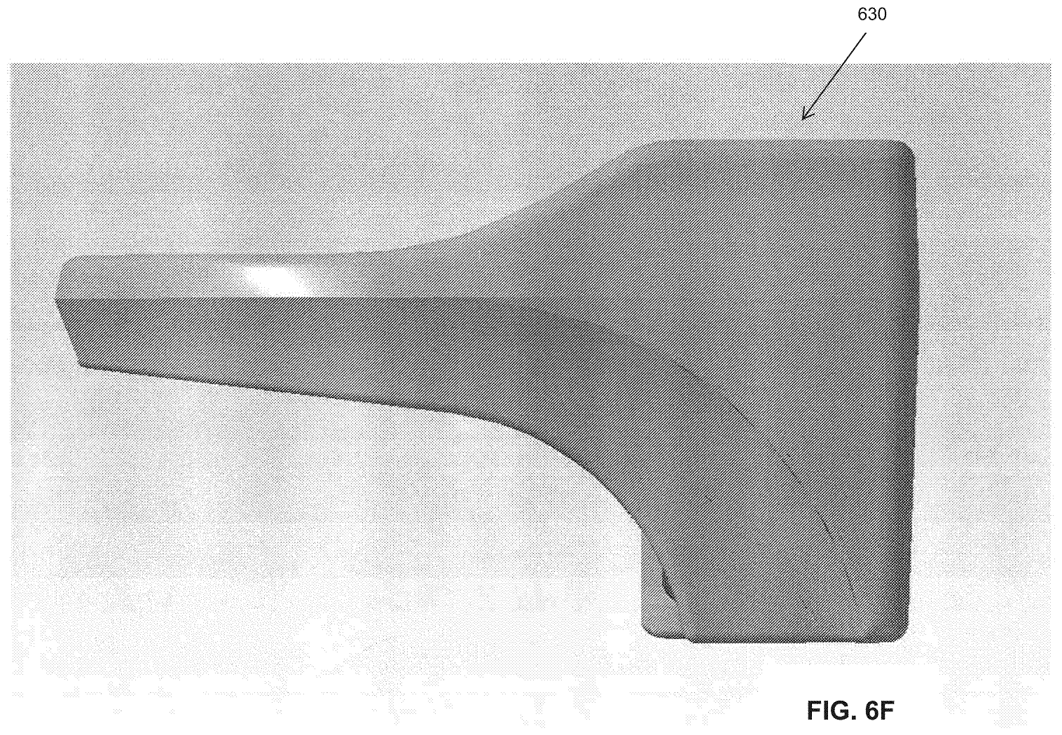

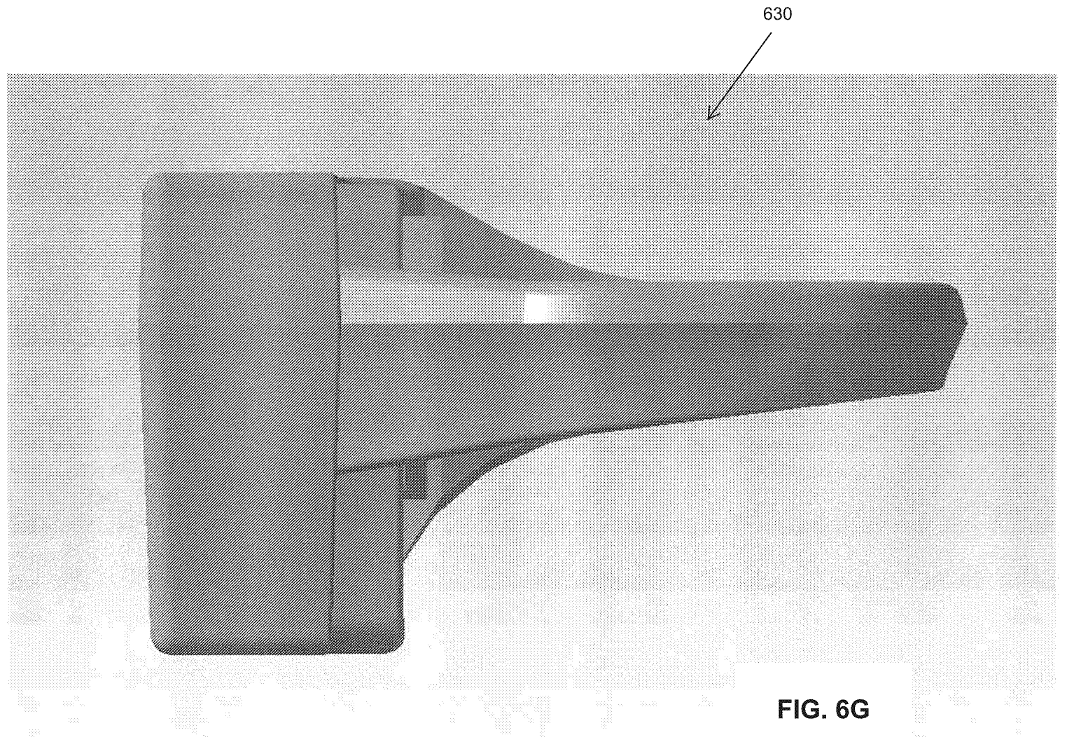

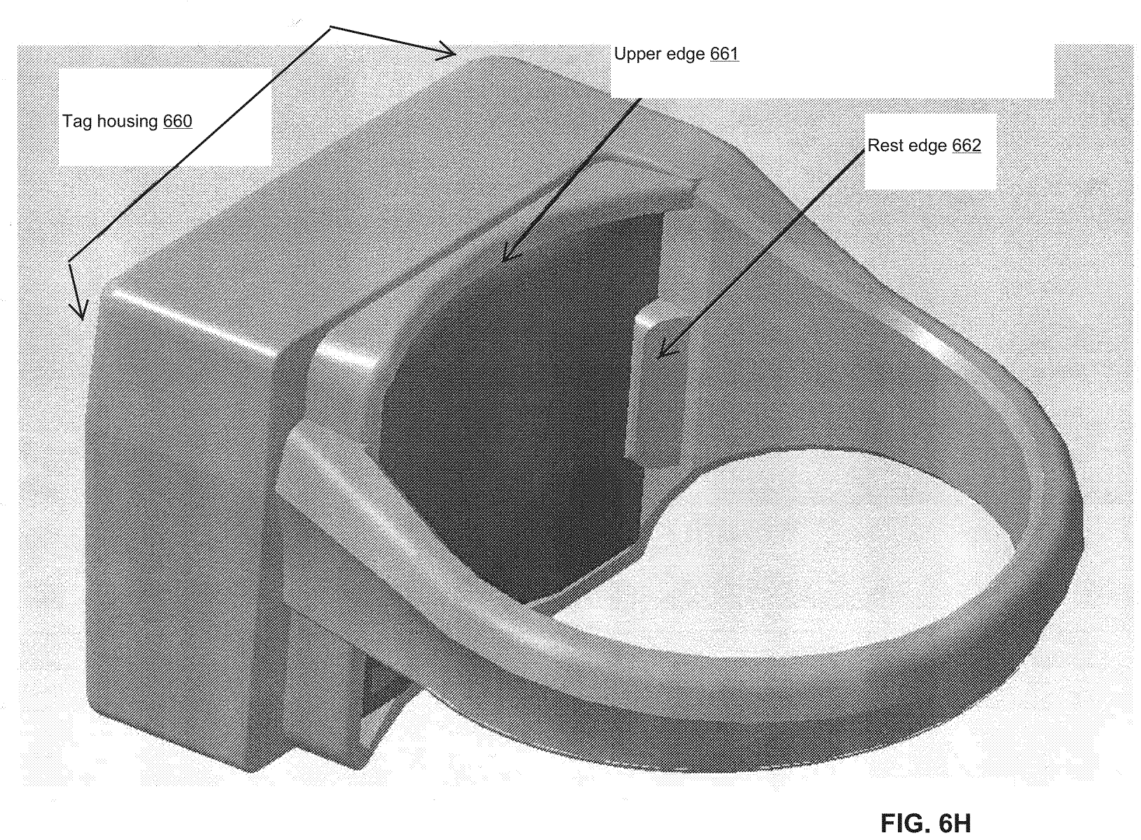

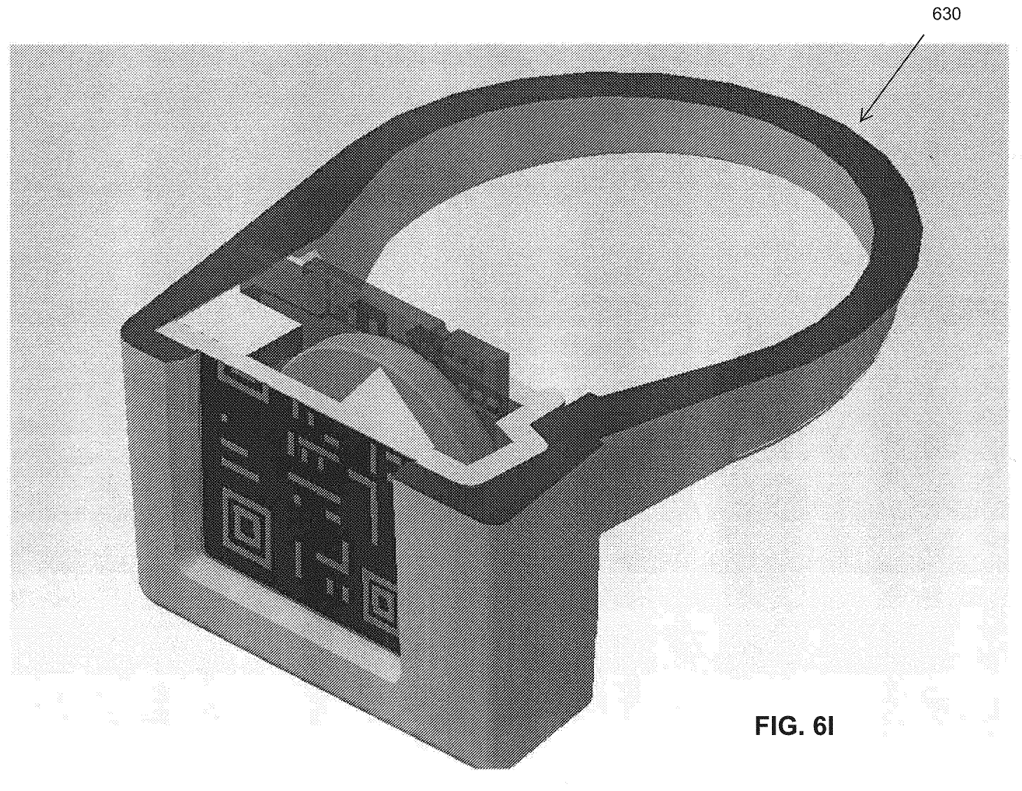

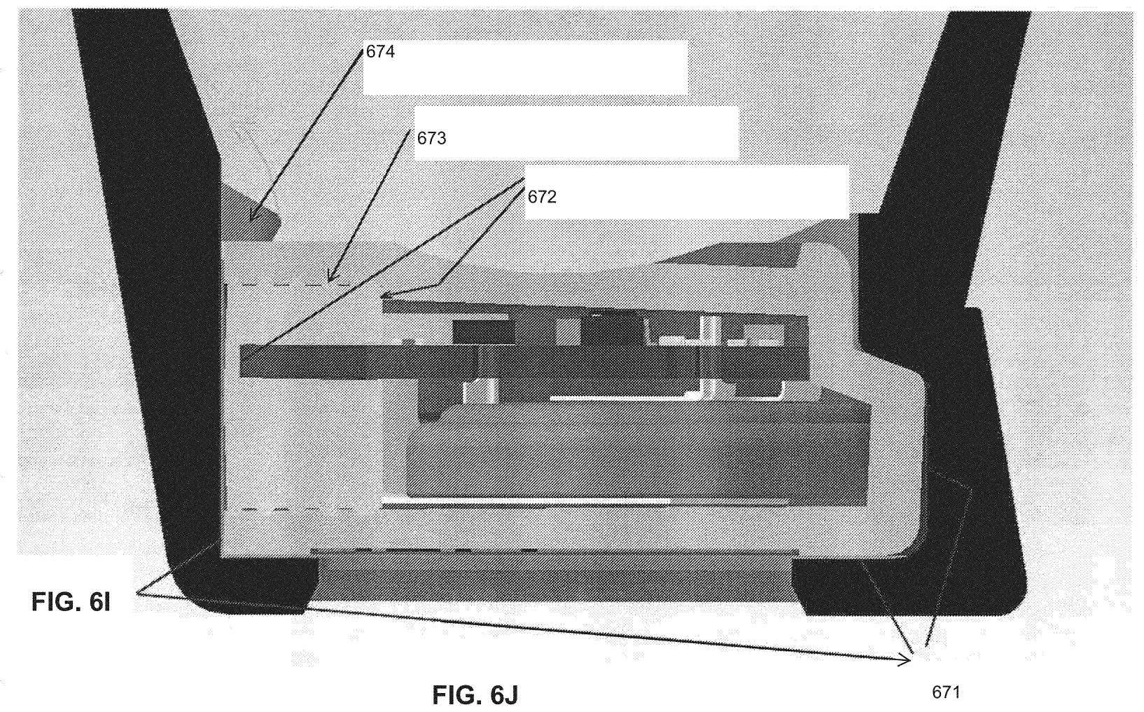

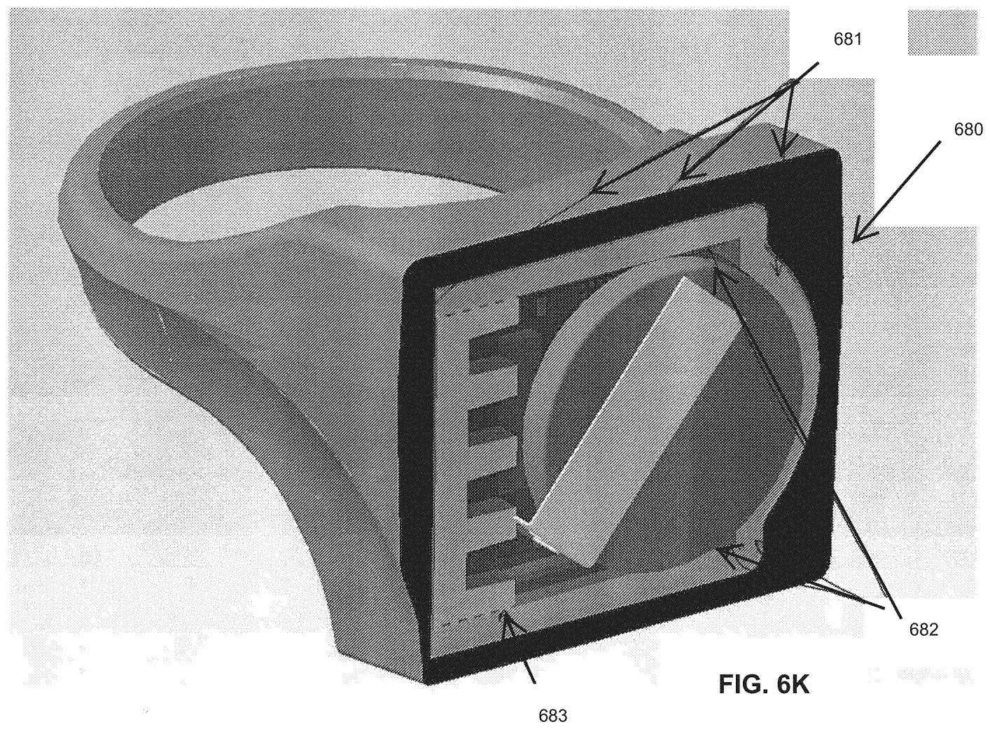

FIG. 6A shows an example embodiment of a tag assembly 600, i.e., tag 603 and housing 601, of the present disclosure. The tag assembly includes a holder 602 of tag 603 and a cap 604 to keep the tag 603 in the holder. The holder 602 with the tag 603 and stopper 604 all fit into the tag housing 601. In an embodiment, the holder 602 is polymer which is IR transparent or other IR transparent material. In other cases, the tag holder may be made of a flexible and stretchy or elastic material such as silicone, rubber, or another flexible material. A spring-metal band could also be used, where the band is open ended, but can be snapped around a container or neck of a bottle. In some cases, the tag holder may be composed of the same material as the band portion of the tag housing, further described below.

In an embodiment, the cap 604 is a rubber or silicon or other elastic-like material. In an embodiment, the band portion of the tag housing 604 is a rubber or silicon or other elastic-like material. FIG. 6B shows an example embodiment of a tag assembly 610 from the front side, having a tag housing 615 with an opening 615A, a tag holder 612 having an opening 611 or a protrusion 611 to account for a battery (or other feature) of the tag circuit 613 and a stopper 614. In an embodiment, the battery is a rechargeable or changeable battery. The tag holder allows for the extraction of the battery from the tag assembly. The opening 615A is provided to allow for a display screen on the tag holder 612 or an identifying code display or other display on the tag holder 612 which is inserted into the tag housing 615. For example, the identifying code display or other display could be 15.5 mm×15.5 mm for a QR code or bar code label of 15 mm×15 mm, to display through the opening 615A of the same or similar measurement. FIG. 6C shows a tag assembly 620 having a band 625 made of an elastic or gripping type of material, the band 625 can include one or more ridges 624 to increase the grip of the band. The tag has a holder 621 shown in a cross section view, with certain uplifted edges 622 to assist in keeping the tag features stationary or set. The tag housing 623 can be a harder material than the band 625, in order to keep straight and stationary (and to protect) the tag circuit. FIG. 6D shows an example tag assembly 630 having a texture line 631 from the manufacture of the tag housing. The tag housing can be 3D made or made via a set mold or other method. In an embodiment, the tag housing is one piece. In an embodiment, the tag housing is more than one piece fitted together.

FIG. 6E shows a front side of the tag assembly, displaying a quick response (QR) code, or multidimensional barcode or other display. FIGS. 6F and 6G show right and left side views of the tag assembly. FIG. 6H shows a tag housing 660 having an upper edge 661, and a rest edge 662. These edges allow for keeping the tag holder in the tag housing, and for easy removal of the tag holder from the tag housing. FIG. 6I shows a horizontal cross-section of the tag assembly, showing the tag holder and tag inside the tag housing. FIG. 6J shows a top view of a horizontal cross section of the tag assembly 670, having space and/or elastic 671 allowing for movement when getting the tag holder out of the tag housing. The rest edge 674 (similar to the edge 662 of FIG. 6H), the stopper 673, and the holder edges 672 are also shown. FIG. 6K shows a front vertical cross-section view of the tag assembly 680. There is an airgap all around 681 is shown to allow for manipulating the tag holder out from the tag housing. The edge 683 is shown for keeping features in place. Spaces 682 are also shown.

In embodiments of the present disclosure, in order to determine the amount of liquid poured from a container, e.g., a bottle (for purposes of illustration here), various features need to be known and/or measured as described further below.

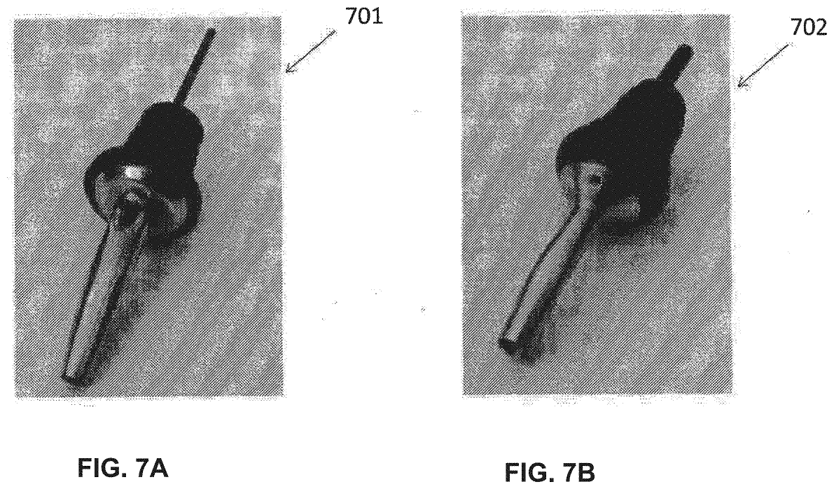

FIG. 7A shows an example spout 701 with a circular outflow of 5 millimeters (mm) in diameter that can be used in an embodiment of the present disclosure. In an embodiment, a specific algorithm calculating pour information takes into account that a bottle or container uses a spout for pouring, and specifically the circular outflow of the spout. FIG. 7B shows an example spout 702 with a circular outflow of 7 millimeters (mm) in diameter. In an embodiment, an algorithm or data generating process and system takes into account the size of the circular outflow of a spout attached to a bottle or container for pouring. In an embodiment, an algorithm or data generating process and system takes into account the types or viscosities of the liquid to be poured. For example, some types of liquids are: aqueous liquids, including vodka, rum, tequila, whiskey, wine, Cointreau, Grand Marnier, et al.; others are more viscous such as Baileys and Godiva liqueurs. In an embodiment, an algorithm or data generating process and system takes into account the size and shape of the bottle or container. For example, some bottles of different shapes include: Baileys; Cointreau; Godiva; Grand Marnier; Knob Creek whiskey; and wine bottle.

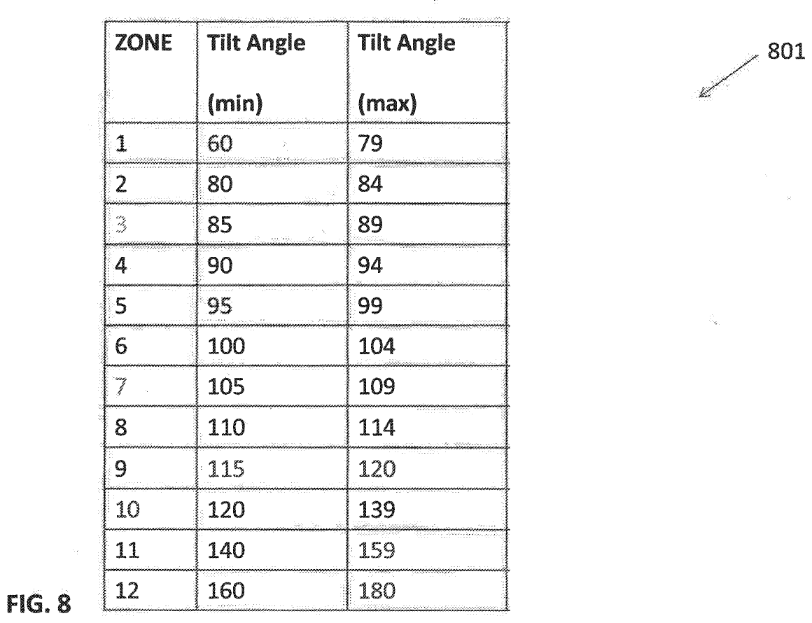

FIG. 8 shows a table 801 of angle zones of a tag or sensor on a liquid container according to an embodiment of the present disclosure. In an embodiment of the present disclosure, in order to determine the amount of liquid poured from a bottle (or container), the tilt angle is measured over time by a sensor, or tag (as referred to interchangeably herein), disposed on the bottle. In an embodiment, an algorithm or data generating process and system takes into account the geometrical parameters of the bottle's shape and size, the initial liquid content, and the tilt angle, in order to determine the amount of liquid poured. Embodiments of the present disclosure provide systems and methods for handling bottles or containers with and without an attached spout. In an embodiment, the tilt angle of a bottle varies between zero degrees (upright) and 180 degrees (upside down). That is, if the tilt angle is zero degrees, then the bottle head or tip is vertically upwards. If the tilt angle is 180 degrees, then the bottle head or tip is vertically downwards. The sensor is measured as detecting at least twelve angle zones as listed in FIG. 8. In an embodiment, an algorithm or data generating process and system takes into account the tilt angle, and where available, the average tilt angle for a specific zone.

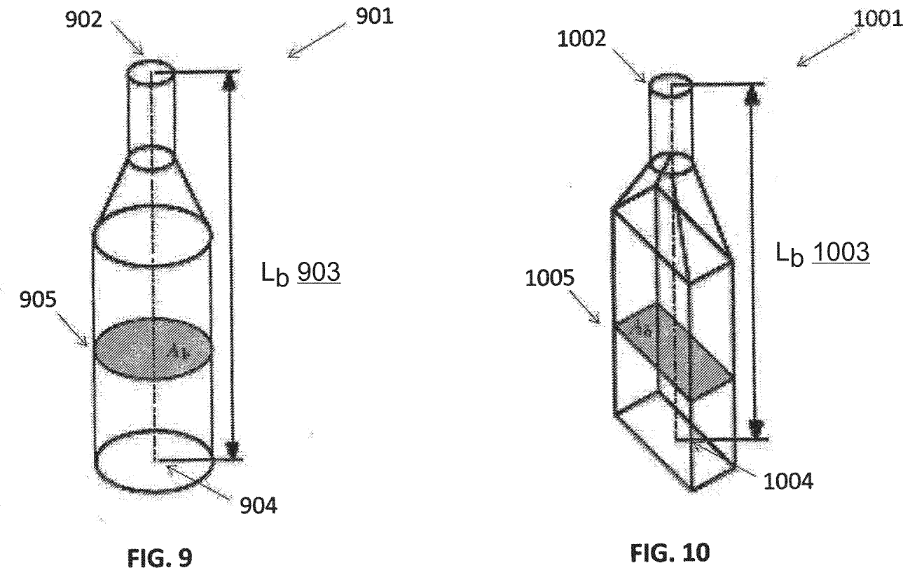

FIG. 9 shows a schematic sketch of a cylindrical bottle 901 according to an embodiment of the present disclosure. The bottle 901 has a tip or head 902, a length 903, a bottom 904, and a cross-section 905 of the center portion of the bottle. From the cross-section, the circumference and diameter can be determined. FIG. 10 shows a schematic sketch of a rectangular bottle 1001 according to an embodiment of the present disclosure. The bottle 1001 has a tip or head 1002, a length 1003, a bottom 1004, and a cross-section 1005 of the center portion of the rectangular bottle. The length and the cross-section are parameters needed for use in determining how much liquid has been poured as described further herein.

In embodiments of the present disclosure, various algorithms or data generating processes or systems are described herein. For example, Formula A for a pour from a bottle having an attached spout is as follows:

$${V}_{pour} - 100 \times {A}_{sp} {\sum }_{i = 1}^{12} {v}_{i} {t}_{i} - C \sqrt{{L}_{b} - \frac{{V}_{ini}}{{A}_{b}}} \qquad Equation ( 1 )$$

In this embodiment, the parameters include: Vₚₒᵤᵣ as the poured liquid volume and measured in milliliters (ml); Vᵢₙᵢ as the initial liquid volume in the bottle before the pour and measured in milliliters; Asp as the cross section of the spout at circular outflow and measured in square centimeters (cm²); Ab as the cross section of the lower or largest diameter portion of the bottle and measured in cm²; L_{b} as the length of the bottle and measured in centimeters; Vi as the outflow velocity in zone i where f(tilt angle i, spout, liquid) and measured in meters per second; tᵢ as time in zone i and measured in seconds, and C as empirical constant where f(spout, liquid) is measured in cm ³/². The first term on the right-hand side of the above formula represents the outflow of the liquid through the spout. Asp represents the outflow cross section of the spout, which is for a circular cross section, calculated by πDₛₚ²/4, where Dₛₚ is the diameter of the circular outflow cross section. For example, for a Dₛₚ of 5 mm and 7 mm, cross sections Asp of 0.19635 cm² and 0.384845 cm², respectively, can be obtained. The average outflow velocity in an angle zone i is shown as vᵢ. In experiments, it was found in emptying experiments that the outflow velocity is constant, for a given spout, liquid and tilt angle, independent of the initial liquid volume in the bottle. It was found that the correlation between emptying time and the poured amount of liquid appears to be linear, i.e., constant velocity. Further, it was found that the emptying time appears to be independent of the shape of the bottle, when conducting an experiment using a wine bottle, Cointreau bottle and a Knob Creek bottle. For greater ease of implementation, the above equation can be rewritten as:

$${V}_{pour} - 100 \times {A}_{sp} {\sum }_{i = 1}^{12} {v}_{i} {t}_{i} - C \sqrt{\frac{{L}_{b}}{2}} \qquad Equation ( 2 )$$

The simplification of the values within the square root to L_{b}/2 effectively takes a rough average.

In conducting emptying experiments, it was found that the experimental outflow velocity v is approximately constant at large tilt angles, e.g., greater than 140 degrees. It was found that the experimental outflow velocity v decreases linearly with decreasing tilt angle. In order to match actual pours effectively, the average velocities vi are optimized by least squares fitting of the above Equation (1) or (2) to experimental pours, where the amount of poured liquid is measured with a weighing scale, with the restriction that the resulting velocity profile has to be in the same range and of the same shape (constant velocity at large angles and linear decrease with decreasing angles) as that obtained by the emptying experiments described above.

In embodiments with large pours, one can assume an essentially constant outflow velocity. However, where there are small pours, the acceleration of the liquid in the bottle has to be accounted for as well. In Equation (1) or (2), the second term on the right-hand side of the formula represents the influence of the acceleration of the liquid. The empirical constant C depends upon the spout and the liquid type. Such included parameters are gravitational acceleration and the outflow cross section of the spout. This is obtained via the least squares fitting of Equation (1) or (2) to experimental pours.

In FIGS. 9 and 10, the length of the bottle L_{b} and the cross section of the main lower part of the bottle A_{b} are shown and taken into consideration in Formula A. If the main lower part of the bottle is not cylindrical or constant mainly in shape, and instead is conical, curved, or of another complex shape, then an average value for A_{b} is taken and used in Equation (1) or (2). For greater accuracy, a shape profile can be developed rather than taking a mere average. It has to be ensured here that Vᵢₙᵢ/A_{b}>L_{b} otherwise the square root would result in a complex number.

In validating Equation (1), the results of the experimental pours were compared to the results of Equation (1). The relative deviation of the calculated pour Vₚₒᵤᵣ from the experimental pour Vₑₓₚ is defined by Equation (3):

$$\tilde{r} = \frac{{V}_{exp} - {V}_{pour}}{{V}_{exp}} \qquad Equation ( 3 )$$

Note, the above also necessitated the use of a weighing scale and the knowledge of the density of the liquid poured. The average value μ of a discrete number of quantities Z is defined by Equation (4):

$$μ ( \tilde{r} ) = \frac{1}{N} {\sum }_{n = 1}^{N} {\tilde{r}}_{n} \qquad Equation ( 4 )$$

The standard deviation of μ(r) discrete number of quantities Z from its average value is shown in Equation (5):

$${σ ( \tilde{r} ) = \sqrt{\frac{1}{N}} {\sum }_{n = 1}^{N} - μ ( \tilde{r} ) )}^{2} \qquad Equation ( 5 )$$

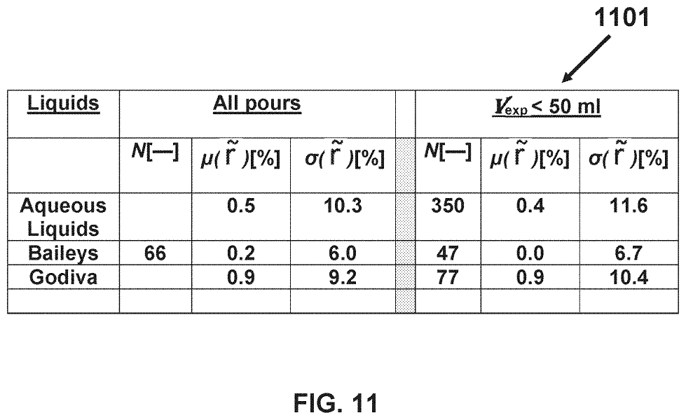

FIG. 11 shows example statistical quantities 1101 of beverage pours according to an embodiment of the present disclosure using a 5 mm spout on the bottle. In FIG. 11, N is the number of performed pours, μ(\tilde{r}) is the average value of the relative deviation, and σ(\tilde{r}) is the standard deviation of the relative deviation. On the left hand side of FIG. 11, all pours are represented. On the right hand side of FIG. 11, only pours smaller than 50 ml are shown.

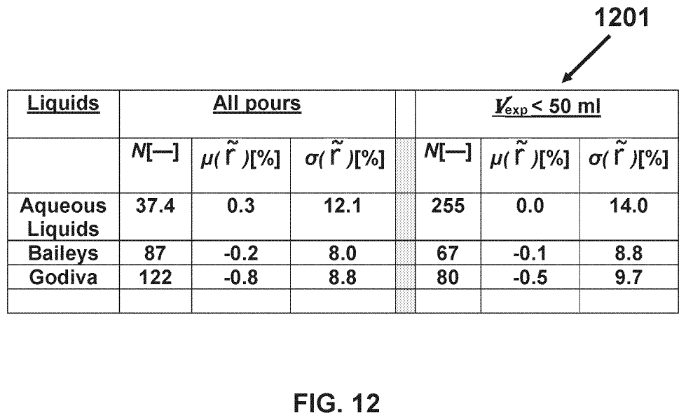

FIG. 12 shows example statistical quantities 1201 of beverage pours according to an embodiment of the present disclosure using a 7 mm spout on the bottle. In FIG. 12, N is the number of performed pours, μ(\tilde{r}) is the average value of the relative deviation, and σ(\tilde{r}) is the standard deviation of the relative deviation. On the left hand side of FIG. 11, all pours are represented. On the right hand side of FIG. 11, only pours smaller than 50 ml are shown.

The experiments were conducted with aqueous liquids in four different types of bottles, i.e., Cointreau, Grand Marnier, Knob Creek, and wine bottle. The experiments were also conducted with four different liquids, i.e., Cointreau, Grand Marnier, Knob Creek whiskey, and water. In FIG. 11 and FIG. 12, the statistical quantities corresponding to the direct comparisons made between the calculated pours and the experimental pours for the 5 mm and 7 mm spout are listed. The average values of the relative deviation μ(\tilde{r}) were determined for all configurations within a range of ±1°, indicating a close agreement between the calculated and measured pours. The standard deviations σ(\tilde{r}) were determined to be smaller than 12% for all experiments with the 5 mm spout. For the 7 mm spout, the obtained standard deviations are slightly larger (<14%) due to shorter time scales.

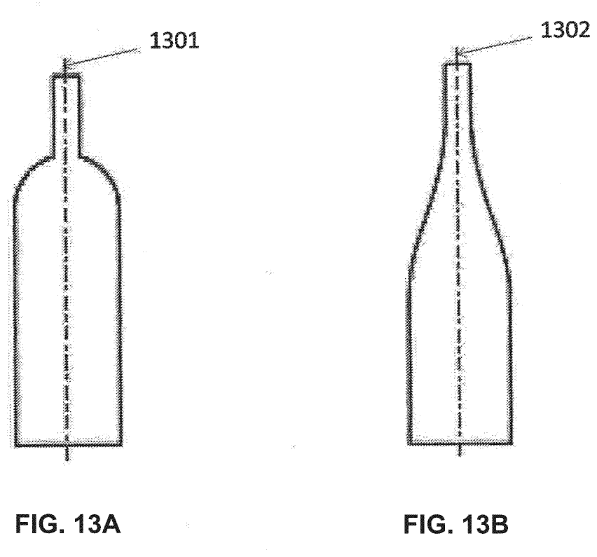

FIG. 13A shows a schematic sketch of a wine bottle 1301 used without a spout according to an embodiment of the present disclosure. The circular outflow of the wine bottle 1301 depicted is about 19 mm in diameter.

FIG. 13B shows a schematic sketch of a wine bottle 1302 used without a spout according to an embodiment of the present disclosure. The circular outflow of the wine bottle 1302 depicted is about 19 mm in diameter, and noticeably has a different cross section of the lower main portion from the wine bottle 1301 of FIG. 13 A.

In embodiments of the present disclosure where there is no spout used on a bottle, the following Equation (6) can be used

Vₚₒᵤᵣ=100×AₒᵤₜΣᵢ₌₁¹²vᵢtᵢ Equation (6)

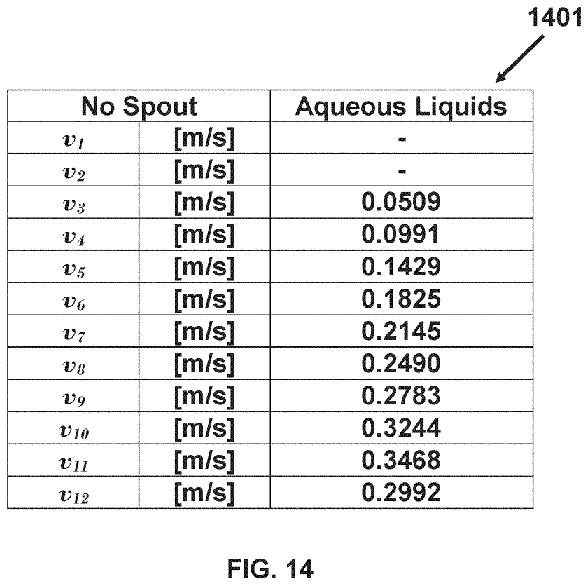

In Equation (6), Aₒᵤₜ is the outflow cross section of the bottle. For wine bottles with an outflow of 19 mm in diameter, an Aₛₚ of 2.835287 cm² is obtained. As with the pours with a spout, the outflow velocity is assumed to be constant for a given liquid, outflow diameter and tilt angle, independent of the initial liquid volume. In order to optimize predictions of the amount of poured liquid, the velocity profile obtained by emptying experiments is fitted to the results of experimental pours. The resulting velocity profile values are shown in FIG. 14.

FIG. 14 shows example outflow velocities 1401 for beverage pours from a bottle without a spout such as that shown in FIGS. 13A, 13B according to an embodiment of the present disclosure.

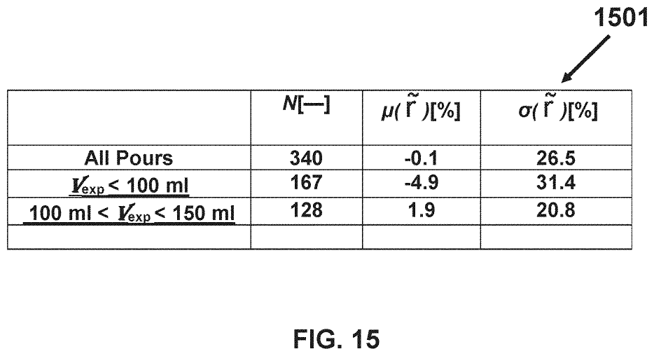

FIG. 15 shows example statistical information 1501 on experimental beverage pours from a bottle without a spout according to an embodiment of the present disclosure. In FIG. 15, N is the number of pours, μ(r) is the relative deviation of the calculated pour from the experimental pour, μ(\tilde{r}) is the average value of the relative deviation, and σ(\tilde{r}) is the standard deviation of the relative deviation.

Embodiments of the present disclosure provide for an artificial intelligence (AI) solution by providing granular situation and response pairings, allowing for a company to obtain better forecasting for their business in inventory, usage, waste, and the like. For example, in the embodiments provided herein, example granular situation and response pairings are provided. For example, such Al provides for better forecasting, and thus, reordering.

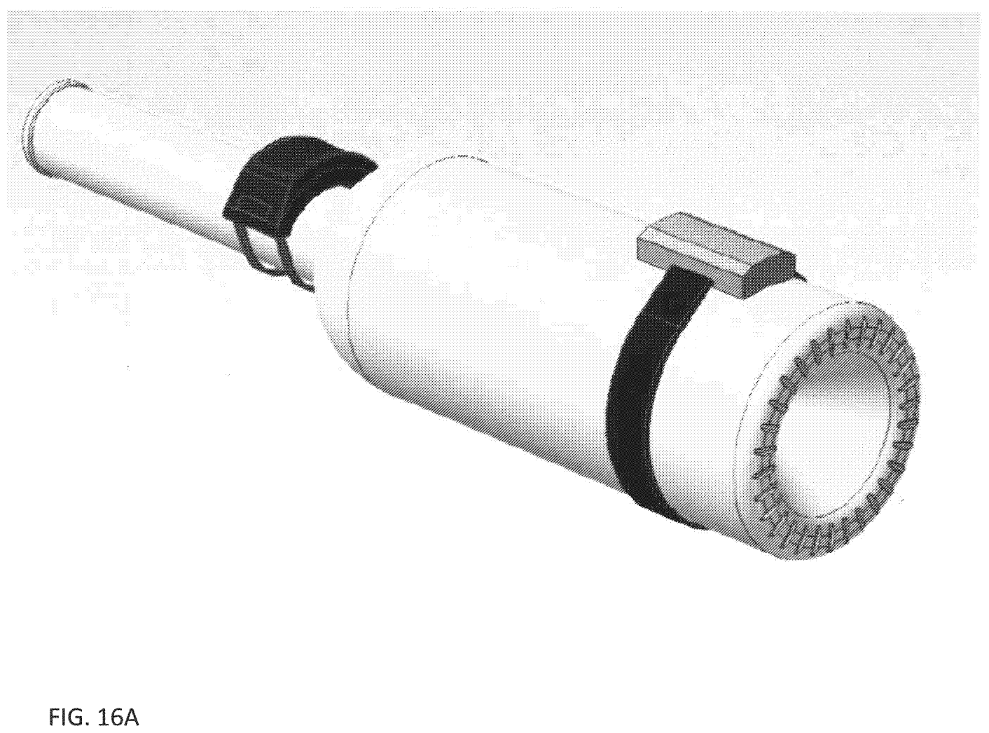

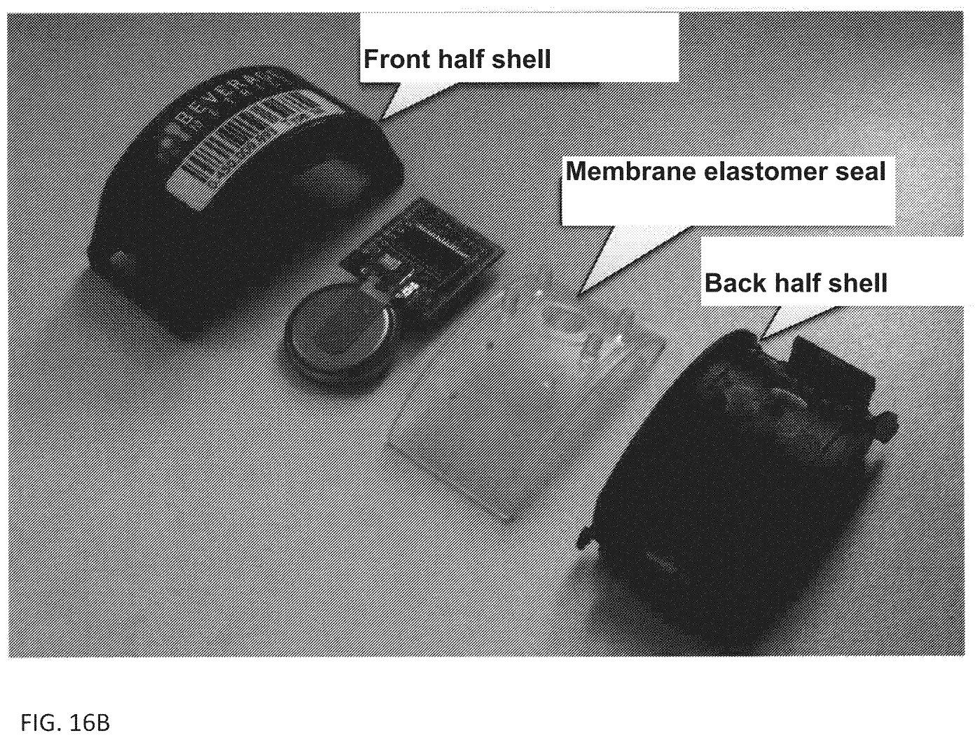

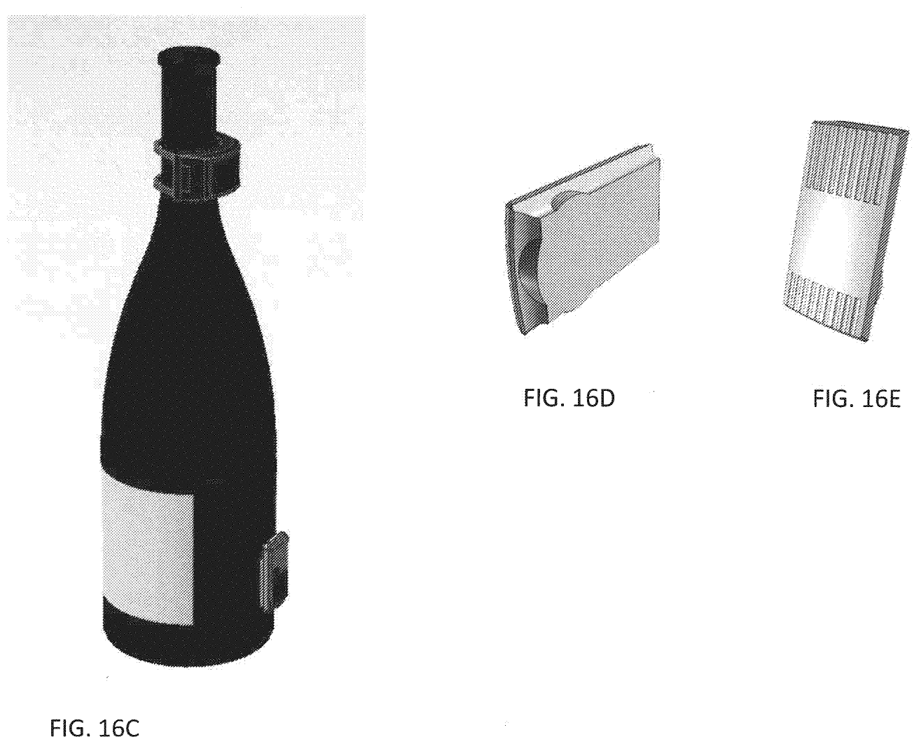

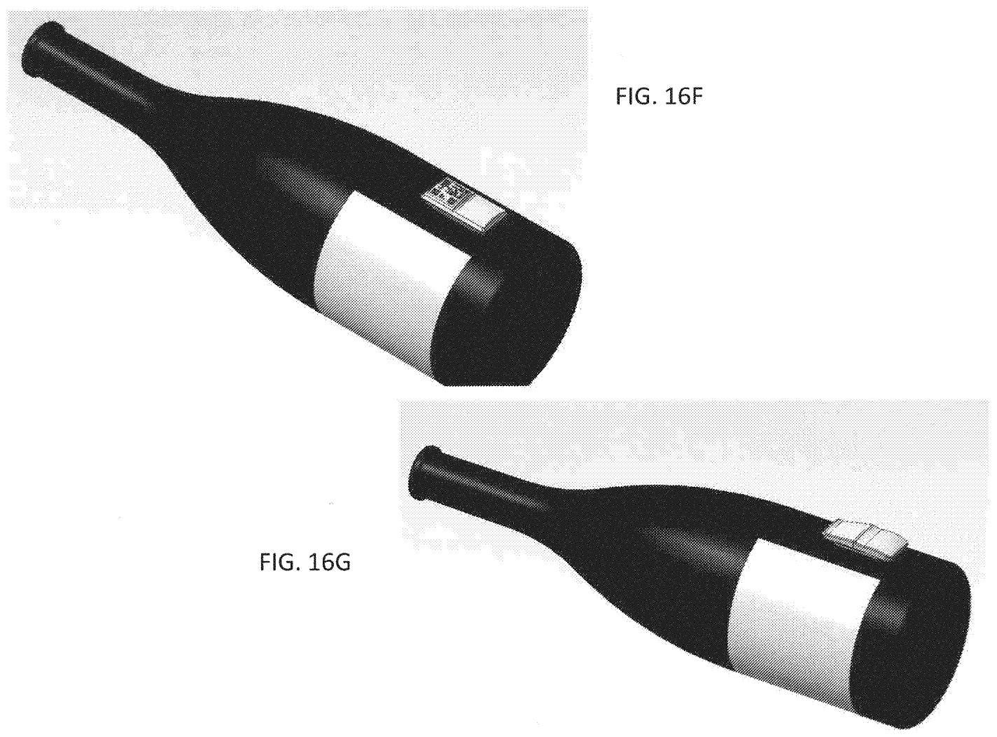

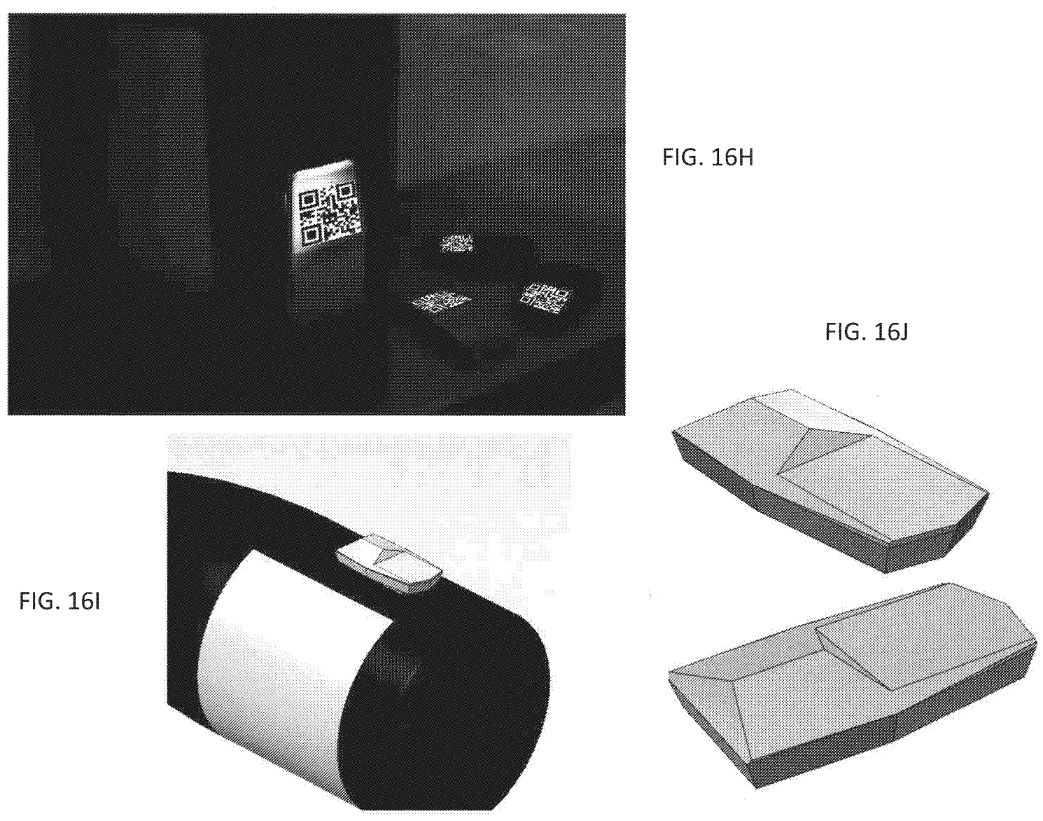

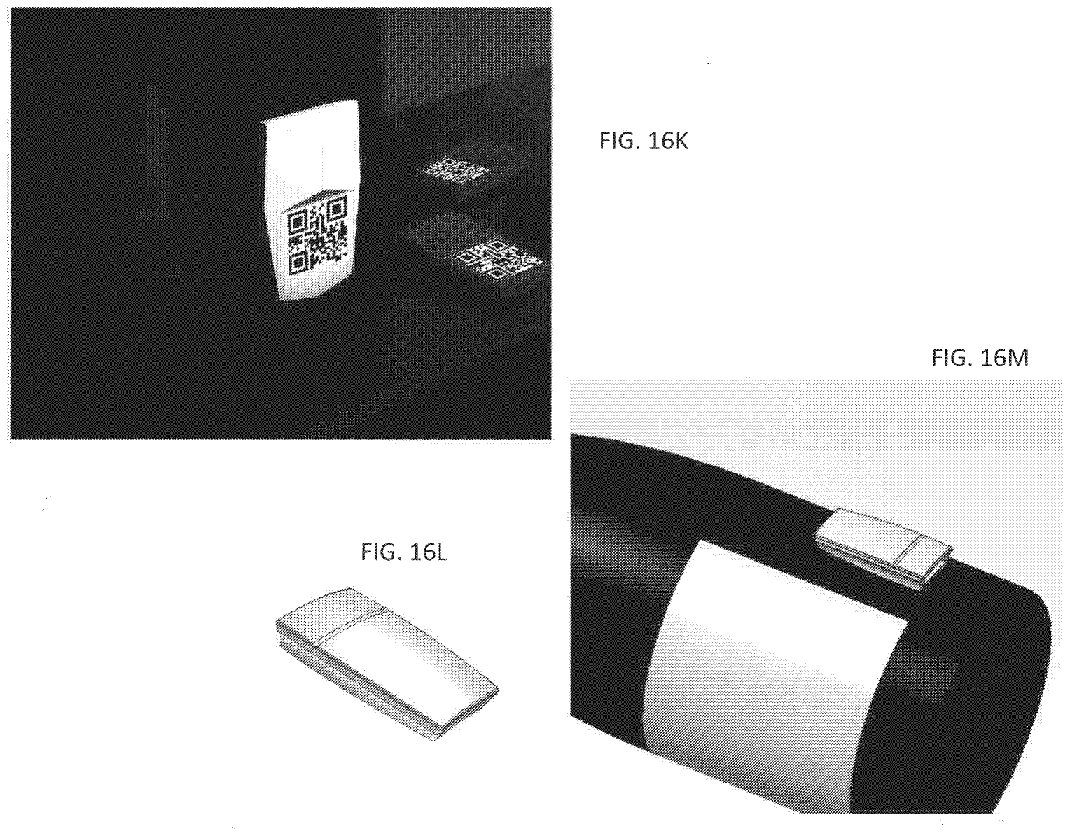

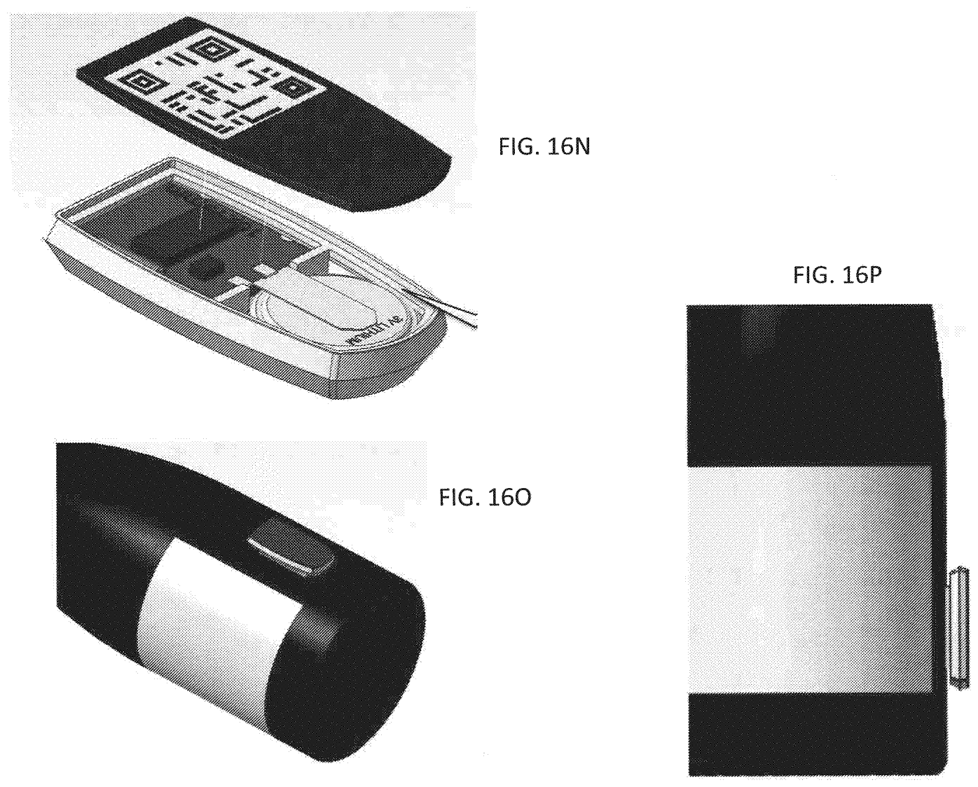

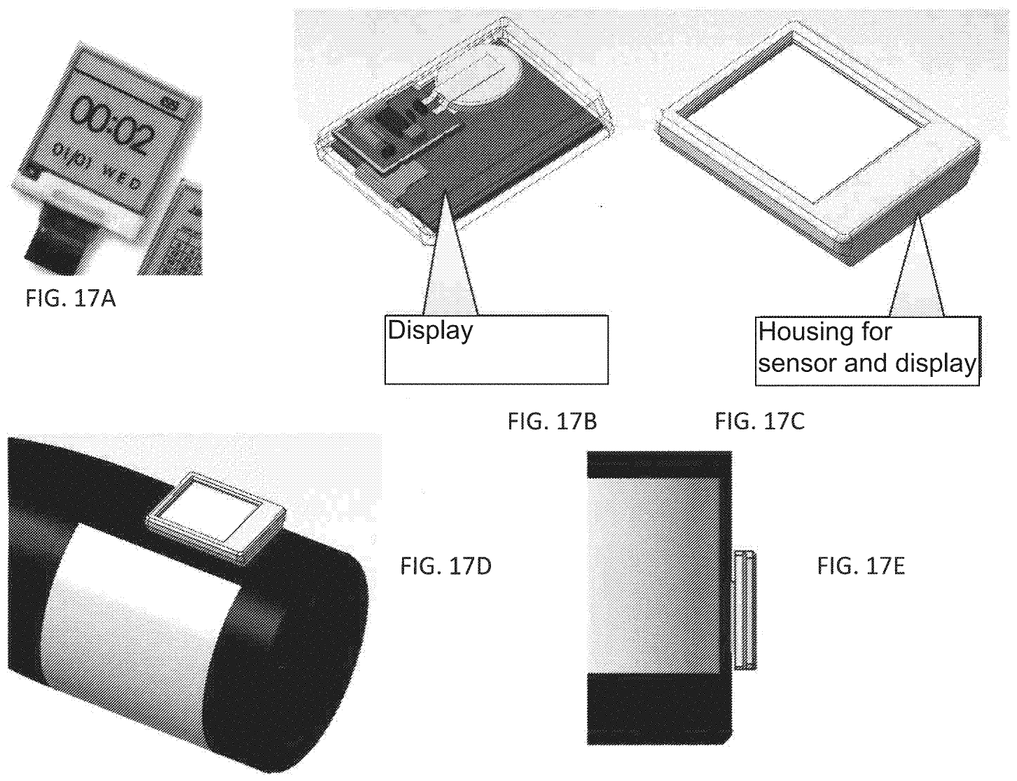

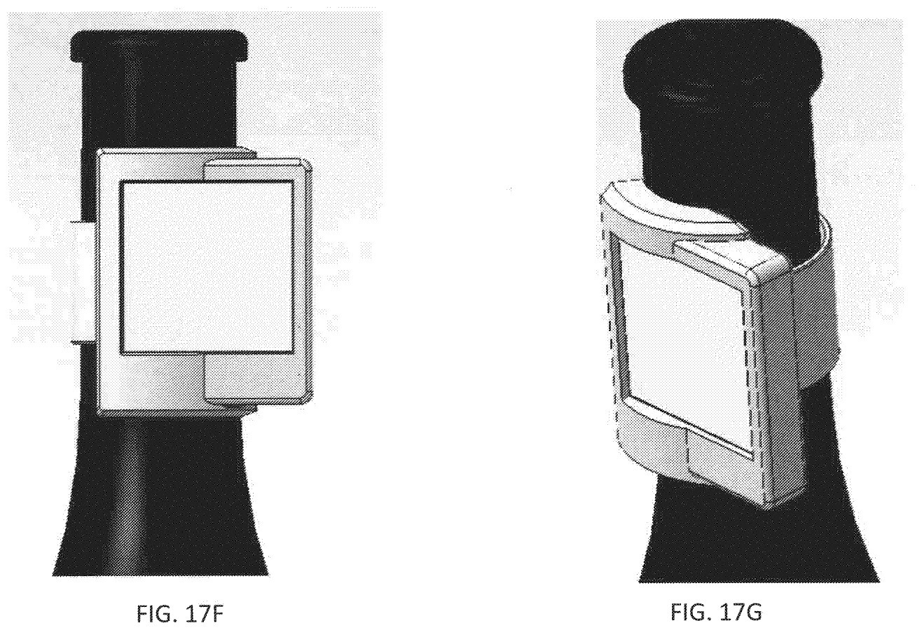

FIGS. 16A to 16P show different embodiments of a tag housing. These tag housings can be attached at various points on a bottle or another container for holding a liquid. These tag housings can be a variety of shapes, allowing for easy removal of a tag or a battery from the tag housing. The tag housings and features of FIGS. 17A to 17G also depict a variety of attachment options for attaching a tag with a container, such as a bottle or another object for holding liquids. For example, a band, a rubber band, a belt-like structure, a ring-band like structure, hook-and-loop, adhesive, and other attachment options may be used.

FIGS. 17A to 17G show different embodiments of tag features, including an electronic display screen. A user can wirelessly transmit, via the computer system or another device in communication with the transceiver in the tag a value or information to be displayed on the electronic screen display (e.g., see FIGS. 17A/B/C), such as the fluid type or brand. Alternatively, the CPU of the tag may be utilized to display the fluid level in the bottle or other relevant information.

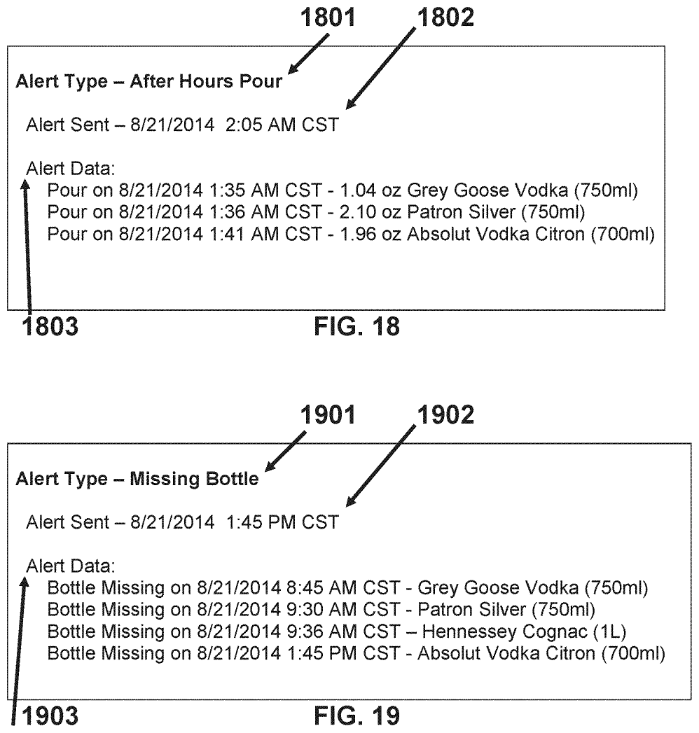

FIG. 18 shows an example alert report according to an embodiment of the present disclosure.

FIG. 19 shows an example alert report according to an embodiment of the present disclosure.

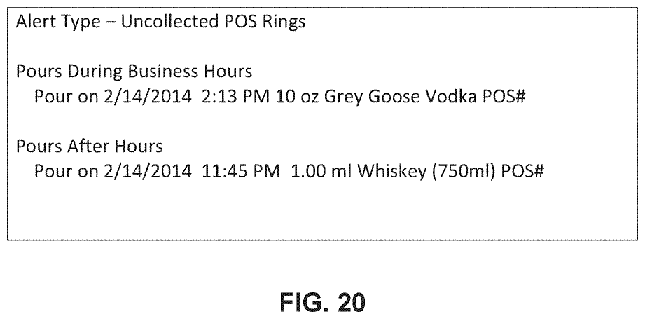

FIG. 20 shows an example alert report according to an embodiment of the present disclosure.

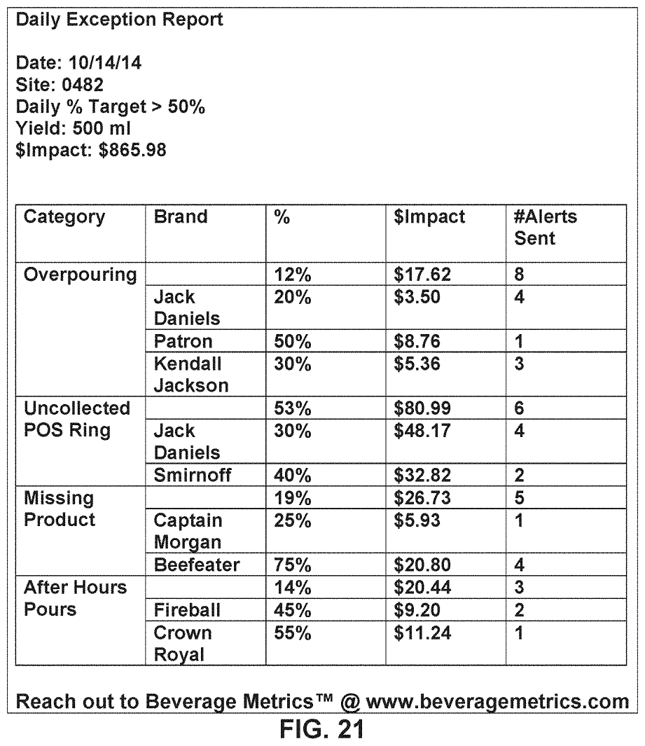

FIG. 21 shows an example exception report according to an embodiment of the present disclosure.

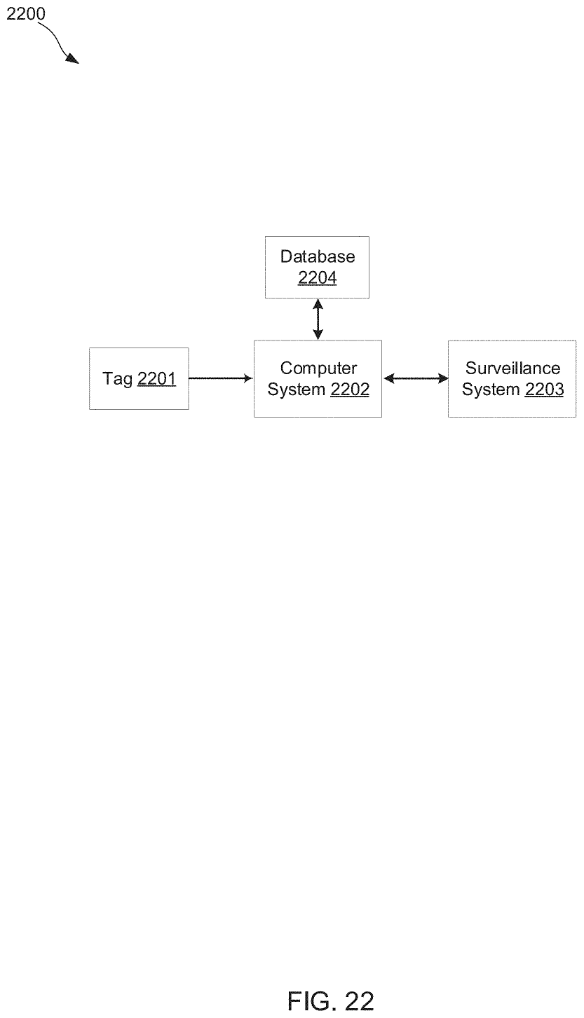

FIG. 22 shows a block diagram of a system 2200 that supports fluid management with surveillance in accordance with aspects of the present disclosure. In FIG. 22, a tag 2201 attached to a bottle may be digitally associated with the bottle in a computer software system, such as a beverage computer system 2202. The beverage computer system 2202 stores its data and information in an associated database 2204, which may be external to or within the beverage computer system 2202. The database 2204 can be one or more databases, on one or more servers, and some or all of the databases can be linked or associated with each other in a network. In some other cases, the databases may be disassociated from each other. In some embodiments, the beverage computer system 2202 may be associated with a surveillance system 2203. In some examples, the surveillance system 2203 may comprise one or more cameras (e.g., video cameras, Closed-Circuit Television (CCTV) cameras, etc.) and/or audio recording equipment, such as microphones. In some examples, the cameras may have audio recording capabilities, and dedicated audio recorders may not be needed. Additionally or alternatively, the surveillance system 2203 may also comprise a recognition unit for recognizing at least one of a location and time of a dispensing event. Further, the recognition unit may also be configured to recognize one or more of a brand, type, size, or other relevant information pertaining to a container. In some cases, the recognition unit may be configured to receive information captured by the surveillance system's cameras and process the same using image recognition, Artificial Intelligence (AI), or Machine Learning algorithms. In some other cases, the recognition unit may be separate from the surveillance system (e.g., running on the computer system or in a cloud-based processing system). In yet other cases, the cameras may include their own recognition units, or image recognition software.

In an embodiment of the present disclosure, a surveillance system 2203 for the location is linked to or associated with the computer software system 2203. The association can be via a communications network and/or a closed standalone system. The surveillance system can be externally operated, e.g., installed and/or operated by a third party, such as an outsourced provider. Alternatively, the surveillance system 2203 can be run by the person running the establishment (i.e., organizer of the event/customer of the computer software system). In other cases, the surveillance system may be run by an administrator or entity running the computer software system 2202, according to an embodiment of the present disclosure. When an alert is triggered by the computer software system 2202, the system 2200 or a sub-component of the system (e.g., computer software system 2202) may send a request to the surveillance system 2203. In some examples, the request may include an indication that a video feed segment for the specific time, plus, e.g., a preset time amount before and after that specific time, of the alert is desired. For example, in the present disclosure, an alert could be triggered when the tag 2201 is removed from the bottle (i.e., identified by the movement of the tag, using the accelerometer), when the bottle is poured afterhours for the business, when the bottle with tag moves off site, when the tag does not register movement for a predetermined amount of time, when the pouring time is registered as too long for any preset time, or any other event at that location that would be suggestive of unexpected or improper behavior (e.g., rogue use, theft, etc.).

As an example, if bartender A removes the tag from an opened (but not empty) bottle, the tag may send an alert to the computer system regarding its bottle. In an embodiment, the computer system 2202 tallies the contents of the bottle based on the amount or volume of liquid originally in the bottle at the start of use, and subtracts the amount or volume of the liquid pours calculated by the computer system 2202 as explained above, in order to determine whether a bottle still has liquid or contents. In some cases, determining the fill state of a container may also be referred to determining the inventory level of a container's contents. In an embodiment, this information may be tallied or kept track of in a database 2204 associated with the computer system and checked or retrieved as needed. When the information identifies an “empty” bottle, based on tallying the database by the computer system, an empty or stock out alert may be sent to the administrator.

In an embodiment, when the tag 2201 sends an alert to the computer system regarding the removal from the bottle, the alert may be checked against the maintenance records or database fields toto confirm whether the tag is intended to be removed. Once the tag 2201 sends an alert to the computer system 2202, the computer system 2202 checks its database to see whether the tag should be removed, and, if not, then the computer system 2202 sends a message to the surveillance system 2203. The computer system 2202, in formulating the automatic message to the surveillance system 2203, automatically adds a preset amount of time value before and after the time recorded of the tag-sent alert. The message sent by the computer system 2202 can include in a subject line or file name or other available method: the alert time plus the present amount of time value added to it, the location of the bottle tag at the time of the alert (e.g., in latitude and longitude coordinates, or if programmed to automatically identify the different location rooms by another identification system (e.g., names: bar pouring area, seating room, storage room, etc.), and a request to provide video feed for that specified time period and location.

In an embodiment of the present disclosure, one of the surveillance system 2203 or computer system 2202 of the present disclosure may comprise a database (i.e., database 2204, or another database) that maps the locations recognized by the respective systems. For example, the database 2204 identifies that for the present vendor location, the “bar area” named in the system 2200 or computer system 2202 is equivalent to the “room I” identifier in the surveillance system 2203. Thus, for example, when an alert is triggered at the computer system 2202 based on the motion of the electronic tag, the computer system 2202 may also receive the location of the bottle from the tag 2201 or the tag alert. Further, the computer system 2202 may look up that location (e.g., bar area) in the lookup table and determine that the surveillance system at that geographic location identifies that area as room 1. Then, “room I” may be appended to the message request sent by the computer system 2202 to the surveillance system 2203. Alternatively, the surveillance system 2203 has the lookup table stored and handles the identification of the location before sending the video and/or audio clips and/or still shots (i.e., surveillance images). Alternatively, the surveillance system 2203 and the computer system 2202 may identify the locations in the same manner, via a shared naming or identification scheme for the different areas at that geographic location, thus obviating any need for the lookup table.

In an embodiment, the surveillance system 2203 receives the message and parses the time period, the location, and the request. Upon receiving, the surveillance system 2203 determines the time period as it matches to the digital records of the specific location, makes a copy of the video or other surveillance images/audio stored for that time period and specific location, and transmits the copy to the computer system 2202.

In an embodiment, upon receiving the copy of the, e.g., video feed for the specific time period and location, the computer system 2202 sends an alert to the administrator's mobile device or other communication means along with the copy of the surveillance footage. This way, an administrator can view the alert and/or the surveillance information and determine in real-time if, for example, the police or another authority (i.e., management, supervisor, etc.) should also be alerted. For example, in situations where a specific bottle of liquid is particularly potent or worth a large sum of money, and the surveillance footage indicates theft or misuse, law enforcement or management may be notified automatically by the system 2200. If, for example, the alert was related to an employee accidentally dropping a bottle (also supported by the surveillance information), the administrator may tag the alert as a false alarm. In such cases, the administrator or computer system may refrain from contacting any formal authorities or assistance. Generally, the surveillance system aims to provide further clarity on instances occurring at the bar or stockroom/storeroom that deviate from the norm (i.e., actionable variance events), allowing management to make more informed decisions. In another example, an administrator may be able to confirm, via the surveillance footage, if an employee was injured on the job, as they claim. If so, the administrator may be able to call for medical personnel or provide the employee with supporting documentation (i.e., proof) for a workers' compensation claim.

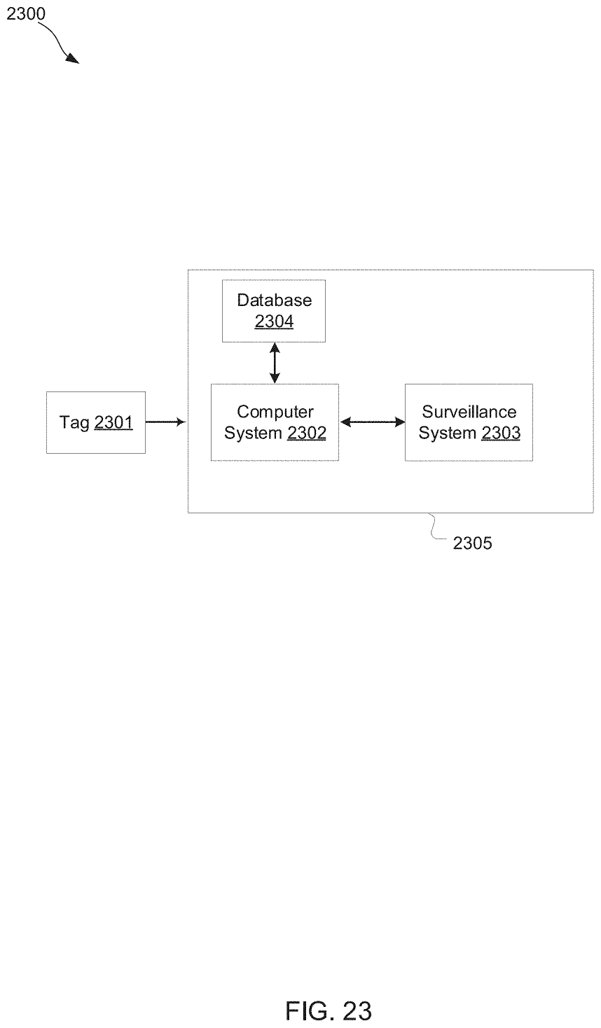

FIG. 23 shows an example block diagram of a system 2300 that supports fluid management with surveillance in accordance with aspects of the present disclosure. In FIG. 23, a tag 2301 on a bottle or other housing/device, communicates with a beverage enterprise system 2305. The beverage enterprise system 2305 can include a beverage or computer software system 2302 as described in the various embodiments above, such as the computer software system 2202 in FIG. 22. The beverage enterprise system 2305 can include one or more databases 2304 or storage for data from the computer software system 2302.

The beverage enterprise system 2305 can include a surveillance system 2303, or the surveillance system 2303 can be external to or remote from the beverage enterprise system 2305. In an embodiment, the computer software system 2302, as described in the various embodiments above, communicates with the surveillance system 2303 in order to track possible inappropriate behaviors, accidents, and other alert-worthy events.

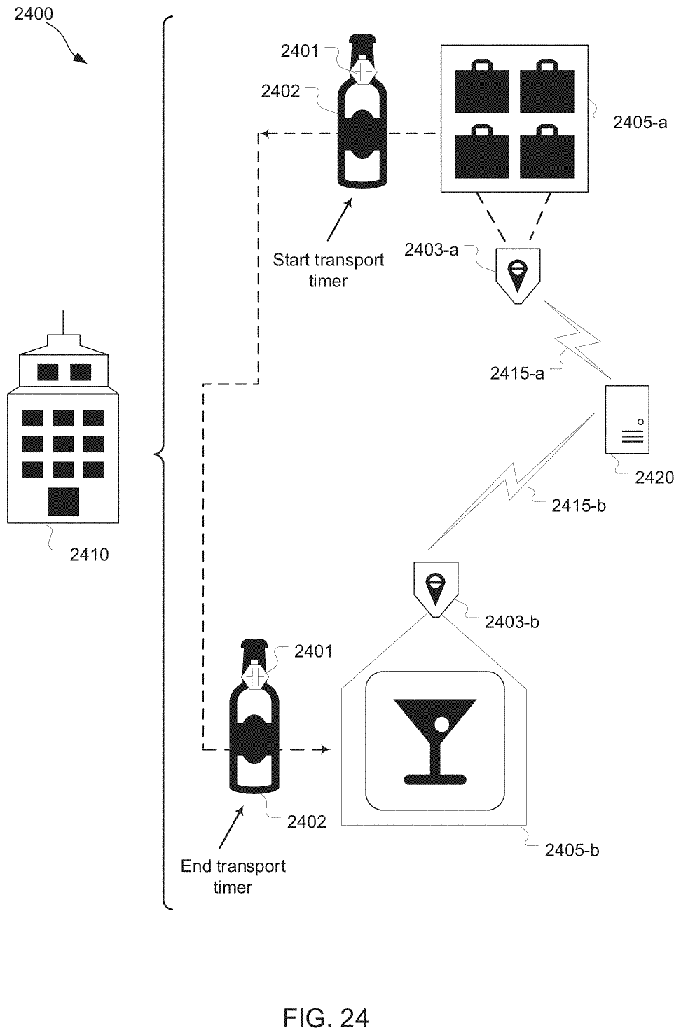

FIG. 24 shows an example beverage enterprise system 2400 according to various embodiments of the present disclosure. The beverage enterprise system 2400 may include a first location 2410, such as a bar, restaurant, hotel, banquet hall, convention center, etc. As shown, the first location 2410 may include a first area 2405-a, such as a storage room/warehouse/stock room, and a second area 2405-b, such as a bar or restaurant. In some cases, the first area 2405-a may be used to store inventory, such as bottles or containers holding beverages (i.e., alcoholic and non-alcoholic) to be dispensed at the second area 2405-b. Further, the beverage enterprise system may include a tag 2401, a container 2402, one or more readers 2403 (or receiving devices) (e.g., reader 2403-a, reader 2403-b, etc.), and a computer system 2420. In some examples, the computer system 2420 may be linked to a database for storing data received and analyzed at the computer system.

As an example, in FIG. 24, tag 2401 may be attached to the container 2402. In some cases, the container 2402 may be a bottle or another receptacle for holding a liquid. Further, readers 2403 may communicate with computer system 2420 over one or more communication links 2415 (e.g., communication link 2415-a, 2415-b, etc.). In some examples, the first area 2405-a or the second area 2405-b may comprise more than one reader 2403. The communication links 2415 can include various wireless protocols such as Bluetooth, Bluetooth Low Energy (BLE), Near Field Communication (NFC), Wi-Fi, cellular, or even Radio Frequency Identification (RFID) technologies, etc. or wired protocols, such as those common to local area networks. The readers 2403 may be configured to monitor for and receive signals from the tag 2401.

As an example, tag 2401 may comprise at least a tag housing, a motion detector, a timing device, and optionally a tilt sensor (that may or may not be one and the same with the motion detector). For instance, an accelerometer can detect both motion and tilt angle. However, two different accelerometers might also be used: one accelerometer used to track motion and the other to track tilt, where each accelerometer is tailored to its specific task. In some cases, the tag 2401 may also comprise a transceiver for transmitting and receiving data, where the data may be exchanged with the reader (e.g., on-site reader or the computer system 2420). The band portion of the tag housing may be composed of a flexible or stretchy material, such as silicone or rubber, allowing it to be stretched around multiple bottle shapes for an easy and secure friction fit. In some examples, the band of the tag housing may be designed such that its diameter (prior to stretching) is slightly smaller than the bottle (or neck of the bottle) to which it is configured to be attached. In some cases, the tag housing may be composed of a more rigid material than the tag band, so as to protect the tag circuitry. Further, the material for the tag band may be selected such that it retains its shape and elasticity for multiple attaches/detaches.

In some cases, the tag 2401 may be attached to the container 2402 at the first area 2405-a within the first location 2410. After attachment, the tag 2401 may transmit an indication of a tag attach event to at least one of the reader 2403-a and the computer system 2420. In some embodiments, the tag 2401 may comprise a sensor (e.g., infrared (IR) sensor, ultrasonic sensor, laser, etc.) for detecting whether the tag is attached to the container, where the detection is based at least in part on measuring a reflection. In such cases, the computer system 2402 may create a digital association between the tag 2401 and the container 2402 to which the tag is attached. The digital association may include associating the tag 2401 to the container 2402, or the tag 2401 to a location of the tag 2401, or the location of the tag 2401 to the container 2402, to name just three, non-limiting examples.

In some cases, the container to which the tag is attached may be transported from the first area 2405-a (e.g., stockroom) to the second area 2405-b (e.g., bar), where the container 2402 may be used for a dispensing event (e.g., pouring a shot). In some examples, the tag 2401 may start a transport timer at the start of its movement to the second area 2405-b. The transport timer may be started based on the motion detector detecting a motion of the tag 2402. In some examples, the tag 2401 may start a transport timer (instead of a pour timer) upon identifying that the container 2402 to which the tag 2401 is attached is not within a designated area, such as a bar, or if the tilt angle is below a threshold during the movement. In other words, one or more of the tag 2401, the reader 2403, and the computer system 2420 may determine the location of the tag 2401 and the container 2402, and the type of timer (i.e., transport timer or pour timer) that is initiated may be determined based on the location.

After container 2402 with the attached tag 2401 has been transported from the first area 2405-a to the second area 2405-b, tag 2401 may end its transport timer, for instance, based on a lack of motion of the tag 2401. In some cases, reader 2403-b at the second area 2405-b may scan or monitor the tag 2401 attached to the container 2402 and may send an indication to the tag 2401 to end its timer. In other words, when the tag 2401 comes within range of wireless signals from the reader 2403-b while the transport timer is running, the tag 2401 may end the transport timer. Additionally or alternatively, the reader 2403-b may also notify the computer system 2402 that container 2402 and tag 2401 have reached their final destination. In such cases, computer system 2420 may update a database associated with the computer system with the most recent location of tag 2401 and container 2402. A time of transport may also be stored in the database. If the tag 2401 was picked up by a third reader (not shown), then this may also be recorded (e.g., where a circuitous transport route is used).

The transport timer may be initiated when the tag 2401 is within range of certain of a plurality of readers 2403, but may not be initiated when the tag 2401 is within range of certain other of a plurality of readers 2403. For instance, if the tag 2401 is within range of a reader associated with a storeroom, then movement of the container 2402 may initiate the transport timer. However, if the tag 2401 is within range of a reader associated with the bar, then movement may not trigger the transport timer.

Additionally, the computer system 2420 can perform various analyses based on the transport timer data. For instance, if a container 2402 leaves a storeroom, but does not reach the bar area within a given period of time, then an alert may be triggered (e.g., a text to a bar manager). Similarly, a video feed in the storeroom may be accessed and sent to a manager or other user if such a situation occurs to help in identifying the staff member involved in the incomplete transport and/or to see if some other event caused the transport timer to be triggered. As another example, the computer system 2420 can analyze the time taken for containers 2402 to be transported between the storeroom and a bar area by different users to help assess staff efficiency.

It should be noted that, while the first area 2405-a and second area 2405-b have been shown as being within the same structure 2410, in other embodiments, they may be at different geographic locations or in distinct structures. For instance, the first area 2405-b and second area 2405-b may be in different buildings, may be separated over a few miles in the same town or city, or may even be in different cities.

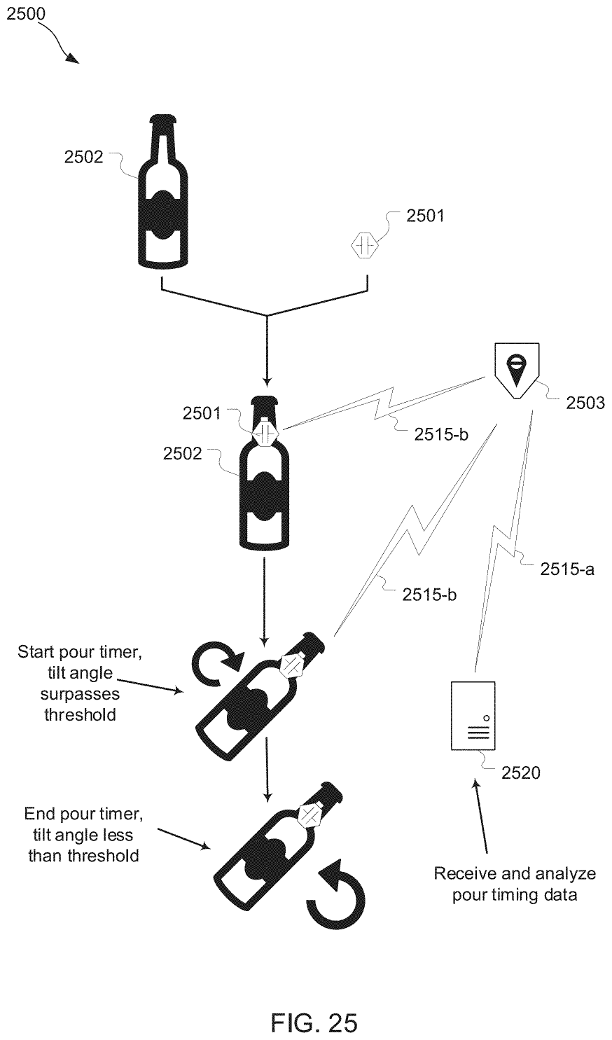

FIG. 25 shows an example beverage enterprise system 2500 according to various embodiments of the disclosure. The beverage enterprise system 2500 may include a container 2502, an electronic tag 2501, a reader 2503, and a computer system 2520, which may be examples of the container 2402, tag 2401, reader 2403, and computer system 2420, respectively, as described in relation to FIG. 24. In some cases, tag 2501 may be attached to container 2502, where container 2502 may be an example of a bottle or another container for holding a liquid. After attachment, the tag 2501 may transmit an indication of a tag attach event to one or more readers 2503 in the vicinity of tag 2501, for instance, based on measuring a reflection grade via a proximity sensor (e.g., IR). In some other cases, the one or more readers 2503 may scan or monitor one or more tags and identify when a tag is attached to a container. In some cases, the tag 2501 and reader 2403 may communicate over communication link 2515-b using Bluetooth, Bluetooth Low Energy (BLE), Near Field Communication (NFC), Wi-Fi, cellular, or even Radio Frequency Identification (RFID) technologies, to name a few non-limiting examples.

As shown, a motion detector of tag 2501 may be used to identify a movement of the tag 2501 and the container 2502 to which the tag 2501 is attached. In some cases, the motion detector may be an accelerometer or a gyroscope. Further, the motion detector, the computer system, or the reader may be configured to distinguish between a tilt/pour event versus a movement event of the tag 2501. For instance, a tilt/pour event may be identified when a tilt angle for the tag 2501 exceeds a tag angle threshold (e.g., 45 degrees, 60 degrees, etc.). In some circumstances, the tag angle may remain relatively constant during a motion event, even though the location of the tag 2501 changes, whereas the tag angle may change during a tilt/pour event, even though the location of the tag 2501 remains relatively constant. Thus, analysis of the tilt angle over time may also be used to distinguish between pour events and mere movement of a bottle between two locations.

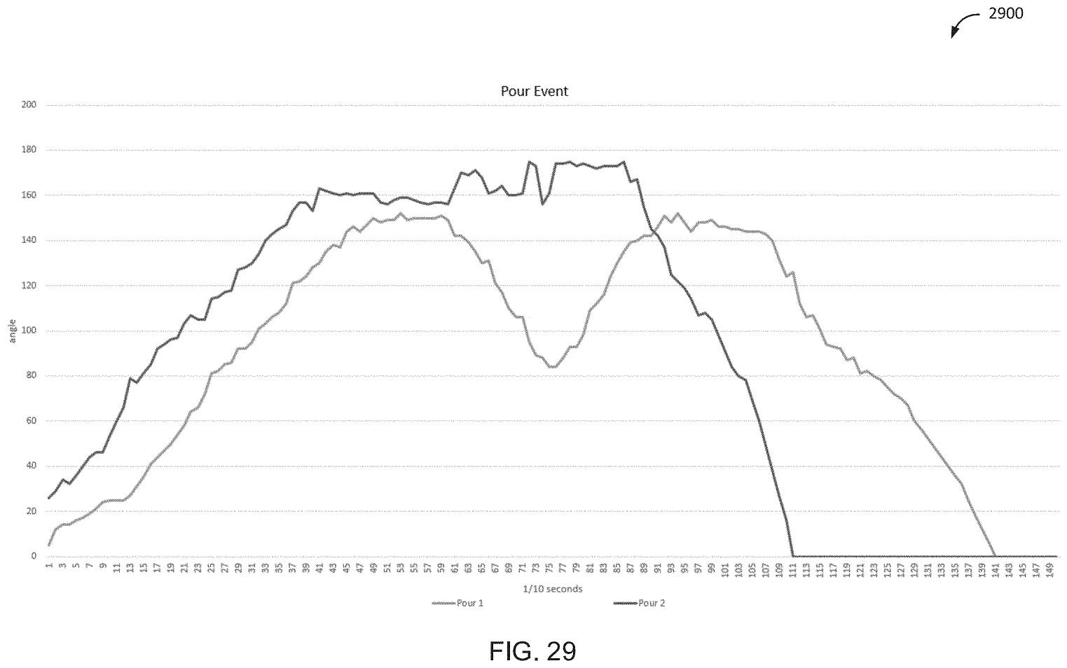

After determining that the tag angle has exceeded a threshold, the tag 2501 may start a pour timer. In some examples, the pour timer may continue running as long as the tag angle is at or above the threshold. In some cases, the computer system 2520 may receive and analyze pour timing data for the tilt/pour event, based on which it may calculate a flow rate and/or a volume dispensed. In some embodiments, the tag 2501 may start a plurality of pour timers, each pour timer associated with a specific tilt angle. Further, the tag 2501 may end each of the one or pour timers when the tilt angle falls below the tilt angle threshold. Following receiving and recording the pour timing data, the computer system 2520 may calculate a volume dispensed (or a volume remaining) for the container 2502 to which the tag is attached. In some embodiments, the computer system 2520 may also store this value in a database associated with the computer system 2520, for future reference or for generating reports for the organizer and/or the client. In some other cases, the computer system 2520 may need to retrieve the volume remaining in the container 2502 to which the tag 2501 is attached during another tilt/pour event. In yet other cases, the computer system 2520 may identify when a container 2502 is an empty or stock out state based on subtracting a volume dispensed during a second pour event from a volume remaining after a first pour event, where the volume remaining after the first pour event may be retrieved from the database. In some embodiments, the tilt angle threshold for starting the pour time may be different than the tilt angle threshold for ending the pour timer. When the tag 2501 meets or exceeds the tilt angle threshold, the system 2500 may begin recording tilt angle as a function of time (i.e., an array of tilt angle data points and timestamps). This data may be used to plot a pour timeline as shown in FIG. 29 and discussed in more detail below.

FIG. 29 illustrates a pour timeline showing two different pours and tilt angles of those pours over a period of time. Pour 2 can be seen to start at a greater tilt angle, but both tilt angles appear to increase at a similar rate and then top out around the same time and at around the same tilt angle. However, as the pour continues, at a relatively constant tilt angle, Pour 1 shows a dip and then a climb back up to a max tilt angle. This indicates that a double pour may have occurred (i.e., that a bartender poured a first shot and then moved to a different glass without bringing the bottle back to a vertical position). This is important data since the dip may not have been low enough to trigger a stop to the tilt timer and thus the second pour would have been missed by the system had tilt angle thresholds alone been used to determine a start and end to a pour. Thus, a pour timeline such as shown in FIG. 29 can help to supplement and enhance the accuracy of methods just looking for tilt angle to cross a threshold. On the other hand, the undulation in Pour 2 could be indication of an unsteady hand—an inexperienced bartender who has yet to perfect his/her technique. A manager might use the pour timeline to help train staff to more efficiently perform their duties and achieve more consistent pours.

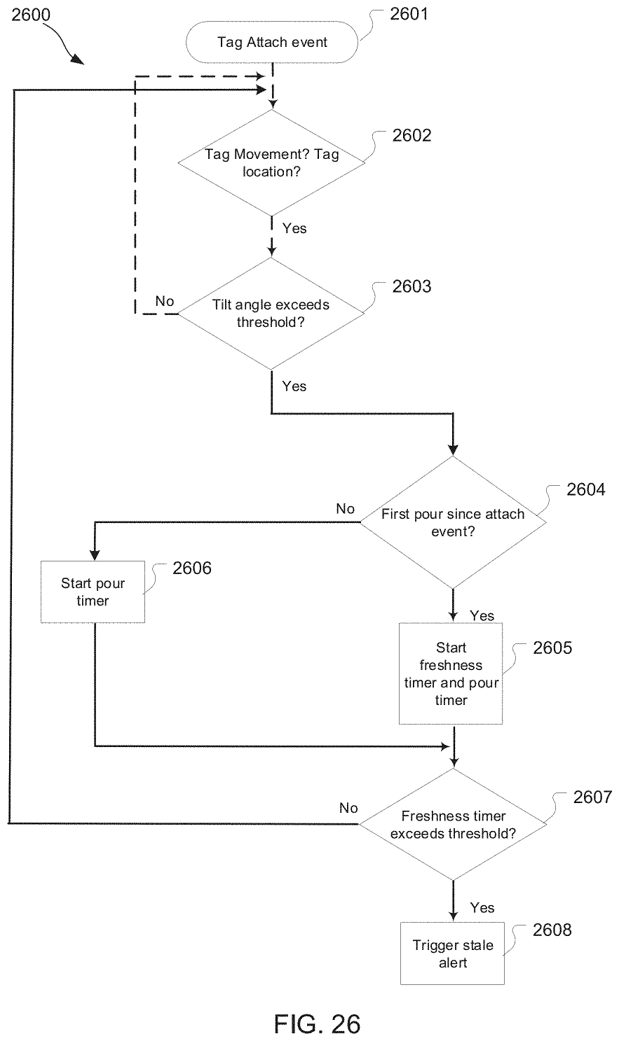

FIG. 26 illustrates a flowchart 2600 of the beverage enterprise system according to various embodiments of the disclosure. In some examples, flowchart 2600 is directed to the steps for triggering a stale alert for a beverage, such as wine, stored in one or more containers.

At 2601, an electronic tag may be attached to a container, where the container may be an example of a bottle or another receptacle for holding a liquid. The electronic tag may be an example of the beverage system tag described above. In some cases, the electronic tag may comprise at least a tag housing, a motion detector, and a timing device for measuring a duration of motion of the electronic tag. In some cases, the electronic tag may comprise a data transceiver for exchanging (i.e., transmitting and receiving) data with a computer system, a surveillance system, or a reader, such as an on-site reader.

After attachment, the electronic tag may transmit an indication of a tag attach event to one or more readers in the vicinity of the tag, or even the computer system. In some other cases, the one or more readers may scan or monitor the tag and identify when the tag is attached to the container. In some cases, the electronic tag, reader, and computer system may communicate with each other using Bluetooth, BLE, NFC, or RFID technologies, to name a few non-limiting examples.

At 2602, the motion detector of the electronic tag may be triggered due to movement of the tag. In some cases, the movement of the tag may be associated with a tilt/pour event. As described above, the motion detector may comprise an accelerometer or gyroscope for distinguishing between pour events and movement events, although other devices and technologies can also be implemented to detect movement.

At 2603, the computer system may analyze the motion of the electronic tag based on data received from the tag. The received data may comprise a tilt/pour angle and/or pour timing data. In some examples, the motion detector of the tag may determine if the tilt angle exceeds a tilt angle threshold (i.e., indicative of a pour event).

If the tilt angle exceeds the threshold, the computer system, the database, and/or the electronic tag may determine, at 2604, if it is the first pour since a tag attach event. That is, a determination may be made if the bottle or container to which the tag is attached is open (e.g., if a pour has already occurred). In such cases, the electronic tag or the computer system may already be running a freshness timer for that tag and its associated container or bottle.

If it is the first pour (or first tilt exceeding a threshold) since a tag attach event, the electronic tag may start one or more of a pour timer and a freshness timer at 2604. In some embodiments, the electronic tag may start the one or more timers based in part on the location of the tag in a designated area, such as a bar, as opposed to a stockroom. In other cases, if it is not the first pour since a tag attach event (i.e., a freshness timer is already running), the electronic tag may start a new pour timer at 2606 for this tilt/pour event. In some embodiments, the freshness timer at 2605 may continue running in the background, even after the pour timer has ended. If the freshness timer exceeds a threshold at 2607, the electronic tag, the reader, or the computer system may trigger a stale alert at 2608.

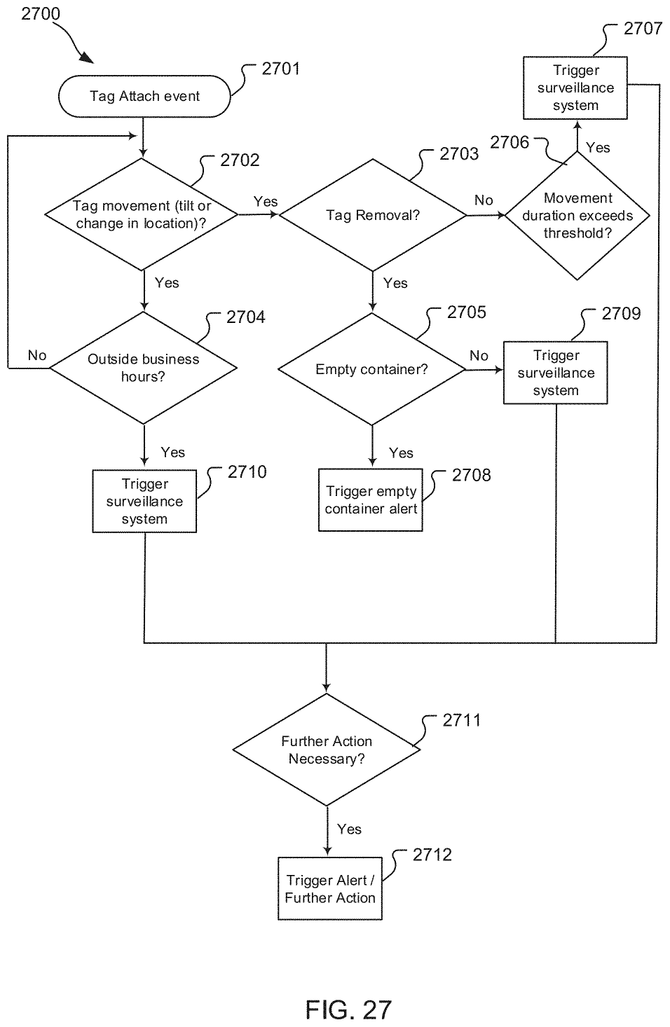

It should be noted that the dashed lines in the flowchart may represent a reversal of order between steps 2602 and 2603. For instance, in some embodiments, the tilt angle may exceed a threshold, but the location of the tag may be outside of a designated area. In such cases, the electronic tag may not start a freshness or pour timer, since the freshness timer is primarily used to indicate that a bottle is open and pouring for the first time, if in a certain location like the bar. In some examples, on-site readers scattered throughout the location (i.e., in bars, restaurants, stock rooms, inventory storage areas, etc.) may be used to monitor and identify the tag's location based in part on a signal strength at the readers. In other words, if one or more readers in one area register stronger signals from the electronic tag as compared to readers in another area, it may be indicative that the electronic tag is close to or in that first area. Furthermore, it should be noted that, while the electronic tag may not start a timer in instances of tilts outside a certain area, the computer system may still trigger an alert for the surveillance system based on this unexpected behavior, further described in relation to FIG. 27.

In some circumstances, after the conclusion of the pour event (i.e., tilt angle falls below a threshold), the electronic tag may end the pour timer started at 2606 or 2605, and calibrate the tilt angle based on the vertical angle of the tag. Specifically, the electronic tag may be configured to enter a calibration mode based at least in part on a lack of motion of the electronic tag with a predefined period of time. Further, when in the calibration mode, the electronic tag may identify a current tag angle for the electronic tag and set the current tag angle as a vertical bottle angle. In future pour events, the electronic tag may measure a tilt angle in reference to this vertical bottle angle.

FIG. 27 illustrates a flowchart 2700 of the beverage enterprise system according to various embodiments of the disclosure. In some examples, flowchart 2700 is directed to the steps for monitoring or surveilling the dispensing of a liquid from a container, such as a bottle. The operations of flowchart 2700 may be implemented by one or more of an electronic tag, a computer system, a reader, and a surveillance system as described with reference to FIGS. 1-26. Flowchart 2700 refers to a first motion alert and a second alert, where the “first motion alert” is typically triggered by movement of an electronic tag, and the “second alert” is typically triggered when the movement meets another parameter (e.g., movement past a threshold tilt angle, movement during a period of time, movement in a certain location, etc., or some combination of these). A tag typically generates the first motion alert while the computer system generally generates the second alert. The first motion alert typically triggers further analysis of data associated with the event causing the first motion alert, while the second alert typically triggers action such as retrieval or storage of data by a surveillance system.

At 2701, an electronic tag may be attached to a container, where the container may be an example of a bottle or another receptacle for holding a liquid. The tag may be an example of the beverage system tag described above. In some cases, the electronic tag may comprise at least a tag housing, a motion detector, and a timing device for measuring a duration of motion of the electronic tag. In some cases, the electronic tag may comprise a data transceiver for exchanging (i.e., transmitting and receiving) data with a computer system, a surveillance system, or a reader.

After attachment, the electronic tag may transmit an indication of a tag attach event to one or more readers in the vicinity of tag, or even the computer system. In some other cases, the one or more readers may scan or monitor the tag and identify when the tag is attached to the container. In some cases, the electronic tag, reader, and computer system may communicate with each other using Bluetooth, BLE, NFC, or RFID technologies, to name a few non-limiting examples.

At 2702, the motion detector of the electronic tag may be triggered due to movement of the tag. Triggering of the motion detector may cause a first motion alert to be sent at a first time to the computer system, where the first motion alert may include data pertaining to, describing, or identifying motion of the electronic tag. before instance, the first motion alert can indicate a tilt/pour event, a change in location of the tag, or a removal of the tag from the bottle, to name three non-limiting examples. For any movement of the tag, a tag removal decision 2703 and a comparison to a range of business hours (decision 2704) can be made (though both are not required). At 2704, the electronic tag or the computer system may determine if the tag movement occurred outside business hours, based in part on a timestamp sent with or as part of the first motion alert. If the movement occurred outside business hours, the computer system may trigger or send a second alert for the surveillance system at 2710. If the movement did not occur outside business hours, the system may further analyze the motion of the electronic tag, as described below. Along with or alternatively to the second alert, the computer system may access or store a period of video feed from the surveillance system surrounding the timestamp of the first motion alert. For instance, a video buffer may hold a period of video for the surveillance system (e.g., a last hour of video), and segments of video in the buffer can be stored if a second alert is triggered, while the rest of the buffer can be cleared as time elapses. As another example, the second alert may cause the surveillance system to retrieve a segment of video, audio, or other stored media from a database and make that segment of media more readily available for review (e.g., by e-mailing a video clip to a manager or presenting the video clip in a manager's app).

At 2703, the computer system may analyze the motion of the electronic tag and determine if the movement was associated with a tag removal. For instance, data from a proximity sensor in concert with data from a motion sensor may enable the computer system to determine whether the movement was associated with tag removal. If so, at 2705, the computer system may determine if the container or bottle to which the tag was attached is empty. For instance, the computer system may use its knowledge of a bottle's first pour along with previous pour data to determine when the bottle is empty of near empty and this data along with movement of a tag and indication from a proximity sensor that the tag is no longer on the bottle may lead to an empty-bottle determination. Upon identifying that the container or bottle is empty, the computer system may then trigger an empty container alert at 2708. If the container or bottle was not empty, the computer system may trigger a second alert for the surveillance system at 2709 to gather further information (e.g., where a tag is removed before a bottle is empty—possibly indicating that a staff member is attempting to steal an unfinished bottle). For instance, the second alert may cause the surveillance system to retrieve any available video clips in the vicinity where the tag was located and around the time when the first motion alert occurred.

In some cases, the movement of the electronic tag may be linked to a movement event (i.e., change in location of the tag) or with a tilt/pour event. In such cases, if the tag removal at 2703 is determined to be “no”, the computer system or the electronic tag may analyze if the duration of the movement exceeds a threshold at 2706. If the duration exceeds a threshold, the computer system may trigger a second alert for the surveillance system at 2707. This may be a time threshold, acceleration threshold, or a distance threshold, to name three non-limiting examples. With neural network training, the threshold may be a trained type of movement such as a periodic acceleration that the neural network has been trained to associate with a walking motion, and where the bottle should only be poured during the time in question, not carried away from the bar.

After the surveillance system is triggered by the second alert at either of 2710, 2709, or 2707, the computer system or an administrator may review one or more digital media files associated with the time and location of the first motion alert (e.g., a video feed, surveillance images, and surveillance audio). In some cases, the surveillance system access and transmit a digital media file associated with the timing of the first motion alert plus a period of time before and after the event causing the first motion alert (e.g., 30 seconds before the movement and 2 minutes after the movement or after the end of movement). After analyzing the surveillance data, the computer system or administrator may determine if the movement of the tag was associated with an event requiring further action (e.g., theft, misuse, neglect, poor form, improper recipe, etc.) at 2711. If it is determined that further action is necessary, the computer system or surveillance system may trigger a further alert or action such as sending a request to law enforcement or an e-mail to a location's manager at 2712.

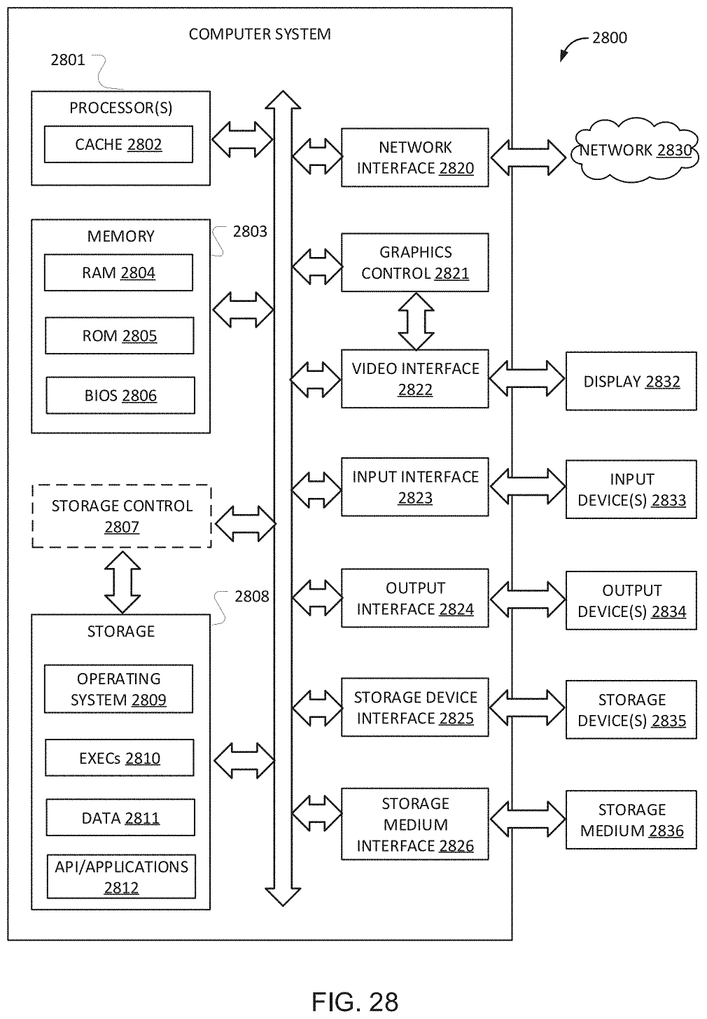

FIG. 28 illustrates a diagrammatic representation of one embodiment of a computer system 2800, within which a set of instructions can execute for causing a device to perform or execute any one or more of the aspects and/or methodologies of the present disclosure. The components in FIG. 28 are examples only and do not limit the scope of use or functionality of any hardware, software, firmware, embedded logic component, or a combination of two or more such components implementing particular embodiments of this disclosure. Some or all of the illustrated components can be part of the computer system 2800. For instance, the computer system 2800 can be a general-purpose computer (e.g., a laptop computer) or an embedded logic device (e.g., an FPGA), to name just two non-limiting examples.

Moreover, the components may be realized by hardware, firmware, software or a combination thereof. Those of ordinary skill in the art in view of this disclosure will recognize that if implemented in software or firmware, the depicted functional components may be implemented with processor-executable code that is stored in a non-transitory, processor-readable medium such as non-volatile memory. In addition, those of ordinary skill in the art will recognize that hardware such as field programmable gate arrays (FPGAs) may be utilized to implement one or more of the constructs depicted herein.

Computer system 2800 includes at least a processor 2801 such as a central processing unit (CPU) or a graphics processing unit (GPU) to name two non-limiting examples. Any of the subsystems described throughout this disclosure could embody the processor 2801. The computer system 2800 may also comprise a memory 2803 and a storage 2808, both communicating with each other, and with other components, via a bus 2840. The bus 2840 may also link a display 2832, one or more input devices 2833 (which may, for example, include a keypad, a keyboard, a mouse, a stylus, etc.), one or more output devices 2834, one or more storage devices 2835, and various non-transitory, tangible computer-readable storage media 2836 with each other and/or with one or more of the processor 2801, the memory 2803, and the storage 2808. All of these elements may interface directly or via one or more interfaces or adaptors to the bus 2840. For instance, the various non-transitory, tangible computer-readable storage media 2836 can interface with the bus 2840 via storage medium interface 2826. Computer system 2800 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 2801 (or central processing unit(s) (CPU(s))) optionally contains a cache memory unit 2832 for temporary local storage of instructions, data, or computer addresses. Processor(s) 2801 are configured to assist in execution of computer-readable instructions stored on at least one non-transitory, tangible computer-readable storage medium. Computer system 2800 may provide functionality as a result of the processor(s) 2801 executing software embodied in one or more non-transitory, tangible computer-readable storage media, such as memory 2803, storage 2808, storage devices 2835, and/or storage medium 2836 (e.g., read only memory (ROM)). Memory 2803 may read the software from one or more other non-transitory, tangible computer-readable storage media (such as mass storage device(s) 2835, 2836) or from one or more other sources through a suitable interface, such as network interface 2820. Any of the subsystems herein disclosed could include a network interface such as the network interface 2820. The software may cause processor(s) 2801 to carry out one or more processes or one or more steps of one or more processes described or illustrated herein. Carrying out such processes or steps may include defining data structures stored in memory 2803 and modifying the data structures as directed by the software. In some embodiments, an FPGA can store instructions for carrying out functionality as described in this disclosure. In other embodiments, firmware includes instructions for carrying out functionality as described in this disclosure.

The memory 2803 may include various components (e.g., non-transitory, tangible computer-readable storage media) including, but not limited to, a random-access memory component (e.g., RAM 2804) (e.g., a static RAM “SRAM”, a dynamic RAM “DRAM, etc.), a read-only component (e.g., ROM 28028), and any combinations thereof. ROM 28028 may act to communicate data and instructions unidirectionally to processor(s) 2801, and RAM 2804 may act to communicate data and instructions bidirectionally with processor(s) 2801. ROM 28028 and RAM 2804 may include any suitable non-transitory, tangible computer-readable storage media. In some instances, ROM 28028 and RAM 2804 include non-transitory, tangible computer-readable storage media for carrying out a method. In one example, a basic input/output system 2806 (BIOS), including basic routines that help to transfer information between elements within computer system 2800, such as during start-up, may be stored in the memory 2803.

Fixed storage 2808 is connected bi-directionally to processor(s) 2801, optionally through storage control unit 2807. Fixed storage 2808 provides additional data storage capacity and may also include any suitable non-transitory, tangible computer-readable media described herein. Storage 2808 may be used to store operating system 28028, EXECs 2810 (executables), data 2811, API applications 2812 (application programs), and the like. Often, although not always, storage 2808 is a secondary storage medium (such as a hard disk) that is slower than primary storage (e.g., memory 2803). Storage 2808 can also include an optical disk drive, a solid-state memory device (e.g., flash-based systems), or a combination of any of the above. Information in storage 2808 may, in appropriate cases, be incorporated as virtual memory in memory 2803.

In one example, storage device(s) 2835 may be removably interfaced with computer system 2800 (e.g., via an external port connector (not shown)) via a storage device interface 2825. Particularly, storage device(s) 2835 and an associated machine-readable medium may provide nonvolatile and/or volatile storage of machine-readable instructions, data structures, program modules, and/or other data for the computer system 2800. In one example, software may reside, completely or partially, within a machine-readable medium on storage device(s) 2835. In another example, software may reside, completely or partially, within processor(s) 2801.

Bus 2840 connects a wide variety of subsystems. Herein, reference to a bus may encompass one or more digital signal lines serving a common function, where appropriate. Bus 2840 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 2800 may also include an input device 2833. In one example, a user of computer system 2800 may enter commands and/or other information into computer system 2800 via input device(s) 2833. Examples of an input device(s) 2833 include, but are not limited to, an alpha-numeric input device (e.g., a keyboard), a pointing device (e.g., a mouse or touchpad), a touchpad, a touch screen and/or a stylus in combination with a touch screen, a joystick, a gamepad, an audio input device (e.g., a microphone, a voice response system, etc.), an optical scanner, a video or still image capture device (e.g., a camera), and any combinations thereof. Input device(s) 2833 may be interfaced to bus 2840 via any of a variety of input interfaces 2823 (e.g., input interface 2823) including, but not limited to, serial, parallel, game port, USB, FIREWIRE, THUNDERBOLT, or any combination of the above.

In particular embodiments, when computer system 2800 is connected to network 2830, computer system 2800 may communicate with other devices, such as mobile devices and enterprise systems, connected to network 2830. Communications to and from computer system 2800 may be sent through network interface 2820. For example, network interface 2820 may receive incoming communications (such as requests or responses from other devices) in the form of one or more packets (such as Internet Protocol (IP) packets) from network 2830, and computer system 2800 may store the incoming communications in memory 2803 for processing. Computer system 2800 may similarly store outgoing communications (such as requests or responses to other devices) in the form of one or more packets in memory 2803 and communicated to network 2830 from network interface 2820. Processor(s) 2801 may access these communication packets stored in memory 2803 for processing.

Examples of the network interface 2820 include, but are not limited to, a network interface card, a modem, and any combination thereof. Examples of a network 2830 or network segment 2830 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 2830, may employ a wired and/or a wireless mode of communication. In general, any network topology may be used.

Information and data can be displayed through a display 2832. Examples of a display 2832 include, but are not limited to, a liquid crystal display (LCD), an organic liquid crystal display (OLED), a cathode ray tube (CRT), a plasma display, and any combinations thereof. The display 2832 can interface to the processor(s) 2801, memory 2803, and fixed storage 2808, as well as other devices, such as input device(s) 2833, via the bus 2840. The display 2832 is linked to the bus 2840 via a video interface 2822, and transport of data between the display 2832 and the bus 2840 can be controlled via the graphics control 2821.

In addition to a display 2832, computer system 2800 may include one or more other peripheral output devices 2834 including, but not limited to, an audio speaker, a printer, a check or receipt printer, and any combinations thereof. Such peripheral output devices may be connected to the bus 2840 via an output interface 2824. Examples of an output interface 2824 include, but are not limited to, a serial port, a parallel connection, a USB port, a FIREWIRE port, a THUNDERBOLT port, and any combinations thereof. In some examples, the peripheral output devices may be used to generate reports for the entity, such as, but not limited to, financial reports, feedback reports, inventory reports, etc. For instance, the manager or another staff member at the entity may print a financial report including the amount of revenue for a particular day or time period, tips collected by each server or cook, profit margin, etc. In some other cases, servers may utilize the printer to print food orders that the cook staff may work off of.

In addition, or as an alternative, computer system 2800 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, a software module implemented as digital logic devices, or in a combination of these. A software module may reside in RAM memory, flash memory, ROM memory, EPROM memory, EEPROM memory, registers, hard disk, a removable disk, a CD-ROM, or any other form of non-transitory, tangible computer-readable storage medium known in the art. An exemplary non-transitory, tangible computer-readable storage medium is coupled to the processor such that the processor can read information from, and write information to, the non-transitory, tangible computer-readable storage medium. In the alternative, the non-transitory, tangible computer-readable storage medium may be integral to the processor. The processor and the non-transitory, tangible computer-readable storage medium may reside in an ASIC. The ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

It is contemplated that one or more of the components or subcomponents described in relation to the computer system 2800 shown in FIG. 28 such as, but not limited to, the network 2830, processor 2801, memory, 2803, etc., may comprise a cloud computing system. In one such system, front-end systems such as input devices 2833 may provide information to back-end platforms such as servers (e.g. computer systems 2800) and storage (e.g., memory 2803). Software (i.e., middleware) may enable interaction between the front-end and back-end systems, with the back-end system providing services and online network storage to multiple front-end clients. For example, a software-as-a-service (SAAS) model may implement such a cloud-computing system. In such a system, users may operate software located on back-end servers through the use of a front-end software application such as, but not limited to, a web browser.

In some cases, users (i.e., organizers and clients) of the beverage enterprise system may have access to an interactive graphical user interface (GUI) display for viewing various types of information related an event. In some cases, the GUI display may be linked to the computer system and/or the surveillance system and may run on a web-based or cloud-based server. In some embodiments, the type of information accessible to the organizers and clients may be different. For instance, through the GUI display, organizers may be able to view sales summary reports, which may include an overview of sales and volume of sales, real-time inventory reports, pour information reports, pour comparison reports for different bartenders, location reports for the inventory, tag history reports, a tag status summary, which may include an attach/detach state of a tag, including bottle to which the tag is attached, to name a few, non-limiting examples. In some cases, an organizer may be able to add or remove bartenders from the beverage enterprise system and/or assign administrator status to one or more bartenders. Further, the organizer may also utilize the GUI display to replenish stock and check their order status.

In some examples, through the GUI display, clients may be able to view real-time consumption reports for their event and request changes on their initial order based on the same. For instance, if a client's initial order included 4 bottles of tequila and 4 bottles of scotch, and the consumption report indicated that 3 bottles of tequila and no bottles of scotch had been consumed, the client may send a request for the scotch to be restocked and replaced with additional bottles of tequila. In this case, the beverage enterprise system may automatically adjust the invoice for the client. In some embodiments, the clients may access the GUI display through a login (e.g., a guest login) that is separate from the login used by the organizer. Further, the client may access reports or other information for their event through a unique code or keyword (e.g., their email address, phone number, etc.) to ensure they don't access reports for other clients of the beverage enterprise system.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

The modifications listed herein and other modifications can be made by those in the art without departing from the ambit of the invention. Although the invention has been described above with reference to specific embodiments, the invention is not limited to the above embodiments and the specific configurations shown in the drawings. For example, some components shown can be combined with each other as one embodiment, and/or a component can be divided into several subcomponents, and/or any other known or available component can be added. The operation processes are also not limited to those shown in the examples. Those skilled in the art will appreciate that the invention can be implemented in other ways without departing from the substantive features of the invention. The present embodiments are therefore to be considered in all respects as illustrative and not restrictive. Other embodiments can be utilized and derived therefrom, such that structural and logical substitutions and changes can be made without departing from the scope of this disclosure. This Specification, therefore, is not to be taken in a limiting sense, along with the full range of equivalents to which such claims are entitled.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations and/or variations of various embodiments. Combinations of the above embodiments, and other embodiments not specifically described herein, will be apparent to those of ordinary skill in the art upon reviewing the above description.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A system for monitoring dispensing of a liquid comprising one or more hardware processors configured by machine-readable instructions, a central processing unit, and one or more of an internal memory device, and further comprising:
an electronic tag attached to a container used in a dispensing event, said electronic tag including at least a tag housing, a motion detector and a timing device;
a data transceiver for transmitting and receiving data from the electronic tag and a computer system, including at least a first motion alert, the first motion alert triggered by motion of the electronic tag;
wherein the computer system generates a second alert based at least in part on analyzing the data describing the motion of the electronic tag, wherein the second alert is configured to cause a surveillance system to retrieve at least one image or at least one video feed of the dispensing event, or to capture the at least one image or the at least one video feed of the dispensing event.

2. The system of claim 1, wherein the computer system generates the second alert based on one or more of the following: a timestamp associated with the dispensing event, motion of the electronic tag, attachment or detachment of the electronic tag to the container, a change in location of the electronic tag, a lack of motion of the electronic tag within a predefined period of time, or the motion of the electronic tag exceeding a time threshold.

3. The system of claim 2, wherein the motion of the electronic tag comprises a tilt angle for the electronic tag exceeding a tilt angle threshold.

4. The system of claim 1, wherein the computer system identifies a fill state of the container based at least in part on analyzing a location of the electronic tag, timestamps of the electronic tag at different tilt angles, and the different tilt angles.

5. The system of claim 4, wherein the computer system calculates a volume of liquid remaining in the container based on a difference between (1) a volume of liquid in the container when a first tilt angle threshold was met or exceeded, and (2) volumes of liquid dispensed at different tilt angles at or exceeding the first tilt angle threshold.

6. The system of claim 1, wherein the second alert includes at least one of a subject line or file name, an alert time period including a preset value of time before and after a range of time in which the tilt angle was at or above the tilt angle threshold, a location of the electronic tag when the tilt angle was at or above the tilt angle threshold, and a request for a video feed from the location of the electronic tag when the tilt angle was at or above the tilt angle threshold.

7. The system of claim 1, wherein the electronic tag includes a proximity sensor configured to monitor attaching and detaching of the electronic tag from the container.

8. The system of claim 1, wherein the timing device starts a freshness timer after the electronic tag meets or exceeds a (1) tilt angle threshold, (2) is in a location associated with pouring, and (3) it is the first time that (a) the tilt angle threshold has been met or exceeded (b) in the location associated with pouring (c) after the electronic tag detects attachment to the container.

9. The system of claim 8, wherein when the freshness timer reaches a predefined time, the electronic tag or the computer system transmits a stale alert.

10. A system for managing disbursement of fluids comprising one or more hardware processors configured by machine-readable instructions, a central processing unit, and one or more of an internal memory device and a storage device, and further comprising:
an electronic tag attached to a container used in a dispensing event, said electronic tag including at least a tag housing, a motion detector and a timing device;
a data transceiver for transmitting and receiving data from the electronic tag and a computer system;
one or more readers each associated with a different location and each in communication with the computer system;
wherein the computer system analyzes motion of the electronic tag based at least in part on the data and is configured to send instructions to a surveillance system in response to analyzing the motion of the electronic tag; and
a database associated with the computer system for storing fill states and locations of one or more containers, including at least the fill state and location of the container.

11. The system of claim 10, wherein the electronic tag further comprises:
a proximity sensor for detecting whether the electronic tag is attached to the container, the detection based at least in part on measuring a reflection.

12. The system of claim 10, wherein the monitoring comprises one or more of:
identifying that a location of the electronic tag has changed;
identifying a lack of motion of the electronic tag for a predefined period of time;
identifying that a duration of motion of the electronic tag exceeds a threshold.

13. The system of claim 12, wherein one or more of the readers are associated with a first location in which pour events occur and one or more of the readers are associated with a second location in which pour events do not occur, and wherein the computer system determines if the motion of the electronic tag is associated with a pour event based on which reader transmits the data to the computer system.

14. The system of claim 13, wherein the timing device of the electronic tag starts an initial pour timer when a tilt angle of the tag exceeds a tilt angle threshold.

15. The system of claim 13, wherein the computer system records pour duration for multiple tilt zones, where the pour duration for each zone is based on a duration of time that the electronic tag is within a range of tilt angles for that zone.

16. The system of claim 15, wherein the computer system calculates a dispensed volume for each of the multiple tilt zones, based on a flow rate and the pour duration for each of the multiple tilt zones.

17. The system of claim 13, wherein the timing device of the electronic tag starts a transportation timer when the motion detector detects the motion of the electronic tag and the electronic tag is in communication with one or more of the readers associated with the second location and not in communication with any of the one or more readers associated with the first location.

18. The system of claim 13, wherein the electronic tag enters a calibration mode when no motion is detected for a period of time and when the electronic tag is in communication with one or more of the readers associated with the first location, and wherein the calibration mode includes setting a current tilt angle as that of a vertical container.

19. The system of claim 18, wherein if the calibration mode has been entered, then future measurements of the tilt angle are referenced to the vertical container angle, but if the calibration mode has not been entered, then future measurements of the tilt angle are stored and then adjusted after a future calibration mode is entered.

20. The system of claim 10, wherein the electronic tag can be stretch to fit around a portion of the container and then release to attach to the container via a friction fit.
